(19) United States
(12) Patent Application Publication
(10) Pub. No.: US 2025/0086898 A1
(43) Pub. Date: Mar. 13, 2025

(54) Methods Of Efficiently Navigating And Performing Persistent Interactions Within Different Metaverse Environments, And Systems And Devices Thereof

(71) Applicant: Meta Platforms Technologies, LLC, Menlo Park, CA (US)

(72) Inventor: Brandon Furtwangler, Issaquah, WA (US)

(21) Appl. No.: 18/828,833

(22) Filed: Sep. 9, 2024

Related U.S. Application Data
(60) Provisional application No. 63/581,613, filed on Sep. 8, 2023.

(51) Int. Cl. G06T 19/00; G06F 3/01; G06T 15/08

(52) U.S. Cl. CPC G06T 19/00; G06F 3/017; G06T 15/08; G06T 2200/24; G06T 2219/024

(57) ABSTRACT

A method is providing for facilitating user interactions with artificial-reality (AR) content of multiple metaverse environments, including presenting a primary metaverse environment and a secondary metaverse environment corresponding to different AR content. The different AR content is presented using a first presentation state within the primary metaverse environment. The method includes, while the different AR content is presented using the first presentation state: (i) detecting an input requesting a modification to the different AR content, and (ii) based on the input, adjusting the different AR content to reflect the requested modification. And the method includes, after adjusting the different AR content, when detecting a request to present the different AR content using a second presentation state: (i) ceasing to present the different AR content using the first presentation state, and (ii) causing the different AR content to be presented using the second presentation state that reflects the modification.

### RELATED APPLICATIONS

This application claims priority to U.S. Prov. App. No. 63/581,613, filed on Sep. 8, 2023, and entitled “Methods of Efficiently Navigating and Performing Persistent Interactions within Different Metaverse Environments, and Systems and Devices Thereof,” which is incorporated herein by reference.

### TECHNICAL FIELD

The present disclosure relates generally to interactions with metaverse environments (e.g., virtual-reality (VR) environments presented by VR devices), and more particularly to facilitating efficient navigation within and between different metaverse environments (e.g., “metaverse worlds”) and persistent interactions that are reflected in multiple representations of the metaverse environments (e.g., different presentation states of a virtual scene being presented within a VR environment).

### BACKGROUND

Users of artificial-reality headsets can become substantially immersed in the artificial-reality environment, including VR content that is configured to be presented in substantially all of a user's field of view. The immersivity of such artificial-reality environments can create a richer, more engaging user experience for users than conventional computing systems with two-dimensional screens. Some artificial-reality environments, which may sometimes be described as metaverse environments, cause users to feel like they are in an entirely different world inhabited by users of the artificial-reality content as well as non-playable characters (NPCs) and other application-related content.

A drawback of the immersivity of individual artificial-reality experiences is that they may cause users to feel dissociated with other users (e.g., online friends) that are not interacting with the particular metaverse environments that the users are currently using. Further, such levels of immersion can be disorienting when users wish to navigate in and between different artificial-reality content associated with different VR environments. Inputs required to navigate within and between metaverse environments can be tedious and can cause an unwelcome interruption to an immersive experience.

As such, there is a need to address one or more of the above-identified challenges. A brief summary of solutions to the issues noted above are described below.

### SUMMARY

The methods, systems, and devices described herein allow users wearing artificial-reality headsets to experience the immersivity and interactivity of artificial-reality content, while also interacting with artificial-reality content associated with different metaverse environments (e.g., concurrently, within a same primary metaverse environment where artificial-reality content is being presented (e.g., a host environment)). By providing users of artificial-reality systems with interactable user interface elements for navigating and requesting persistent modifications (e.g., “sticky” interactions) to artificial-reality content of a secondary metaverse environment while the user is immersed within artificial-reality content of a primary metaverse environment, the techniques described herein allow users to interact with the secondary metaverse environment more conveniently, and while the users are simultaneously interacting with artificial-reality content and users within the primary metaverse content. Such methods, systems, and devices allow users to interact more efficiently and intuitively with other users that are interacting with artificial-reality content of different metaverse environments, including by providing continuous interactivity between users of a primary metaverse environment while the users are also interacting with different artificial-reality content of respective secondary metaverse environments.

As one example, Betty and Fred may be performing a sharing artificial-reality interaction, using different artificial-reality headsets, within a primary metaverse environment (e.g., a socially-oriented virtual world where users are encouraged to partake in various interactive activities, conversations, and/or events). While Betty and Fred are engaging in a conversation within the primary metaverse environment, they each cause different secondary metaverse environments to be presented within the primary metaverse environment, for different artificial-reality activities they each want to perform separately. For example, Betty causes artificial-reality content of a secondary metaverse environment for playing a chess game on a virtual chess board to be presented, and Fred causes artificial-reality content of a different secondary metaverse environment for playing a golf game on a simulated virtual golf course to be presented. Betty and Fred are able to engage in activities related to these different secondary metaverse environments, even “teleporting” into (i.e., virtually moving between) the respective environments such that the artificial-reality content of the respective secondary metaverse environments replaces the artificial-reality content of the primary metaverse environments (as presented by each of their artificial-reality headsets), while continuing to interact with each other within the primary metaverse environment (e.g., via audio communications, chat messaging system, and/or a metaverse-adjustment user interface element for facilitating cross-environment interactivity).

Further, Betty and Fred may be able to interact with the respective secondary metaverse environments that the other one is causing to be presented. For example, assuming that particular access criteria are satisfied, Fred may join the secondary metaverse environment that Betty is causing to be presented, in order to engage in a multi-player game of virtual chess. And Betty may also be able to see a visual representation of the secondary metaverse environment that Fred is causing to be presented. Betty may or may not see an identical visual representation of the secondary metaverse environment that Fred sees from his artificial-reality headset (e.g., depending on whether Betty has access to the artificial-reality content associated with virtual golf application that Fred is using). Betty may also be able to see, via her artificial-reality headset, an indication that Fred is performing a particular type of interaction with the secondary metaverse environment that he is causing to be presented. For example, Fred may perform a user input that modifies the presentation state of the respective secondary metaverse environment that he is causing to be presented.

One example of a method that a user can perform within a VR environment is described herein. The method includes presenting, via an artificial-reality system, a primary metaverse environment and a secondary metaverse environment corresponding to different artificial-reality content than the primary metaverse environment, wherein the different artificial-reality content of the secondary metaverse environment is presented using a first presentation state within the primary metaverse environment. The method further includes, while the different artificial-reality content of the secondary metaverse environment is being presented, via the first presentation state, within the primary metaverse environment: (i) detecting an input requesting a modification to the different artificial-reality content of the secondary metaverse environment, and (ii) in response to detecting the input, adjusting the different artificial-reality content of the secondary metaverse environment to reflect the requested modification. And the method includes, after adjusting the different artificial-reality content of the secondary metaverse environment to reflect the requested modification, in accordance with detecting a request to present the secondary metaverse environment using a second presentation state instead of the first presentation state: (i) ceasing to present the different artificial-reality content of the secondary metaverse environment using the first presentation state, and (ii) causing presentation of the different artificial-reality content of the secondary metaverse environment such that the different artificial-reality content is presented using the second presentation state and continues to reflect the modification caused by the input.

The methods, systems, and devices described herein provide improved functionality, including more efficient and intuitive user experiences, by allowing users to interact with other users within and across different artificial-reality content corresponding to separate metaverse environments. Some of these technical improvements are achieved by, for example, providing efficient and intuitive techniques for the users to interact with each other while they are interacting with different metaverse environments. And some of these technical improvements are also achieved by allowing users to be able to identify (e.g., via a visual indication in the artificial-reality content of the primary metaverse environment) when a particular user is interacting with a different metaverse environment than they are currently in. For example, a first user may be able to see that a second user is currently engaged in an immersive interaction with a secondary metaverse environment even though the second user is also interacting with the first user within the primary metaverse environment. Technical improvements achieved by the methods, systems, and devices described by this disclosure also allow users to interact with artificial-reality content of secondary metaverse environments while the respective artificial-reality content is being presented in various different presentation states, each of which may be preferable to the user at different times based on the interactions that the user is having in the primary metaverse environment.

The features and advantages described in the specification are not necessarily all inclusive and, in particular, certain additional features and advantages will be apparent to one of ordinary skill in the art in view of the drawings, specification, and claims. Moreover, it should be noted that the language used in the specification has been principally selected for readability and instructional purposes.

Having summarized the above example aspects, a brief description of the drawings will now be presented.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

For a better understanding of the various described embodiments, reference should be made to the Detailed Description below, in conjunction with the following drawings in which like reference numerals refer to corresponding parts throughout the figures.

FIGS. 1A-IE illustrate an example of users interacting with artificial-reality content associated with different respective metaverse environments, in accordance with some embodiments.

FIGS. 2A-2E illustrate examples of a secondary metaverse environment being presented with different presentation states within the primary metaverse environment, in accordance with some embodiments.

FIGS. 3A-3H illustrate an example of a user interacting with artificial-reality content associated with respective secondary metaverse environments using a metaverse-adjustment user interface.

FIG. 4 illustrates a flow diagram of a method of facilitating user interactions with respective artificial-reality content of multiple metaverse environments, in accordance with some embodiments.

FIGS. 5A-5C-2 illustrate example artificial-reality systems, in accordance with some embodiments.

FIGS. 6A-6B illustrate an example wrist-wearable device, in accordance with some embodiments.

FIGS. 7A-7C illustrate example head-wearable devices, in accordance with some embodiments.

FIGS. 8A-8B illustrate an example handheld intermediary processing device, in accordance with some embodiments.

In accordance with customary practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DETAILED DESCRIPTION

Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

Artificial-reality, as described herein, is any superimposed functionality and or sensory-detectable presentation provided by one or more components of an artificial-reality system within a user's physical surroundings. Such artificial-realities can include and/or represent VR, augmented reality, mixed artificial-reality (MAR, which may also be described herein as augmented-reality), or some combination and/or variation one of these. For example, a user can perform a swiping in-air hand gesture to cause a song to be skipped by a virtual application that is causing playback to be provided at, for example, a home speaker. An artificial-reality environment, as described herein, includes, but is not limited to, VR environments (including non-immersive, semi-immersive, and fully immersive VR environments); augmented-reality environments (including marker-based augmented-reality environments, markerless augmented-reality environments, location-based augmented-reality environments, and projection-based augmented-reality environments); hybrid reality; and other types of mixed-reality environments.

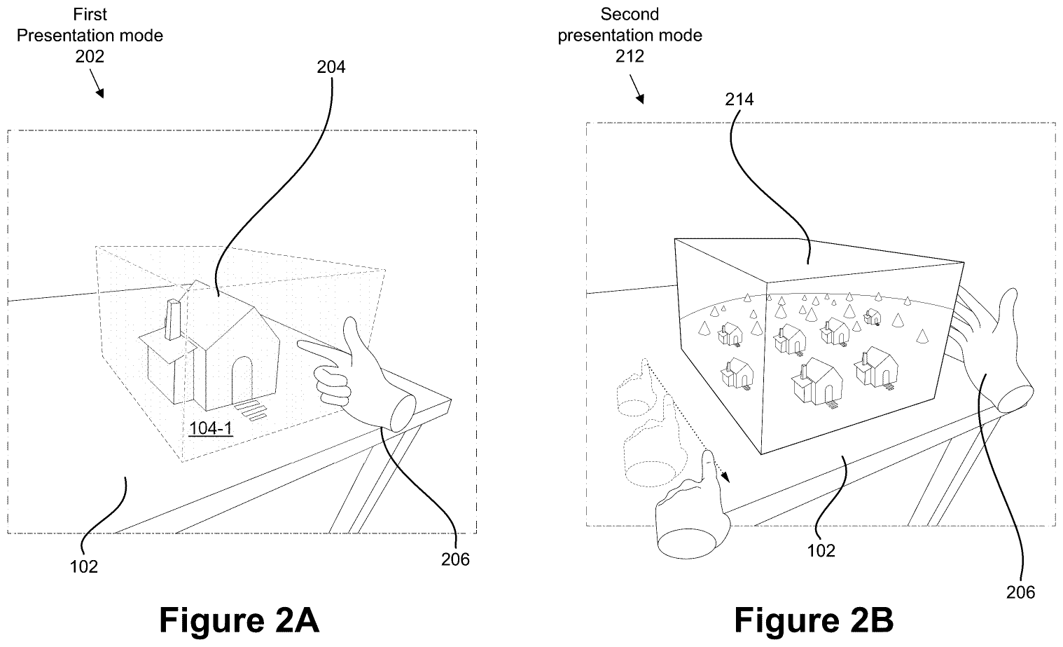

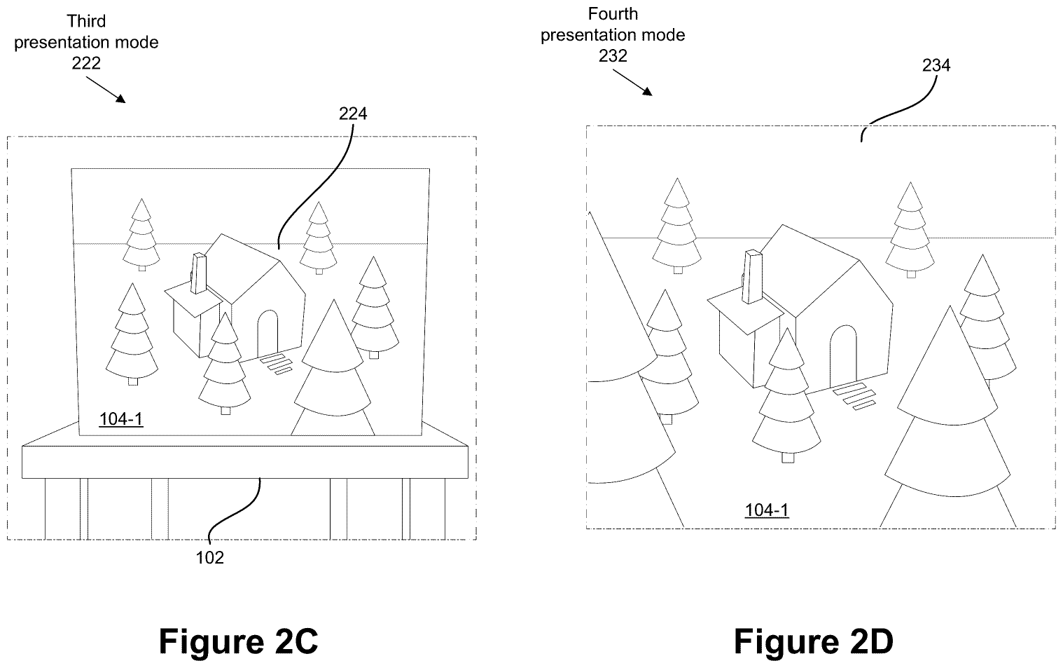

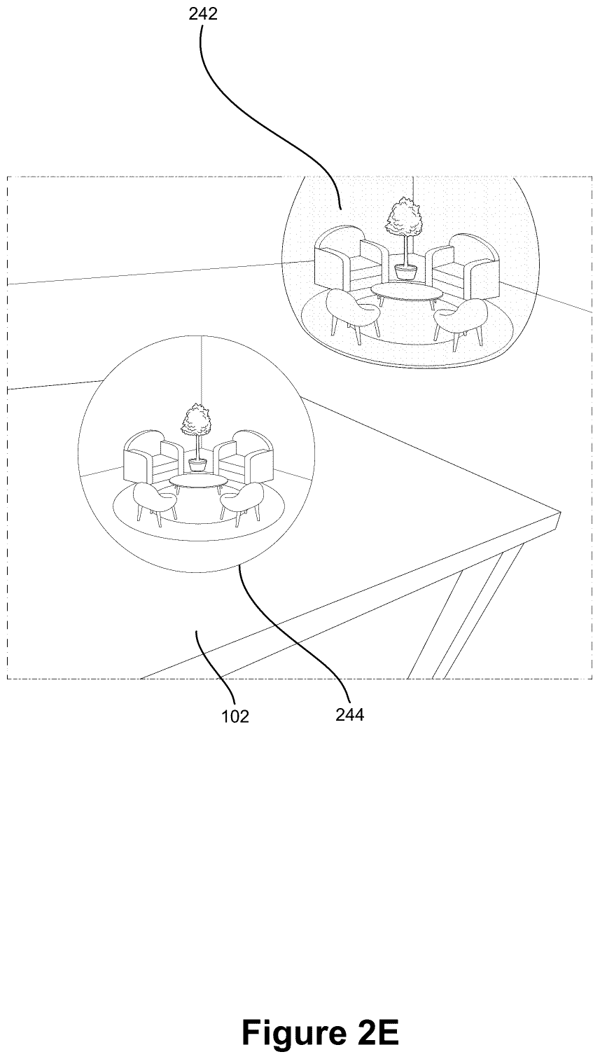

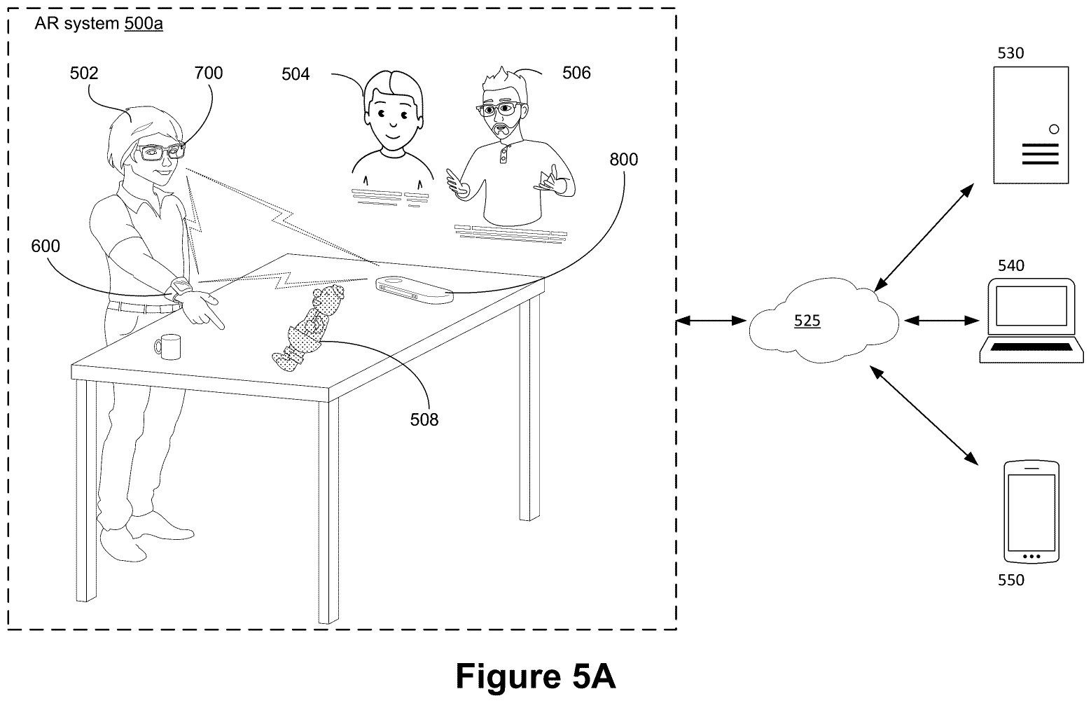

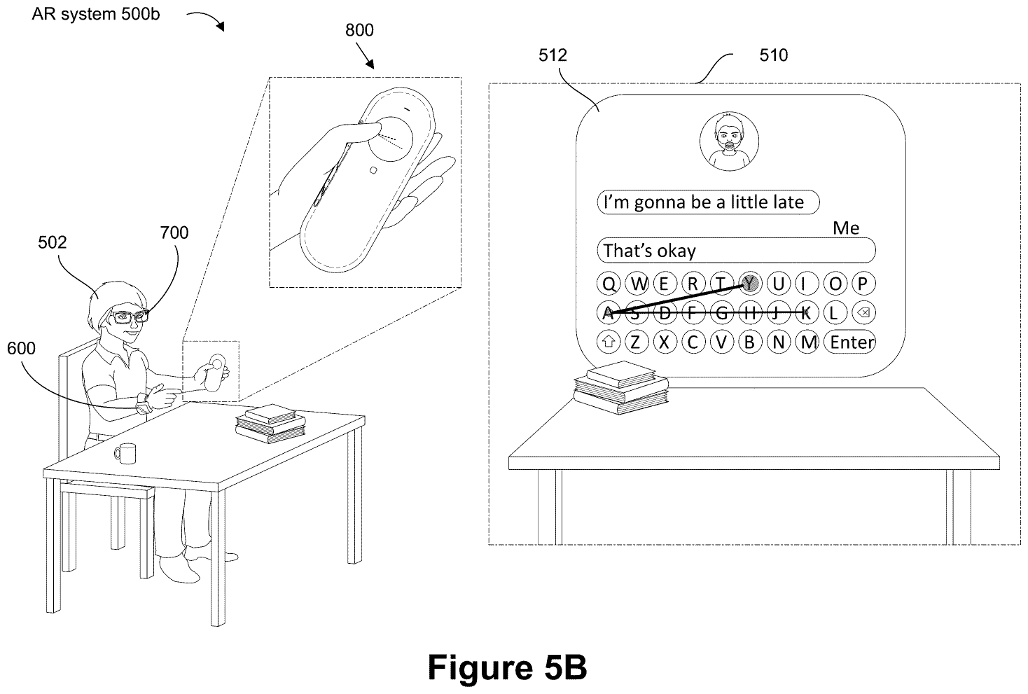

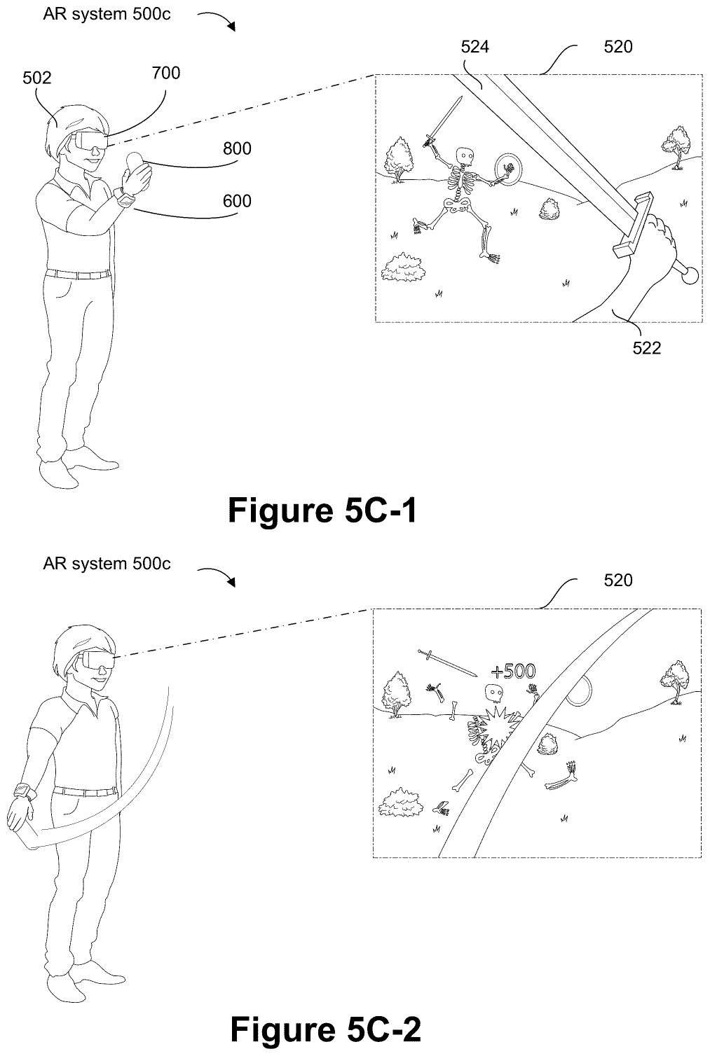

AR systems capable of implementing interactions with artificial-reality can include any of the artificial-reality systems 500a, 500b, 500c, and 500d described with respect to FIGS. 5A to 5C-2, respectively. Artificial-reality systems described herein may be computing systems that include some or all of the components described with respect to FIGS. 5A to 9C, including electronic devices and/or constituent components not explicitly described herein, but which one of skill in the art would understand as being capable of use within the artificial-reality systems described herein.

AR content presented by artificial-reality systems can be entirely comprised of generated content or generated content combined with captured (e.g., real-world) content. The artificial-reality content can include video, audio, haptic events, or some combination thereof, any of which can be presented in a single channel or in multiple channels (such as stereo video that produces a three-dimensional effect to a viewer). Additionally, in some embodiments, artificial reality can also be associated with applications, products, accessories, services, or some combination thereof, which are used, for example, to create content in an artificial reality and/or are otherwise used in (e.g., to perform activities in) an artificial reality.

A “metaverse environment” is a virtual environment (which may be described as a virtual universe, and/or a metaverse world) created by combining VR and augmented reality (AR) technologies. In a metaverse environment, users can interact with each other and with digital objects in a shared virtual space. It is often described as a persistent and immersive space that spans multiple platforms and devices, where people can engage in a variety of activities, such as gaming, socializing, working, and shopping. As described herein artificial-reality content of respective metaverse environments can be presented as primary metaverse environments and/or secondary metaverse environments. Metaverse environments can generally be interchangeably presented as either primary metaverse environments or secondary metaverse environments, although there can be particular metaverse environments that are configured particularly for one purpose or the other. For example, particular primary metaverse environments, which may be described as shell environments and/or host environments, may be particularly configured for compatible secondary metaverse environments to presented into. Such shell and/or host environment may be configured to facilitate social interactions in which users can interact with each other while interacting with VR content of different respective secondary environments. The users may be able to communicate with each other via the primary metaverse environment, even while they are fully immersed within the different respective secondary metaverse environments. The primary metaverse environments can also integrate privacy boundaries for the respective secondary metaverse environments (related to how the different secondary metaverse environments are capable of being viewed by other users of the primary metaverse environment). For example, a user may be interacting with a secondary metaverse environment that another user of the primary metaverse does not have access to. The visual representation of the secondary metaverse environment may be different, as viewed by the user that does not have access to the respective artificial-reality content of the secondary metaverse environment, than the visual representation shown by the artificial-reality headset of the user that is causing the secondary metaverse environment to be presented (and/or other users within the primary metaverse environment that do have permission to access the artificial-reality content of the respective secondary metaverse environment).

As described herein, a miniaturized representation (e.g., of a portion of a metaverse environment) is a representation of the metaverse environment that is configured (e.g., sized) to be presented in the user's entire field of view (e.g., as a portion or the entirety of a virtual object being presented to represent the respective secondary metaverse environment or portion thereof), which is presented in a portion of the primary metaverse environment while the primary metaverse environment is being presented in the user's entire field of view. In some embodiments, artificial-reality content being presented as a secondary metaverse environment within a particular primary metaverse environment may be referred to as an embeddable world augment for augmenting the artificial-reality content of the primary metaverse environment in which the artificial-reality content of the secondary metaverse environment is being presented within.

Modifications to metaverse environments, as described herein, include any changes to the artificial-reality content that the user is observing. Thus, modifications include displacing artificial-reality content within three-dimensional scenes, as well as adjustments to respective vantage points from which the user is observing the artificial-reality content. That is, the modifications caused by the user inputs are not localized to the particular representation of the secondary metaverse content that is being presented. For example, a user may perform a panning translational gesture directed to a three-dimensional location within the miniaturized representation of the secondary metaverse environment that causes a representational position of the user to be modified within the secondary metaverse environment (e.g., the user placing themselves within a different virtual room of a haunted house being presented by the artificial-reality content). Afterwards, the user adjusts a mode of presentation (e.g., which may be described herein as a presentation state) of the secondary metaverse environment such that the user is fully immersed within the secondary metaverse environment (e.g., the secondary metaverse environment replaces the primary metaverse environment). In some embodiments, the modification to the user's position in the secondary metaverse environment is reflected in the adjusted presentation state.

Requests for modification of the artificial-reality content of a metaverse environment can be performed by a user performing hand gestures, or other types of user inputs, directed to the artificial-reality content. A hand gesture, as described herein, can include an in-air gesture, a surface-contact gesture, and or other gestures that can be detected and determined based on movements of a single hand (e.g., a one-handed gesture performed with a user's hand that is detected by one or more sensors of a wearable device (e.g., electromyography (EMG) and/or inertial measurement units (IMU)s of a wrist-wearable device) and/or detected via image data captured by an imaging device of a wearable device (e.g., a camera of a head-wearable device)) or a combination of the user's hands. In-air means, in some embodiments, that the user hand does not contact a surface, object, or portion of an electronic device (e.g., a head-wearable device or other communicatively coupled device, such as the wrist-wearable device), in other words the gesture is performed in open air in 3D space and without contacting a surface, an object, or an electronic device.

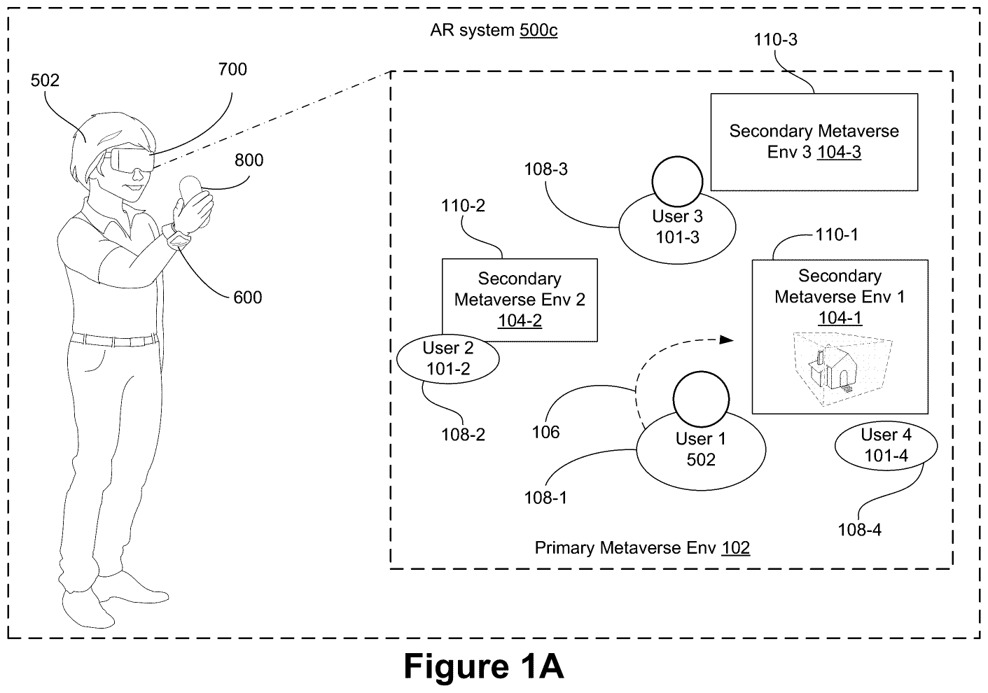

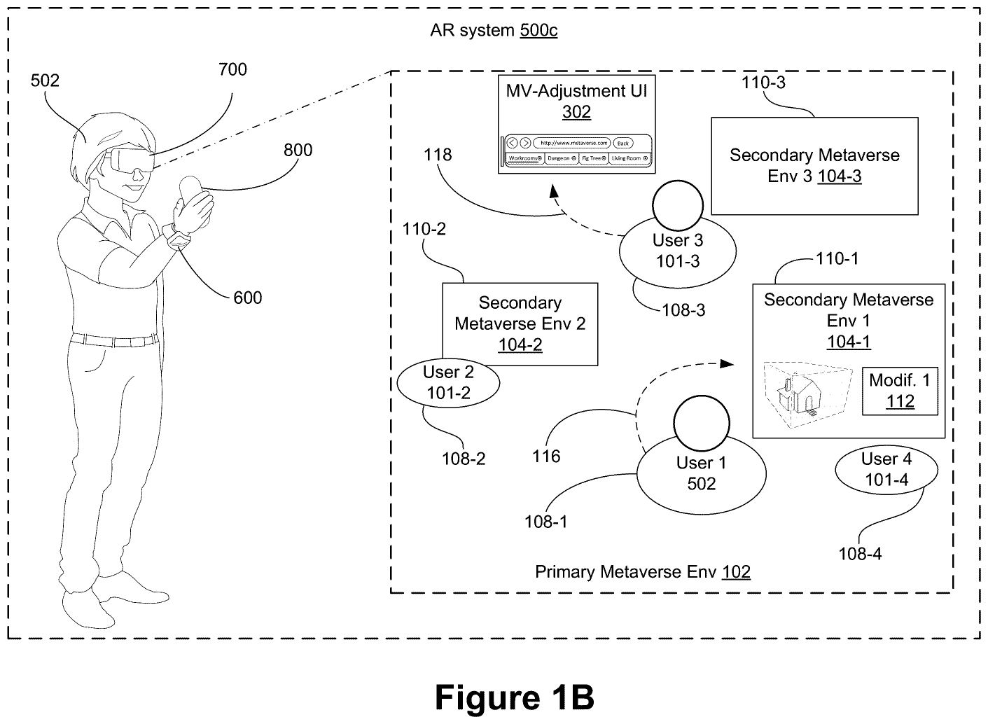

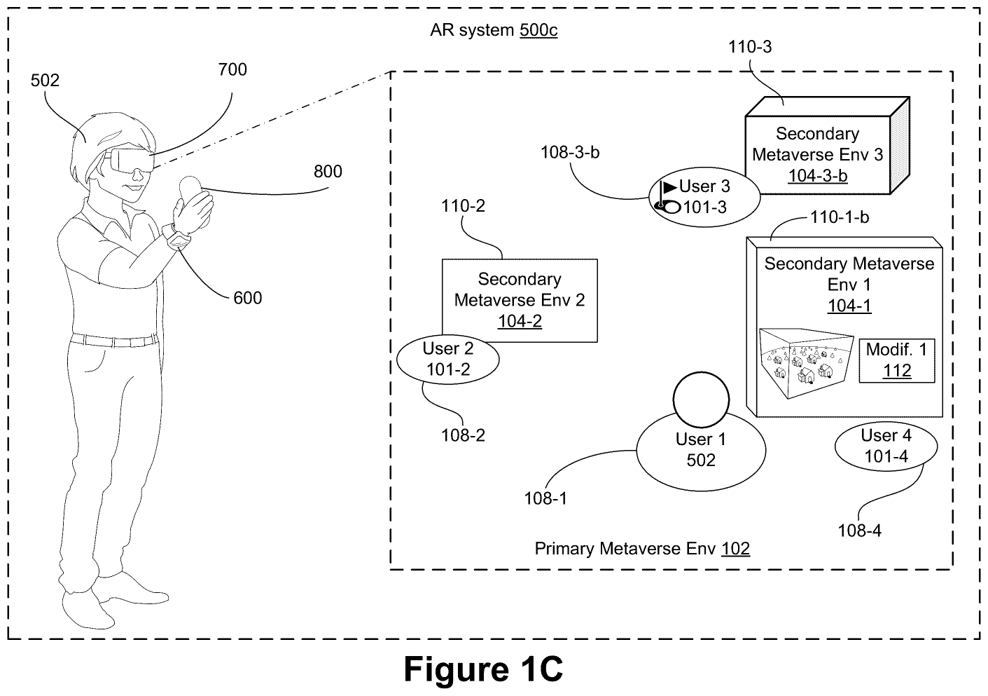

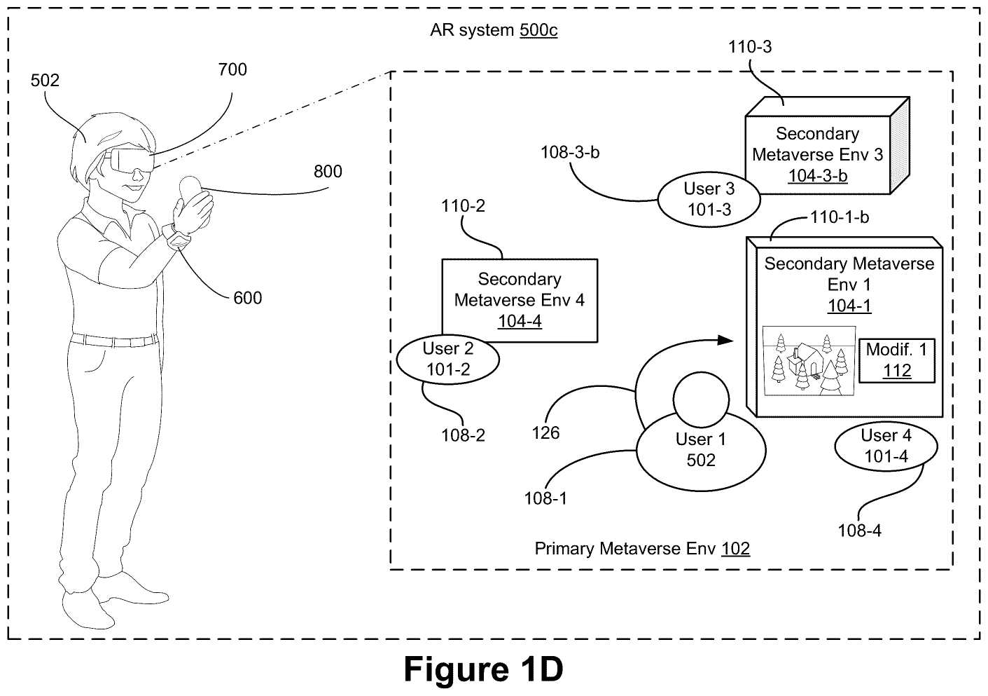

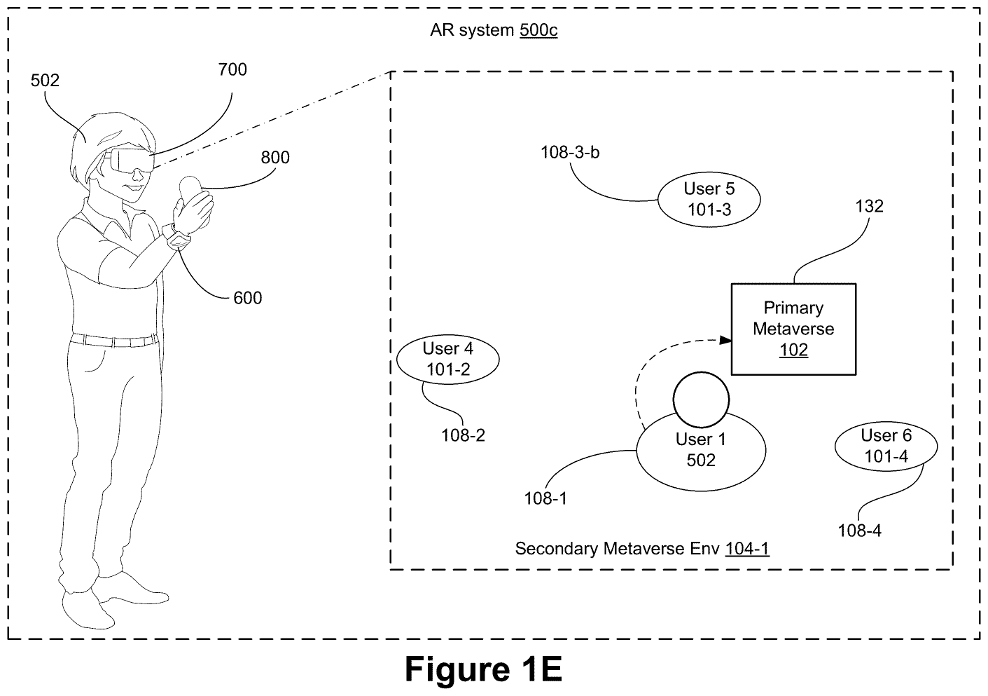

FIGS. 1A-IE illustrate an example artificial-reality system 500c that includes users interacting with artificial-reality content associated with different respective metaverse environments, in accordance with some embodiments. For explanatory purposes, various blocks of the sequence are described herein with reference to FIGS. 5A to 9C, and the associated devices, components, and/or processes described herein. For example, the artificial-reality system illustrated by FIGS. 1A to 1E is the artificial-reality system 500c, including one or more electronic devices shown in FIG. 5, such as a VR device 710, and optional components such as one or more wrist-wearable devices 600, a handheld intermediary processing device (HIPD) 800, and/or a smart textile-based garment 900. Various operations illustrated by the sequence of FIGS. 1A-IE can be performed similarly using an artificial-reality device 700.

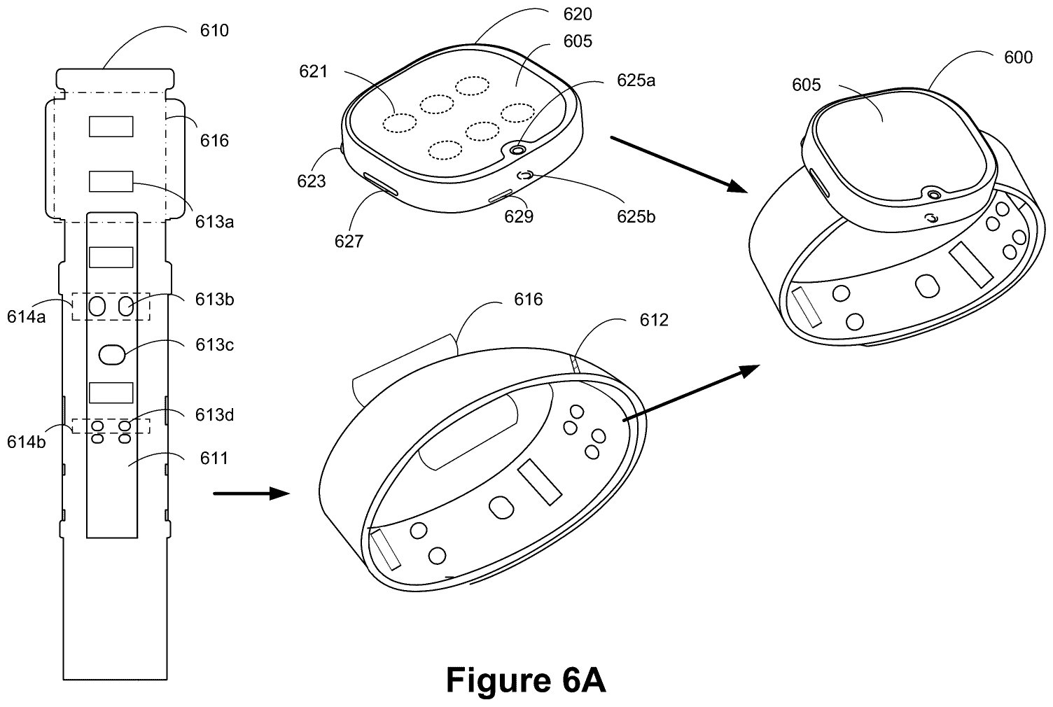

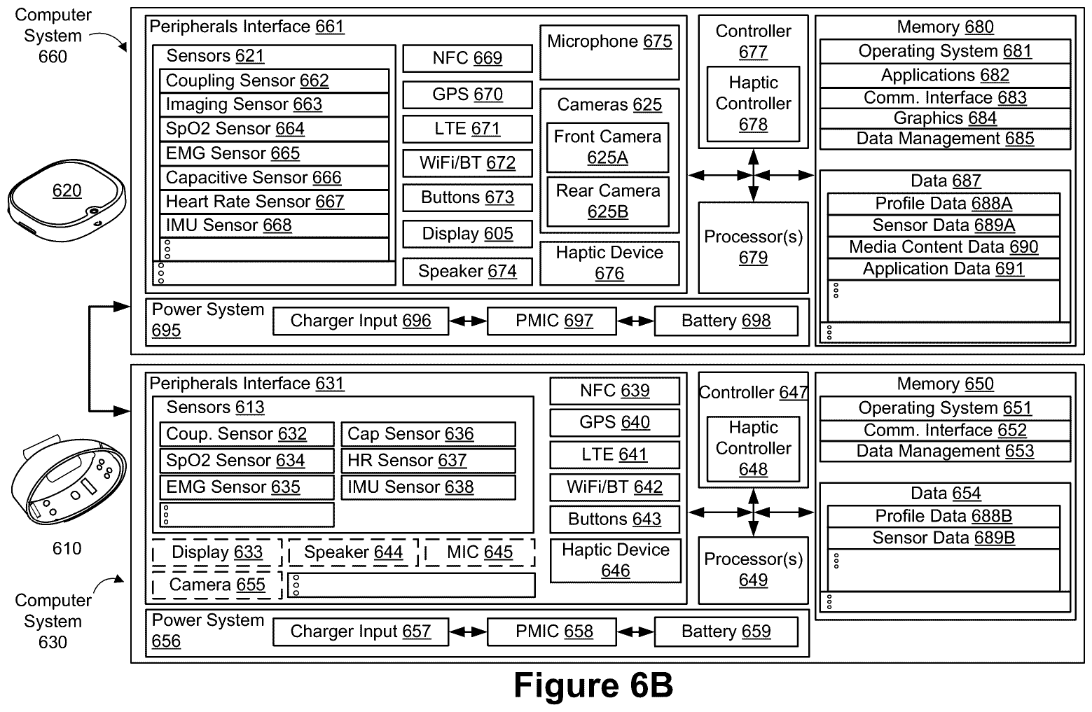

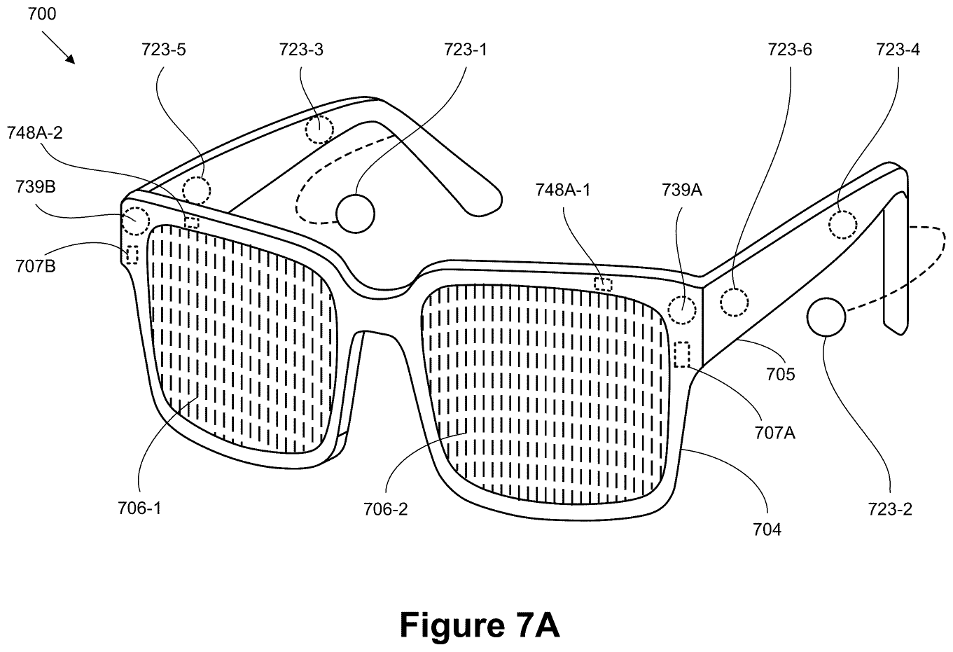

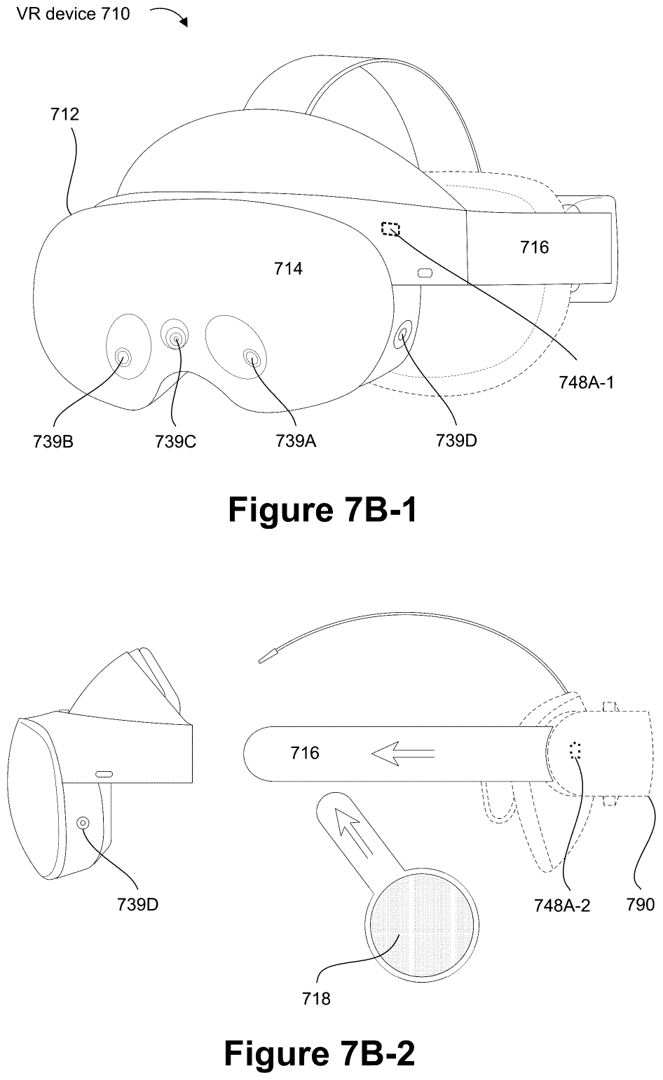

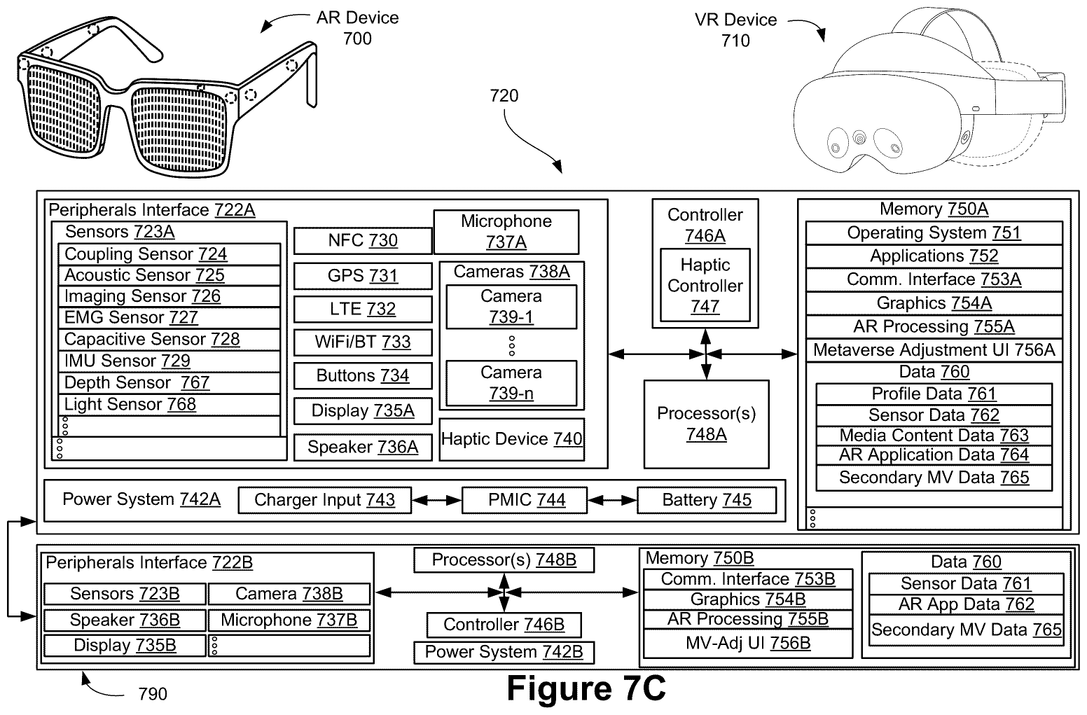

In accordance with various embodiments, artificial-reality system 500c is configured to present artificial-reality content that substantially immerses the user 502 (e.g., by presenting artificial-reality content in substantially all of a field of view of the user 502). The user 502 is wearing a VR device 710 (e.g., a head-wearable device, such as an augmented-reality headset) that is configured to present visual and/or other sensory aspects of the artificial-reality content, which may include a three-dimensional world of VR objects). The VR device 710 may include some or all of the components described with respect to FIGS. 7A to 7C. The user 502 is also wearing the wrist-wearable device 600, which may include some or all of the components described with respect to FIGS. 6A and 6B. Various interactions performed by the user 502 in the sequence illustrated by FIGS. 1A to 1E may be facilitated by one or more sensors of the electronic devices shown in FIG. 1A detecting user interactions by the user 502 with the artificial-reality system 500c. The user 502 is also holding a handheld intermediary processing device (HIPD) 800, which may include sensors for detecting distinct types of interactions by the user 502, in conjunction with or separately from the interactions detected by the VR device 710 and the wrist-wearable device 600.

In FIG. 1A, the user 502 is shown interacting with a primary metaverse environment 102 presented to the user 502 by the VR device 710. In accordance with some embodiments, the primary metaverse environment includes a first set of users (e.g., users 104-a to 104-3), where each of the respective users of the first set of users is interacting with the primary metaverse environment (e.g., while participating in a shared VR interaction, such as a video game, a training module, and/or a presentation of a live sporting event) via different VR devices, which may include some or all of the components described with respect to the VR device 710. The users can engage in interactions with each other within the primary metaverse environment 102, such as audio conversations, virtualized physical interactions between the respective virtual objects (e.g., virtual avatars, profile icons, trailing indicators, etc.) representing the different users within the metaverse environments.

While the users are engaged in a shared interactive experience within the primary metaverse environment 102, the users 502, 101-2, and 101-3 are also interacting with different artificial-reality content associated with secondary metaverse environments 104-1, 104-2, and 104-3, which are separate from the primary metaverse environment 102. For example, the user 502 and a user 101-4 are interacting with a secondary metaverse environment 104-1, a user 101-2 is interacting with a secondary metaverse environment 104-2, and a user 101-3 is interacting with a secondary metaverse environment 104-3.

Each of the respective secondary metaverse environments 104-1 to 104-3 may be associated with different VR applications. For example, the secondary metaverse environment 104-1 may include artificial-reality content for a virtual golfing application, the secondary metaverse environment 104-2 may include artificial-reality content for a virtual chess application, and the secondary metaverse environment 104-3 may include artificial-reality content for a content-creation application used by creators of metaverse environments. Each of the secondary metaverse environments 104-1 to 104-3 may be capable of being presented in various presentation states, some examples of which are described in more detail below with respect to FIGS. 2A-2D. For example, the artificial-reality content of the secondary metaverse environment 104-1 may be presented to the user 502 in a first presentation state that includes a miniaturized representation of a portion of the secondary metaverse environment 104-1.

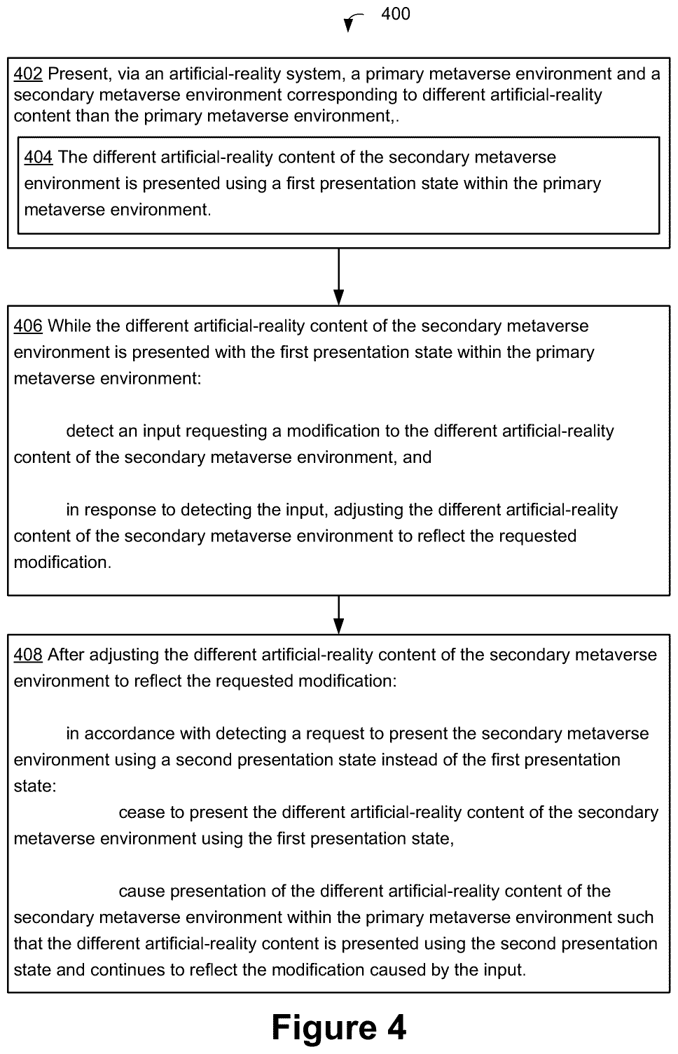

In some embodiments, artificial-reality content of different respective secondary metaverse environments may be presented distinctly to different users in the primary metaverse environment 102. For example, the secondary metaverse environment 104-1 may simultaneously be presented to the user 502 using the first presentation state that includes the miniaturized representation of the portion of the secondary metaverse environment, while being presented to the user 101-4 using a second presentation state that includes a three-dimensional (3D) virtual object that includes a three-dimension gesture interaction zone, as described in more detail with respect to FIG. 4B.

In some embodiments, the primary metaverse environment 102 includes distinctive visual aspects associated with the artificial-reality content presented in the primary metaverse environments. That is, different metaverse environments corresponding to different metaverse worlds or distinct parts of the same metaverse world may include characteristic aspects (e.g., visual features) that affect the way that common elements of the artificial-reality content are displayed. For example, user 502 may be represented as a first avatar (e.g., such as the avatar 504 or the digital representation of the contact 506) within a primary metaverse environment 102 (e.g., an avatar having physical features of a dog), and may be represented as a second avatar, having different visual aspects (e.g., an avatar having physical features of a cat) within the secondary metaverse environment 104-1.

A virtual object 110-1, which is a miniaturized representation of secondary metaverse content 104-1, is presented so as to appear at a particular three-dimensional position within the primary metaverse environment. In some embodiments, the virtual object 110-1 may be presented at a position relative to one of the electronic devices that the user 502 is using (e.g., the wrist-wearable device 600, and/or the HIPD 800). For example, the virtual object 110-1 may be presented so as to appear directly above a particular portion (e.g., a display portion) of the wrist-wearable device 600. In some embodiments, the artificial-reality content of the secondary metaverse environment 104-1 is presented in a particular location by default while it is in a particular presentation state, and can be subsequently moved to different locations by the user 502 by the user performing user inputs directed to the artificial-reality content of the secondary metaverse environment 104-1.

Simultaneously, in accordance with some embodiments, the virtual object 110-2 representing the secondary metaverse environment 104-2 is a three-dimensional virtual object, which is configured to present a portion of the secondary metaverse environment within a two-dimensional area of the virtual screen element. According to some embodiments, the virtual object 110-2 includes a three-dimensional interaction zone that is capable of receiving interactions at different three-dimensional locations corresponding to the artificial-reality content of the secondary metaverse environment 104-2. In some embodiments, user inputs directed at different depths with respect to a virtual location of the surface of the virtual object 110-2 can cause different operations on the respective artificial-reality content of the secondary metaverse environment 104-2. For example, a user input directed to the surface of the three-dimensional virtual object may cause a locational operation that does not modify the underlying artificial-reality content of the secondary metaverse environment, and another user input directed to an internal portion of the virtual object 110-2 may cause a second type of operation that does modify the underlying artificial-reality content of the secondary metaverse environment 104-2.

FIG. 1A also shows the user 502 performing a user input 106 that includes a request to modify the artificial-reality content of the secondary metaverse environment 104-1. While the user is performing the request to modify the artificial-reality content, a different visual representation of the hand of the user 502 can be presented as compared to when the user is interacting with the primary metaverse environment 102. For example, the user may be performing a user input to change the portion of the secondary metaverse environment 104-1 that is being represented by the virtual object 110-1 (e.g., a panning gesture), or the user may be performing a user input to cause a modification to the underlying artificial-reality content of the secondary metaverse environment 104-1 (e.g., moving a chair-shaped virtual object within a room of the secondary metaverse environment 104-1). In some embodiments, the set of operations that are available for modifying the secondary metaverse environment 104-1 is based on the presentation state that the secondary metaverse environment is being presented in within the primary metaverse environment 102. For example, a first set of user inputs may be available while the secondary metaverse environment 104-1 is being presented in the first presented mode, and a second set of user inputs may be available while the secondary metaverse environment 104-1 is being presented with one of the second, third, or fourth presentation states.

FIG. 1B shows another view of the sequence of the user 502 interacting with artificial-reality content of the secondary metaverse environment 104-1, after the user 502 has performed the user input 106 shown in FIG. 1A that includes a request to modify the artificial-reality content of the secondary metaverse environment 104-1. The artificial-reality content of the secondary metaverse environment 104-1 is being presented in the primary metaverse environment 102 with the same first presentation state that was used to present the artificial-reality content of the secondary metaverse environment 104-1 in FIG. 1A, but now, the artificial-reality content reflects the adjustment caused by the user input 106 shown in FIG. 1A. The user is performing a user input 116 requesting to cause presentation of the artificial-reality content of the secondary metaverse environment 104-1 to be presented with a different presentation state than it is being presented in FIGS. 1A and 1B.

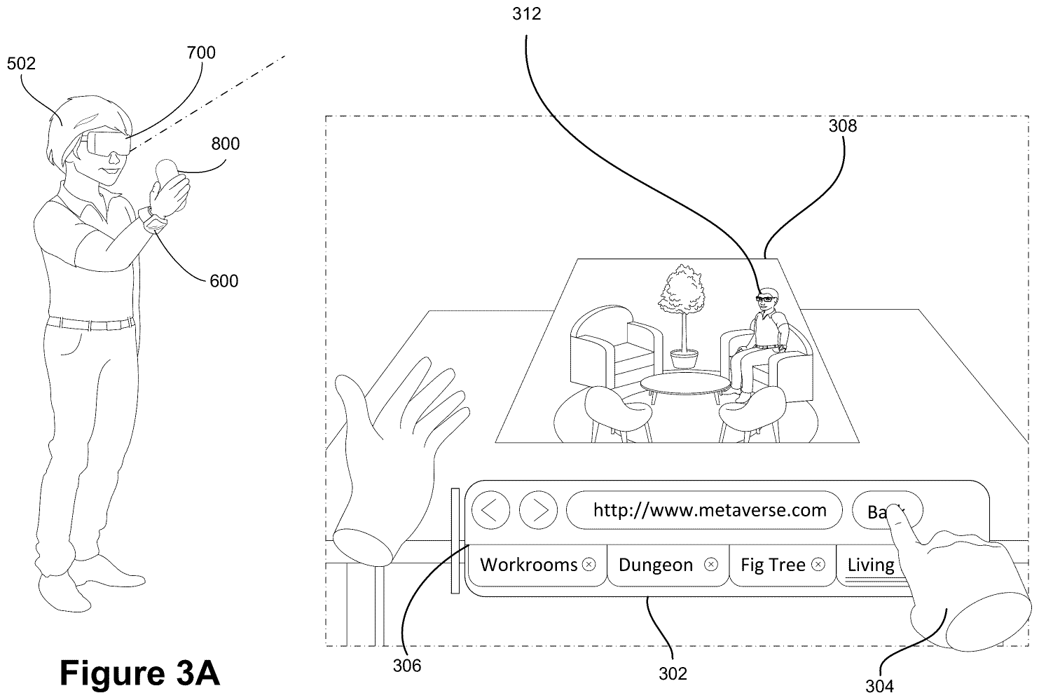

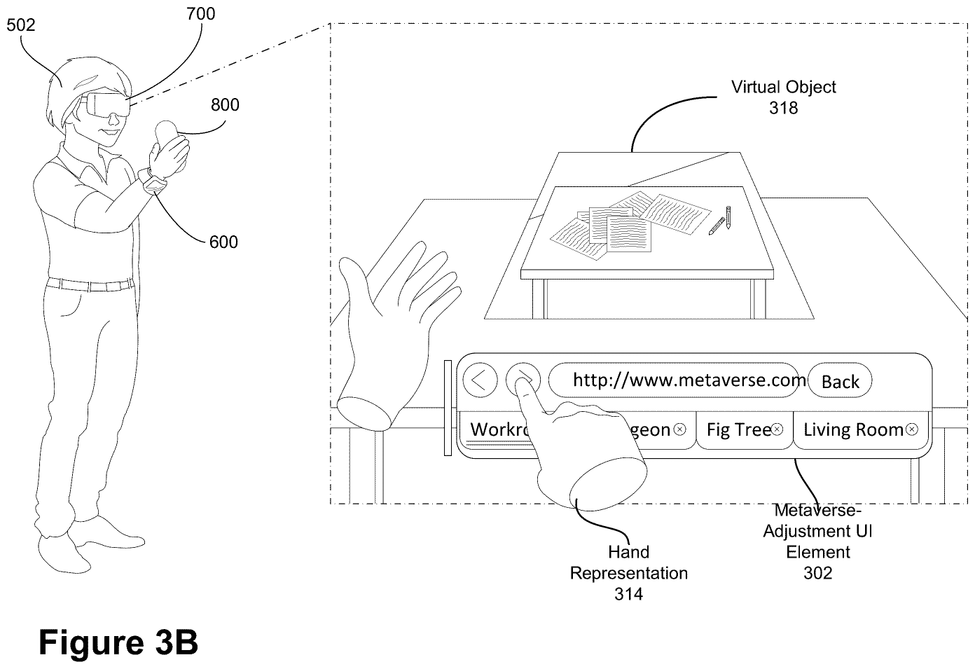

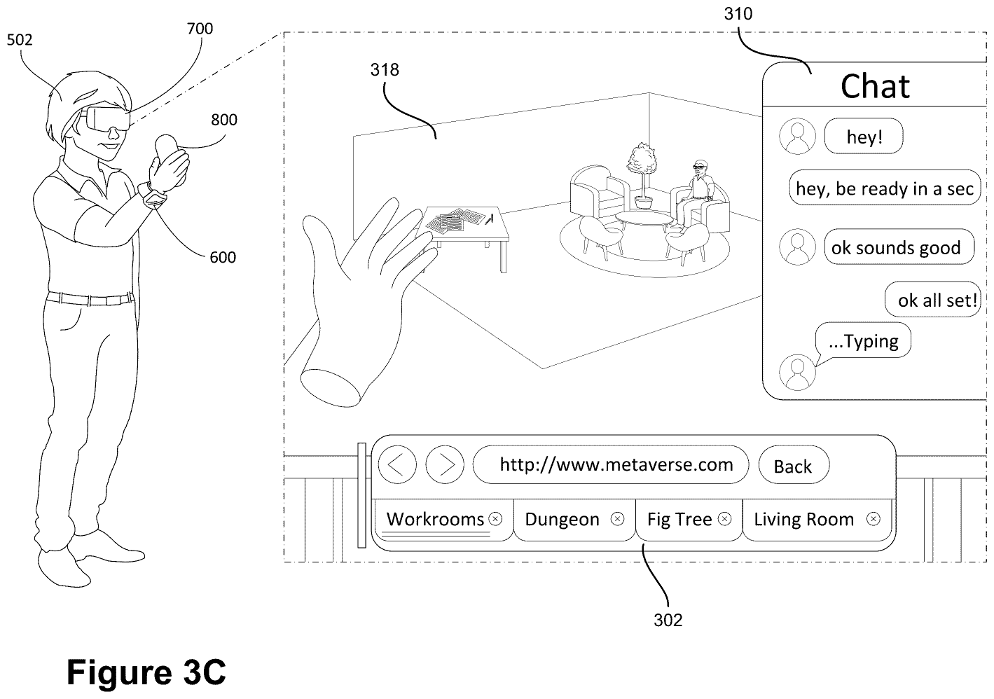

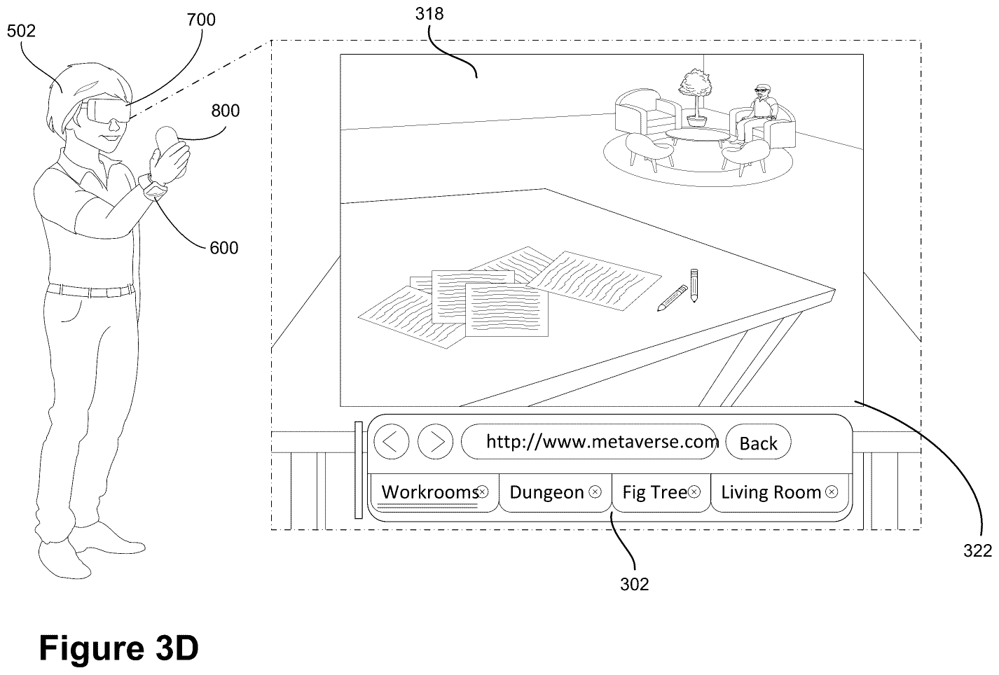

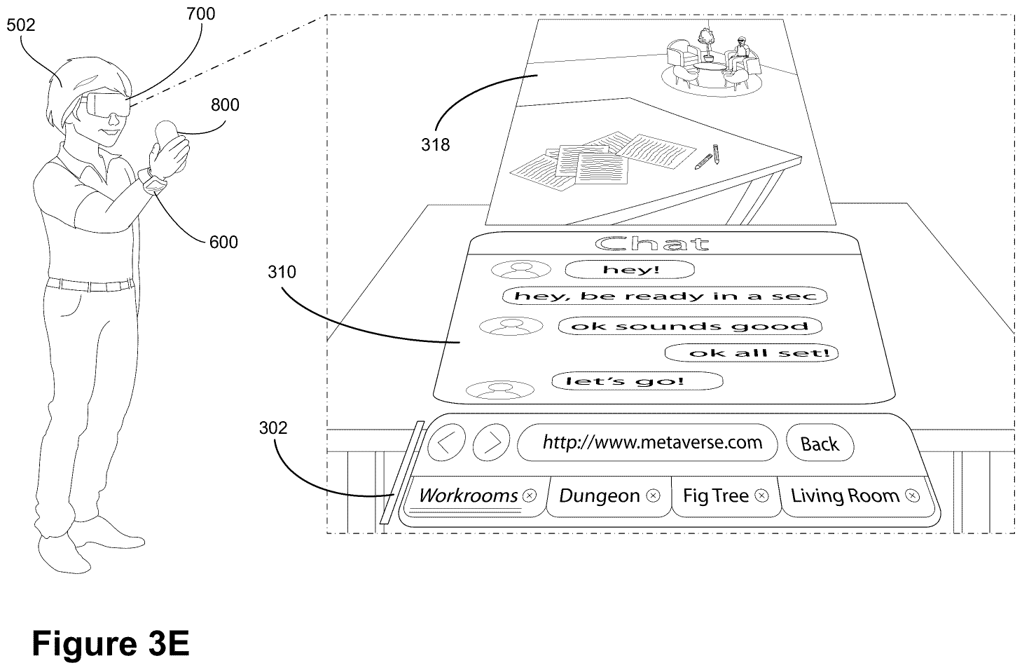

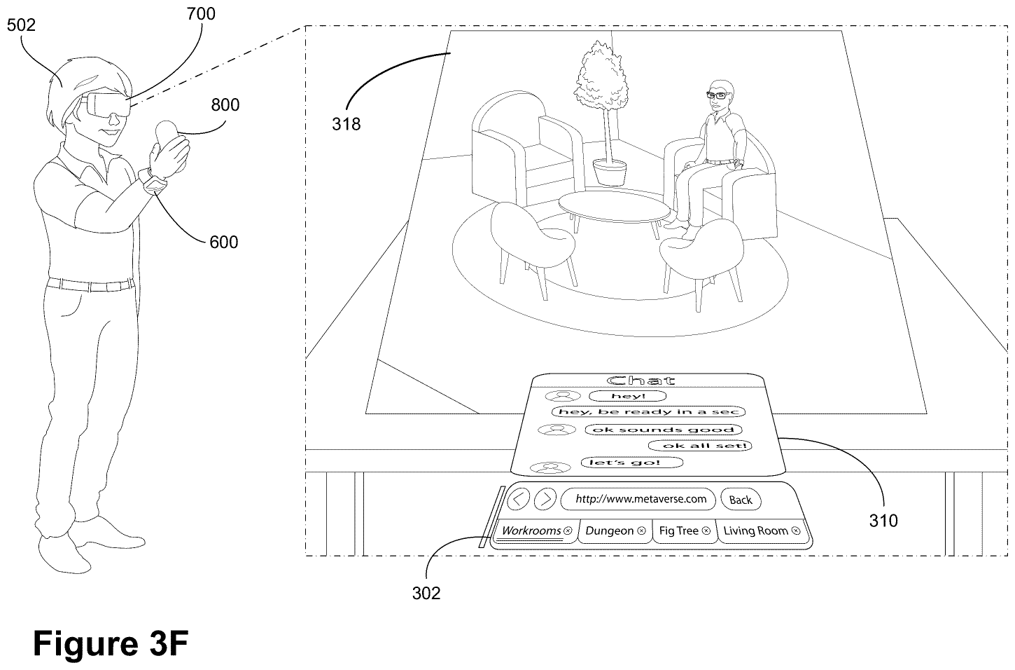

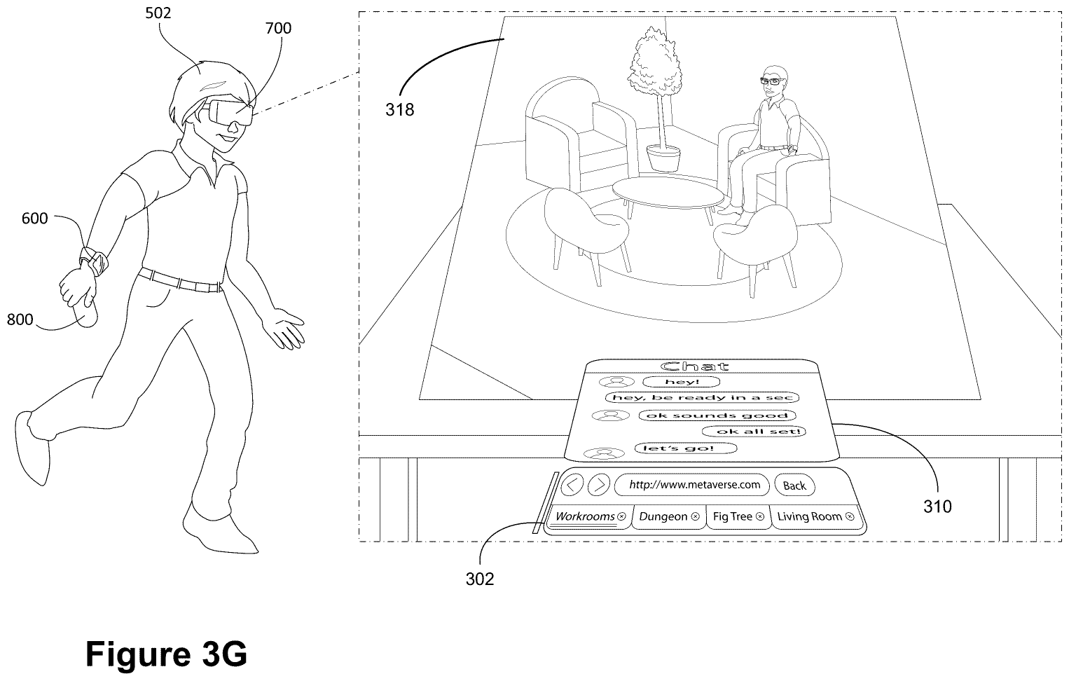

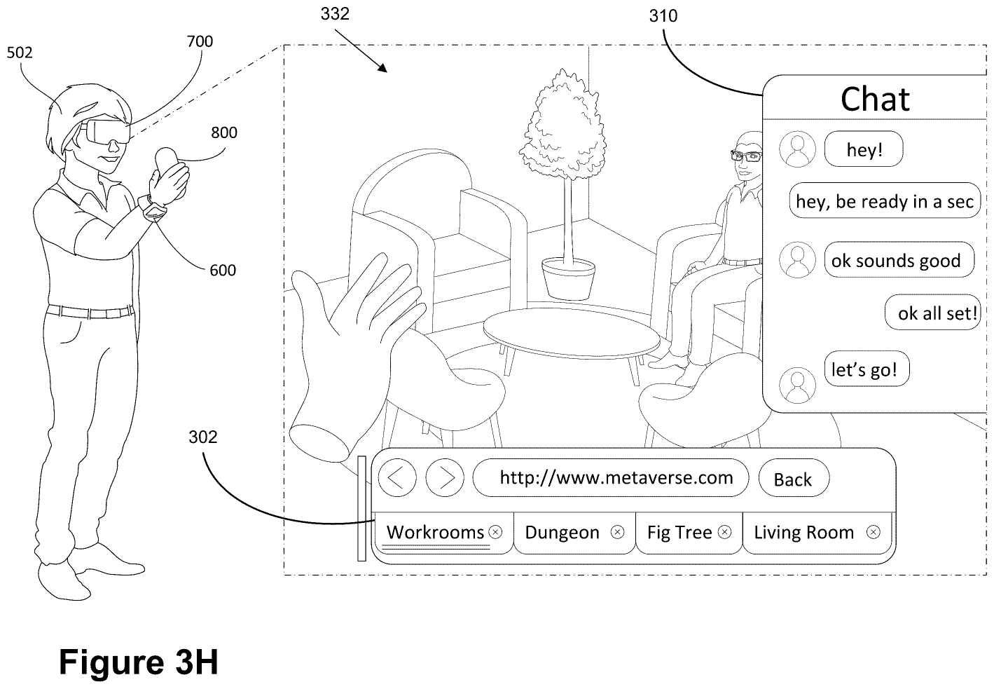

FIG. 1B also shows another user 101-3 interacting with a metaverse-adjustment user interface element 302 (which is described in more detail with respect to FIGS. 3A to 3H). As discussed with respect to FIGS. 3A to 3H, users can interact with artificial-reality content of secondary metaverse environments using metaverse adjustment user interface elements that are configured to cause adjustments to the artificial-reality content of the respective secondary metaverse environments that are being presented. For example, the user 101-3 in FIG. 1B may be performing a user input to cause them to become substantial immersed in (e.g., to teleport into) the artificial-reality content of the secondary metaverse environment 104-3. In some embodiments, the user can cause adjustments to different secondary metaverse environments being presented within the primary metaverse environment 102 (e.g., by directing the metaverse-adjustment user interface element 302 to artificial-reality content of different respective secondary metaverse environments within the primary metaverse environment 102. In some embodiments, the artificial-reality content of the respective secondary metaverse environments that are being presented within the primary metaverse environment 102 are only interactable via the metaverse-adjustment user interface element 302 if the respective user using the metaverse-adjustment user interface element has permissions to access the artificial-reality content of the respective secondary metaverse environments that they are attempting to control. In some embodiments, when a user attempts to interact with artificial-reality content of a secondary metaverse environment that another user is causing to be presented (e.g., if the user 101-3 attempts to interact with the artificial-reality content of the secondary metaverse environment 104-2 that the user 101-2 is causing to be presented), and the user 101-3 has permission to access the respective artificial-reality content of the secondary metaverse environment 104-2, the user 101-3 may be able to access the specific portion of the content that the user 101-2 is interacting with via the virtual object 110-2. In accordance with some embodiments, if a user is interacting with a particular metaverse environment that another user does not have access to (e.g., they have not purchased the application related to the metaverse content), then that user may not receive an indication that the modification is occurring, and/or may receive an indication that does not include the particular portion of metaverse content that is being modified.

FIG. 1C shows another view of the sequence of the user 502 interacting with the artificial-reality content of the secondary metaverse environment 104-1 while it is being presented within the primary metaverse environment 102. The artificial-reality content of the secondary metaverse environment 104-1 is being presented with a different presentation state than is shown in FIGS. 1A and 1B, and the different presentation state includes a three-dimensional virtual presentation object (e.g., a volumetric monitor). In accordance with some embodiments, although the artificial-reality content of the secondary metaverse environment is being presented with a different presentation state than in FIG. 1B, the modification 112 persists to be visible to the user 502, reflecting the modification that the user 502 requested in FIG. 1A. That is, in some embodiments, modifications to artificial-reality content of secondary metaverse environments continue to be perceptible to the user 502 even while the presentation state of the artificial-reality content is caused to change (e.g., based on a request performed by the user, another user, or as part of interaction occurring within the primary metaverse environment 102).

FIG. 1C also shows the user 101-3 being presented within the primary metaverse environment with a different visual indicator (e.g., a trailing indicator user interface element 108-3-b), which is different than the virtual avatar representing the user 101-3 that is shown in FIGS. 1A and 1B. In accordance with some embodiments, the user 101-3 is represented by a different visual indicator in FIG. 1C based on an interaction that the user 101-3 is having within the secondary metaverse environment 104-3.

FIG. 1D shows another view of the sequence in which the user 502 is interacting with the artificial-reality content of the secondary metaverse environment 104-1 while it is being presented within the primary metaverse environment 102. The user 101-2 is now interacting with artificial-reality content of a different secondary metaverse environment, a secondary metaverse environment 104-4 than they were interacting with in FIGS. 1A to 1C (in which the user 101-2 was interacting with a secondary metaverse environment 104-2). In some embodiments, user can utilize a metaverse-adjustment user interface element (e.g., the metaverse-adjustment user interface element 302 shown in FIGS. 3A to 3H) to adjust which respective secondary metaverse environment is being represented within the primary metaverse environment 102.

FIG. 1E shows another view where the user 502 is interacting with secondary metaverse environment 104-1 in an immersive manner, such that the secondary metaverse environment has replaced the primary metaverse environment 102 that the user 502 was shown immersed in during the points in the sequence represented by FIGS. 1A to 1D. That is, in some embodiments, the user 502 can replace the primary metaverse environment 102 with the respective secondary metaverse environment that they are currently interacting with (e.g., the secondary metaverse environment 104-1). In some embodiments, a particular presentation state of the secondary metaverse environment 104-1 includes a virtual guardian boundary, where the user 502 may move within the virtual guardian boundary to become immersed within the secondary metaverse environment. In some embodiments, the virtual guardian boundary functions similarly to a guardian boundary of the primary metaverse environment, except that the rules apply to interactions that are capable of occurring within the primary metaverse environment 102.

In some embodiments, in accordance with the user 502 causing the secondary metaverse environment 104-1 to replace the primary metaverse environment 102 as the immersive artificial-reality content being displayed by the VR headset 710, respective controls of the HIPD 800 are adjusted based on the respective controls that are specifically configured for immersive interactions with the artificial-reality content of the secondary metaverse environment 104-1. For example, the primary metaverse environment 102 may be a host environment that is specifically configured for presenting secondary metaverse environments, and while the user is immersed in the primary metaverse environment, the user inputs available on a touch surface 872 of the HIPD 800 may include a plurality of different user inputs for selecting different respective artificial-reality content of different secondary metaverse environments to present within the primary metaverse environment 102. And while the secondary metaverse environment 104-1 is being presented as immersive artificial-reality content by the VR device 710, the metaverse-adjustment user interface element 302 is configured to present a different set of user input options on the touch surface 872 that correspond to operations that are capable of being performed within the secondary metaverse environment 104-1.

FIGS. 2A-2E illustrate examples of a secondary metaverse environment being presented with different presentation states within the primary metaverse environment, in accordance with some embodiments.

FIG. 2A shows artificial-reality content of the secondary metaverse environment 104-1 being presented with a first presentation state 202. The first presentation state 202 includes a virtual object 204 with a miniaturized representation of a portion of the respective secondary metaverse environment being represented by the representation. In some embodiments, the virtual object 204 with the miniaturized representation includes a three-dimensional visual depiction of a scene that would be presented immersively as part of presenting the artificial-reality content of the respective secondary metaverse environment. In some embodiments, presenting the miniaturized representation of the portion of the secondary metaverse environment (e.g., as part of the virtual object 204) includes mapping a volume of the three-dimensional space that would be presented as part of an immersive representation of the artificial-reality content for the secondary metaverse environment 104-1 to the miniaturized representation (e.g., the virtual object 204).

In some embodiments, presenting the miniaturized representation of the secondary metaverse environment 104-1 includes removing one or more scene elements (e.g., ground textures, background elements) of the immersive presentation from the miniaturized representation within the virtual object 204 representing the secondary metaverse environment. In some embodiments, the miniaturized representation of the secondary metaverse environment does not include at least one background element of an immersive artificial-reality scene configured to be presented within the secondary metaverse environment. For example, the miniaturized representation does not include any visual elements corresponding to the blue-colored sky background, or the texture of the ground of the artificial-reality content associated with the secondary metaverse environment, as is shown in the other respective representations of the secondary metaverse environment shown in FIGS. 2B to 2D. In some embodiments, such elements may be visible, but are displayed with adjusted properties within the virtual object 204.

FIG. 2B shows the secondary metaverse environment 104-1 being presented with a second presentation state 212 that is different than the miniaturized representation of the secondary metaverse environment shown in FIG. 2A. While being presented with the second presentation state 212, the artificial-reality content of the respective secondary metaverse environment is presented as a volumetric presentation object 214 (e.g., a volumetric virtual monitor presenting the artificial-reality content of the secondary metaverse environment 110-1). In some embodiments, the volumetric presentation object includes a three-dimensional interaction zone configured to receive inputs from the user 502 (e.g., a three-dimensional touch sensitive surface, and/or a bi-modal interaction zone that is configured to receive a first set of user inputs directed to a surface portion of the three-dimensional interaction zone of the volumetric presentation object 214, and a second set of user inputs directed to an internal portion of the three-dimensional interaction zone. In some embodiments, a first representation of the hand of the user 502 is presented while the user 502 is performing an interaction directed to the primary metaverse environment 102, and a second representation of the hand of the user 502 is presented while the user 502 is performing an interaction directed to the secondary metaverse environment 110-1. In some embodiments, different respective representations of the hand of the user 502 can be presented based on whether the user 502 is interacting with a surface portion of the three-dimensional interaction zone as compared to an internal portion of the three-dimensional interaction zone of the volumetric presentation object.

FIG. 2C shows the secondary metaverse environment being presented in a third presentation state 222 that is different from both the first presentation state 202 shown in FIG. 2A and the second presentation state 212 shown in FIG. 2B. In some embodiments, the third presentation state includes a two-dimensional virtual display that is configured to display a particular field of view within the artificial-reality content of the secondary metaverse environment. In some embodiments, when the user adjusts their orientation and/or position (e.g., a virtual location) within the primary metaverse environment, there is a direct correspondence between the adjustment in to the artificial-reality content in the primary metaverse environment and the artificial-reality content in the secondary metaverse environment.

FIG. 2D shows the secondary metaverse environment being presented in a fourth presentation state where the user is substantially immersed in the secondary metaverse environment (e.g., replacing the primary metaverse environment). In some embodiments, a user causing the secondary metaverse environment to be presented in the fourth presentation state is referred to as teleporting (e.g., between metaverse environments). In some embodiments, one or more aspects of a visual representation of the user 502 are adjusted when the user 502 becomes immersed within the secondary metaverse environment 104-1.

FIG. 2E shows an example of AR content of a portion of the primary metaverse environment 102 being presented as a virtual object 244 for presenting secondary metaverse environments. That is, in some embodiments, artificial-reality content presented as a secondary metaverse environment can be a portion of the primary metaverse environment that the user is currently interacting with (e.g., the primary metaverse environment 102). In this way, users can interact with and simulate using a portion of a primary metaverse as a secondary metaverse environment (e.g., for purposes of content creation).

FIGS. 3A-3H illustrate an example of a user interacting with artificial-reality content associated with respective secondary metaverse environments using a metaverse-adjustment user interface.

FIG. 3A shows the user 502 interacting with artificial-reality content of the secondary metaverse environment 104-1 using a metaverse-adjustment user interface element 302, which is positionally-locked within the user's field of view relative to a presentation location where the secondary metaverse environment 104-1 is being presented. The secondary metaverse environment 104-1 is being presented with the third presentation state, as described in more detail with respect to FIG. 2C (e.g., as a virtual object 308 that includes a two-dimensional virtual screen element that includes a perspective view from a particular position and/or orientation within the artificial-reality content of the secondary metaverse environment). The position-locked location of the metaverse-adjustment user interface element 302 is illustrated by the position-lock indicator 306, which may be adjustable by the user 502 from within the primary metaverse environment 102. Respective artificial-reality content of the secondary metaverse environment 104-1 may also be adjusted based on which presentation state the artificial-reality content of the secondary metaverse environment is being presented with (e.g., a default position-locked location). While the user is interacting with the artificial-reality content of the secondary metaverse environment 104-1, the user 502 may interact with one or more users of the secondary metaverse environment (e.g., the user 312, shown sitting at a chair virtual object within the secondary metaverse environment).

The user 502 is performing a user input directed to a selectable button user interface element of the metaverse-adjustment user interface element 302, which corresponds to a request to modify the respective presentation state that the artificial reality content of the secondary metaverse environment 104-1 is being presented with. The metaverse-adjustment user interface element 302 can include additional selectable button (or tab) user interface elements for adjusting which secondary metaverse environment(s) are being presented (e.g., within the primary metaverse environment 102). In some embodiments, the user 502 can cause multiple different secondary metaverse environments to be presented within the primary metaverse environment 102.

FIG. 3B shows the user 502 interacting with artificial-reality content of the secondary metaverse environment 104-1 using a metaverse-adjustment user interface element 302 after performing the user input shown in FIG. 3A to change the presentation state of the artificial-reality content associated with the secondary metaverse environment 104-1. The user 502 is performing an input directed to another selectable button user interface element of the metaverse-adjustment user interface element 302 (e.g., a right-arrow button element) while a particular room of the secondary metaverse environment is being presented within the virtual object 318, which is presenting the secondary metaverse environment in a presentation state that includes a miniaturized representation of the secondary metaverse environment 104-1.

FIG. 3C shows the user 502 interacting with artificial-reality content of the secondary metaverse environment 104-1 using a metaverse-adjustment user interface element 302 after performing the user input shown in FIG. 3B (directed to the right-arrow button user interface element). Based on the user input performed by the user 502 in FIG. 3B, a modification is caused to the artificial-reality content of the secondary metaverse environment 104-1 to cause a different portion of the artificial-reality content to be presented in the same presentation state as shown in FIG. 3B, including the virtual object 318 having the miniaturized representation of the artificial-reality content.

FIG. 3D shows the user 502 interacting with the artificial-reality content of the secondary metaverse environment 104-1 while it is being presented with yet another presentation state different than the respective presentation states used to present the artificial-reality content shown in FIGS. 3A to 3C.

FIG. 3E shows the user 502 interacting with the artificial-reality content of the secondary metaverse environment 104-1 while it is being presented in another presentation state that includes a two-dimensional virtual screen element similar to that shown in FIG. 3D, but which includes a different arrangement of user interface elements within the primary metaverse environment 102. That is different presentation states for presenting the artificial-reality content of the secondary metaverse environment 104-1 can include the same or similar representations of the secondary metaverse content, but can still be distinct based on the way that the representation of the secondary metaverse environment 104-1 is presented within the primary metaverse environment 102.

FIG. 3F shows the user 502 interacting with the artificial-reality content of the secondary metaverse environment 104-1 while it is being presented in a different presentation state than is shown in any of FIGS. 3A-3E. In accordance with some embodiments, the artificial-reality content is presented in FIG. 3F in a presentation state that includes a two-dimensional (or optionally three-dimensional) position-locked user interface element that provides co-located portion of the secondary metaverse environment such that it aligns with a certain portion of the field of view of the user 502, including accounting for adjustments of the user's field of view within the primary metaverse environment 102. That is, while the user is interacting with a primary metaverse environment 102 (and/or aspects of their physical surroundings, they can interact with the representation of the artificial-reality content within the secondary metaverse environment 104-1 as if they were also moving (e.g., virtually) through the space represented by the artificial-reality content of the secondary metaverse environment 104-1. The user 502 is performing a gesture directed to the position-lock indicator on the right-hand side of the metaverse-adjustment user interface element 302 (e.g., a grabbing pinch gesture directed to the position-lock indicator).

FIG. 3G shows the user 502 interacting with the artificial-reality content of the secondary metaverse environment 104-1 while it is being presented in the same presentation state shown in FIG. 3F, while the user 502 is performing the grabbing gesture directed to the position-lock indicator user interface element corresponding to the right side of the metaverse-adjustment user interface element 302. The user 502 is moving through their physical environment while performing the grabbing gesture directed to the position-lock indicator. And as a result, the virtual object 318 is moving based on a position-locked orientation relative to the metaverse-adjustment user interface element 302. That is, in some embodiments, the user can choose whether the virtual object 318 should dynamically move as they move through their physical space (or a primary metaverse environment), or whether the virtual object 318 should be statically presented in a particular location within the environment that the user 502 is causing the artificial-reality content of the secondary metaverse environment to be presented.

FIG. 3H shows the user 502 interacting with the artificial-reality content of the secondary metaverse environment 104-1 while it is being presented as a primary metaverse environment (e.g., fully immersing the user 502 within the artificial-reality content of the secondary metaverse environment 104-1). That is, in accordance with some embodiments, metaverse environments can be interchangeable between being presented as primary metaverse environments and secondary metaverse environments, such that the terms can be relative to the way the content is currently being presented at any particular time. It should be noted that which content is being presented as a primary or secondary metaverse environment can be interchangeably selectable by the user and/or can be specific to the respective configurations of the metaverse environments. For example, a primary metaverse environment can include particular artificial-reality content that is configured specifically for presenting artificial-reality content of secondary metaverse environments (e.g., the secondary metaverse environments 104-1, 104-2, and/or 104-3).

FIG. 4 illustrates a flow diagram of a method of facilitating user interactions with respective artificial-reality content of multiple metaverse environments, in accordance with some embodiments. For explanatory purposes, the various blocks (e.g., operations, unordered steps, etc.) of the method 400 are described herein with reference to FIGS. 1A to 3H and FIGS. 5A to 9C, and the associated components and/or processes described herein. The one or more blocks of the method 400 may be implemented, for example, by one or more artificial-reality systems (e.g., concurrently, based on inputs by a plurality of different users of the different artificial-reality systems).

The artificial-reality system 500c presents (402) a primary metaverse environment and a secondary metaverse environment corresponding to different artificial-reality content than the primary metaverse environment. For example, the head-wearable device 700 is causing artificial-reality content of a primary metaverse environment 102 to the user 502 while they are wearing the head-wearable device 700. And within the artificial-reality content of the primary metaverse environment, the head-wearable device 700 presents different artificial-reality content associated with a secondary metaverse environment 104-1. As shown in FIG. 1A, the user 502 may also be able to see and/or interact with artificial-reality content of different secondary metaverse environments (e.g., secondary metaverse environments 104-2 and 104-3, which the user 502 sees as virtual objects within the primary metaverse environment 102.

The different artificial-reality content of the secondary metaverse environment is presented using a first presentation state within the primary metaverse environment (404), such as the first presentation state 202 shown in FIG. 2A that includes the miniaturized representation of a portion of the secondary metaverse environment.

While the artificial-reality system 500c is presenting the different artificial-reality content of the secondary metaverse environment using a first presentation state within the primary metaverse environment, the artificial-reality system 500c detects an input requesting a modification to the different artificial-reality content of the secondary metaverse environment, and, in response to detecting the input, the artificial-reality system 500c adjusts the different artificial-reality content of the secondary metaverse environment to reflect the requested modification (406). In some embodiments, the requested modification may be described as a “sticky” interaction with the secondary metaverse environment that causes a change to content within the secondary metaverse environment. For example, the user 502 can “reach in” to the secondary metaverse environment 104-1 to re-position and/or remove a user interface element (e.g., a virtual chair object) from within the different artificial-reality content of the secondary metaverse environment 104-1, as discussed with respect to FIG. 1A.

After adjusting the different artificial-reality content of the secondary metaverse environment to reflect the requested modification, in accordance with detecting a request to present the secondary metaverse environment using a second presentation state instead of the first presentation state, the artificial-reality system 500c ceases to present the different artificial-reality content of the secondary metaverse environment using the first presentation state, and the artificial-reality system 500c causes presentation of the different artificial-reality content of the secondary metaverse environment within the primary metaverse environment such that the different artificial-reality content is presented using the second presentation state and continues to reflect the modification caused by the input (408).

(A2) In some embodiments of A1, at a first time (e.g., a time associated with the point in the sequence represented by FIG. 1A), while another user of a different artificial-reality system, distinct from the artificial-reality system, is interacting with the primary metaverse environment in conjunction with the user (e.g., as part of a shared VR experience, such as a virtual meeting or video game), the artificial-reality system 500c presents a first representation of the other user within the primary metaverse environment (e.g., a virtual avatar representation that is caused to animate based on actions (e.g., body movements) performed by the other user). In some embodiments, at a second time different than the first time, in response to receiving an indication that the other user of the different artificial-reality system has moved from the primary metaverse environment to the secondary metaverse environment, the artificial-reality system 500c presents a second representation, distinct from the first representation, of the other user. In some embodiments, the second representation includes a trailing indicator (e.g., a static avatar face icon) associated with the other user in the primary metaverse environment. In some embodiments, the trailing indicator is meant to indicate to other users in the primary metaverse environment that the other user is interacting with the secondary metaverse environment. For example, in FIG. 1B, the user 101-3 performs an interaction that causes the user 101-3 to become fully immersed within the secondary metaverse environment 104-3. Based on this interaction the virtual object 108-3 shown in FIG. 1B is replaced by the other virtual object 108-3-b shown in FIG. 1C.

A respective user moving from one metaverse environment to another metaverse environment may be described herein as a user teleporting between artificial-reality content of different metaverse environments. As described herein, teleporting between metaverse environments includes causing a user to be transported (e.g., instantaneously) from one virtual environment to another, such that the user perceives being immersed within the metaverse environment that they have been teleported to (e.g., a secondary metaverse environment), instead of the metaverse environment from which they were teleported (e.g., a primary metaverse environment).

(A3) In some embodiments of A1 or A2, after the other user has moved from the primary metaverse environment to the secondary metaverse environment, based on an interaction that the other user has engaged in within the secondary metaverse environment, the artificial-reality system 500c presents a perceptible indicator (e.g., a visual icon, an animation, an audible notification, etc.) as part of the second representation of the other user within the primary metaverse environment. That is, in some embodiments, the primary metaverse environment is configured to continue facilitating interactions between the user and other users within the primary metaverse environment while the user is within the secondary metaverse environment. For example, the user 101-2 is presented as a virtual object that has a different visual appearance than the virtual objects presented for the users 502 and 101-1, which indicates that the user 101-2 has teleported into the secondary metaverse environment 104-3.

(A4) In some embodiments of A2 or A3, after the other user has moved from the primary metaverse environment to the secondary metaverse environment, based on an interaction that the other user is engaged in within the secondary metaverse environment, presenting a perceptible indicator as part of the second representation of the other user within the primary metaverse environment. In other words, the user 502 can interact with users in the primary metaverse environment 102 while they are interacting with (e.g., immersed within) the secondary metaverse environment 104-1. For example, while the user 502 is immersed within the artificial-reality content of the secondary metaverse environment 104-1, they can initiate a conversation with the user 101-2 that is immersed within the primary metaverse environment (e.g., via an audial or textual message, and/or a movement of the user's hand). This can be true even while the user 101-2 is interacting with the different virtual object 108-2 that is associated with the different secondary metaverse environment 104-2.

In some embodiments, the extent to which the respective other users in the primary metaverse can view the changes occurring in the secondary metaverse environment are based on whether the users have separate permissions associated with particular levels of access to the artificial-contents of the secondary metaverse environment that is being interacted with. For example, a user may only have access to a primary metaverse environment, and the same user may not have access to the secondary metaverse environment that another user is causing to be presented (e.g., with a particular presentation state) in the primary metaverse environment 102. The user may not be able to teleport into the secondary metaverse environment, based on the lack of permissions for accessing the artificial-reality content associated with the secondary metaverse environment, and/or some content that would otherwise be visible from the presentation of the artificial-reality content of the secondary metaverse environment 104-1 may not be visible to the user based on their lack of access to the underlying artificial-reality content.

(A5) In some embodiments of A1 to A4, while the artificial-reality system 500c presents the different artificial-reality content of the secondary metaverse environment using the second presentation state, detecting a second input requesting another modification to the secondary metaverse environment. In some embodiments, in accordance with detecting a request to present the artificial-reality content of the secondary metaverse environment using a third presentation state instead of the second presentation state, the artificial-reality system 500c ceases to present the different artificial-reality content of the secondary metaverse environment using the second presentation state, and the artificial-reality system 500c causes presentation of the different artificial-reality content of the secondary metaverse environment within the primary metaverse environment such that the different artificial-reality content is presented using the third presentation state and continues to reflect the modification and the other modification caused by the respective inputs requesting the modification and the other modification.

(A6) In some embodiments of A5, presenting the other artificial-reality content of the secondary metaverse environment using the first presentation state includes presenting a miniaturized representation of a portion of the secondary metaverse environment. In some embodiments, presenting the other artificial-reality content of the secondary metaverse environment using the second presentation state includes presenting a volumetric presentation object, wherein the volumetric presentation object is different than the miniaturized representation of the portion of secondary metaverse environment (e.g., a perspective-locked virtual screen element that includes content from an immersive view of the secondary metaverse environment).

In some embodiments, presenting the other artificial-reality content of the secondary metaverse environment using the third presentation state includes presenting a two-dimensional virtual display that is configured to display a field of view within the secondary metaverse environment. In some embodiments, the scale of objects within the secondary metaverse environment changes based on a display state of the secondary metaverse content. For example, a virtual chair object may have a first size relative to the user while the miniaturized representation of the secondary metaverse environment is being presented to the user, and may have a second size relative to the user while the second and/or third representations of the secondary metaverse environment are being presented.

(A7) In some embodiments of A6, the volumetric presentation object includes a three-dimensional interaction zone configure to receive inputs from the user. In some embodiments, gestures performed within the three-dimensional interaction zone are configured to cause operations to modify the artificial-reality content of the secondary metaverse environment.

(A8) In some embodiments of A7, while the user is interacting with the volumetric presentation object, (i) in accordance with detecting that the user is interacting with a surface of the volumetric presentation object, the artificial-reality system 500 presents a first representation of the hand of the user (which may indicate that the user is performing a surface-level interaction with the artificial-reality content of the secondary metaverse environment (e.g., a panning, translational, and/or rotational modification to the artificial-reality content)), and (ii) in accordance with detecting that the user is interacting with an internal portion of the volumetric presentation object (e.g., “reaching through” to the secondary metaverse environment), the artificial-reality system 500 presents a second representation of the hand of the user (which may indicate that the user is performing a “reach-through” interaction that actually modifies a portion of the artificial-reality content that the user is interacting with (rather than performing a gesture that simply modifies the view of the artificial-reality content)).

In some embodiments, user inputs directed to a surface of a volumetric presentation object (e.g., the volumetric presentation object shown in FIG. 2C) cause a first set of input commands at the second metaverse environment, and at-depth gestures performed while the second representation of the hand of the user is presented cause a second set of input commands at the secondary metaverse environment. For example, a first set of user inputs may cause translational, rotational, and/or related panning location displacement within the secondary metaverse environment 104-1.

(A9) In some embodiments any one of A6 to A8, presenting the miniaturized representation of the portion of the secondary metaverse environment includes: (i) mapping a volume of three-dimensional space of an immersive presentation of the secondary metaverse environment to the miniaturized representation of the secondary metaverse environment, and (ii) removing one or more scene elements (e.g., ground textures, background elements) of the immersive presentation from the miniaturized representation of the secondary metaverse environment. For example, the virtual object 204 shown in FIG. 2A shows the miniaturized representation of the artificial-reality content of the secondary metaverse environment 104-1.

(A10) In some embodiments of A9, the metaverse environment does not include at least one background element of an immersive artificial-reality scene configured to be presented within the secondary metaverse environment (e.g., ground, sky, audio content, etc.). For example, as illustrated in FIGS. 2A to 2D the miniaturized representation of the secondary metaverse content shown in the virtual object 204 does not include the blue-sky background shown for the same respective artificial-reality content of the secondary metaverse content while it is being presented in the second, third, or fourth presentation states 212, 222, and 232, respectively.

(A11) In some embodiments of any one of A1 to A10, the artificial-reality system 500c presents a metaverse-adjustment user interface element (e.g., the metaverse-adjustment user interface element 302, which may be a tab manager configured to present a plurality of selectable elements corresponding to different respective metaverse environments, and for toggling between presentation states of each respective metaverse environment). The metaverse-adjustment user interface element may be configured to be responsive to selection of: (i) a first set of user inputs for toggling between respective presentation states of a respective secondary metaverse environment that is currently being presented being presented, and (ii) a second set of user inputs replacing the respective secondary metaverse environment being presented with artificial-reality content of a different respective secondary metaverse environment. In some embodiments, the metaverse-adjustment user interface element is presented at a particular location in the three-dimensional space in front of the user. In some embodiments, the respective representations (e.g., presentation states) of the secondary metaverse environment are presented at a particular location relative to the metaverse-adjustment user interface element 302.

(A12) In some embodiments of A11, in response to detecting an adjustment input directed to a respective second user input of the second set of user inputs of the metaverse-adjustment user interface element, the artificial-reality system 500c presents a different secondary metaverse environment, distinct from the secondary metaverse environment, the different secondary metaverse environment presented in a same presentation state being used to display the secondary metaverse environment. In other words, the metaverse-adjustment user interface element 302 can allow the user to switch content while continuing to present artificial-reality content of the same respective selected secondary metaverse environments with the same presentation states.

(A13) In some embodiments of A1 to A12, the primary metaverse environment is a host application that includes one or more dedicated affordances (e.g., permanently presentable user interface elements) configured to provide interactivity with secondary metaverse environments presented within the primary metaverse environment. For example, the primary metaverse environment 102 may include particular code (e.g., non-transitory computer-readable storage media associated with an API server) that causes artificial-reality content of respective secondary metaverse environments to be presented in different presentation states (e.g., the first presentation state 202, the second presentation state 212, the third presentation state 222, and/or the fourth presentation state 232).

(A14) In some embodiments of A1 to A3, the artificial-reality content of the primary metaverse environment is a first portion of a first metaverse world associated with a first set of users such that the first set of users, including the user, can interact within the primary metaverse environment (e.g., a host application, such as a virtual town square application). And the other artificial-reality content of the secondary metaverse environment is a second portion of a second metaverse world associated with a second set of users, distinct from a first set of users and including the user, such that the second set of user can interact within the secondary metaverse environment (e.g., a gaming application, such as a mini-golfing application.

(A15) In some embodiments of A14, the artificial-reality system 500 presents within the first presentation state of the secondary metaverse environment, an indication (e.g., a visual representation of an activity that the user is performing in the secondary metaverse environment) that a respective second user of the second set of users associated with the secondary metaverse environment is interacting with the secondary metaverse environment being presented with the first presentation state. For example, a golf flag icon is overlayed on the visual representation of the user 101-3.

(A16) In some embodiments of A14 or A15, the primary metaverse environment includes one or more additional representations of metaverse environments corresponding to other secondary metaverse environments being interacted with by respective first users of the first set of users.

In some embodiments, the additional representations of the other secondary metaverse environments being interacted with by the respective first users may be presented differently to the user by the artificial-reality system 500c than the secondary metaverse environment being presented with the first presentation state. For example, the user may see one of the other secondary metaverse environments represented as a generic icon corresponding to the other secondary metaverse environment, and may not include details about what the other first user is interacting with in the other secondary metaverse environment.

(A17) In some embodiments of any one of A14 to A16, while the user is teleported into the secondary metaverse environment, the artificial-reality system 500c receives an indication that a different first user of the first set of users has requested to be teleported into the secondary metaverse environment. In some embodiments, the artificial-reality system 500c presents the different user within the secondary metaverse environment based on satisfying secondary metaverse access criteria.

(B1) In accordance with some embodiments, a non-transitory computer readable storage medium includes instructions that, when executed by a computing device in communication with an artificial-reality headset (e.g., VR device 710), cause the computer device to perform operations corresponding to any of A1-A17.

(C1) In accordance with some embodiments, an artificial-reality system includes a presentation device, one or more processors, and memory. And the memory includes instructions, which, when executed by the one or more processors, causes one or more operations of any one of A1 to A17.

Some of the devices described above are further detailed below, including systems, wrist-wearable devices, headset devices, and smart textile-based garments. Specific operations described above may occur as a result of specific hardware, such hardware is described in further detail below. The devices described below are not limiting and features on these devices can be removed or additional features can be added to these devices. The different devices can include one or more analogous hardware components. For brevity, analogous devices and components are described below. Any differences in the devices and components are described below in their respective sections.

As described herein, a processor (e.g., a central processing unit (CPU), microcontroller unit (MCU), etc.), is an electronic component that is responsible for executing instructions and controlling the operation of an electronic device (e.g., a wrist-wearable device 600, a head-wearable device, an HIPD 800, a smart textile-based garment 900, or other computer system). There are distinct types of processors that may be used interchangeably, or may be specifically required, by embodiments described herein. For example, a processor may be: (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) a graphics processing unit (GPU) designed to accelerate the creation and rendering of images, videos, and animations (e.g., VR animations, such as three-dimensional modeling); (iv) a field-programmable gate array (FPGA) that can be programmed and reconfigured after manufacturing, and/or can be customized to perform specific tasks, such as signal processing, cryptography, and machine learning; (v) a digital signal processor (DSP) designed to perform mathematical operations on signals such as audio, video, and radio waves. One of skill in the art will understand that one or more processors of one or more electronic devices may be used in various embodiments described herein.

As described herein, controllers are electronic components that manage and coordinate the operation of other components within an electronic device (e.g., controlling inputs, processing data, and/or generating outputs). Examples of controllers can include: (i) microcontrollers, including small, low-power controllers that are commonly used in embedded systems and Internet of Things (IoT) devices; (ii) programmable logic controllers (PLCs) which may be configured to be used in industrial automation systems to control and monitor manufacturing processes; (iii) system-on-a-chip (SoC) controllers that integrate multiple components such as processors, memory, I/O interfaces, and other peripherals into a single chip; and/or DSPs. As described herein, a graphics module is a component or software module that is designed to handle graphical operations and/or processes, and can include a hardware module and/or a software module.

As described herein, memory refers to electronic components in a computer or electronic device that store data and instructions for the processor to access and manipulate. The devices described herein can include volatile and non-volatile memory. Examples of memory can include: (i) random access memory (RAM), such as DRAM, SRAM, DDR RAM or other random access solid state memory devices, configured to store data and instructions temporarily; (ii) read-only memory (ROM) configured to store data and instructions permanently (e.g., one or more portions of system firmware, and/or boot loaders); (iii) flash memory, magnetic disk storage devices, optical disk storage devices, other non-volatile solid state storage devices, which can be configured to store data in electronic devices (e.g., USB drives, memory cards, and/or solid-state drives (SSDs); and (iv) cache memory configured to temporarily store frequently accessed data and instructions. Memory, as described herein, can include structured data (e.g., SQL databases, MongoDB databases, GraphQL data, JSON data, etc.). Other examples of memory can include: (i) profile data, including user account data, user settings, and/or other user data stored by the user; (ii) sensor data detected and/or otherwise obtained by one or more sensors; (iii) media content data including stored image data, audio data, documents, and the like; (iv) application data, which can include data collected and/or otherwise obtained and stored during use of an application; and/or any other types of data described herein.

As described herein, a power system of an electronic device is configured to convert incoming electrical power into a form that can be used to operate the device. A power system can include various components, including: (i) a power source, which can be an alternating current (AC) adapter or a direct current (DC) adapter power supply; (ii) a charger input, and can be configured to use a wired and/or wireless connection (which may be part of a peripheral interface, such as a USB, micro-USB interface, near-field magnetic coupling, magnetic inductive and magnetic resonance charging, and/or radio frequency (RF) charging); (iii) a power-management integrated circuit, configured to distribute power to various components of the device and to ensure that the device operates within safe limits (e.g., regulating voltage, controlling current flow, and/or managing heat dissipation); and/or (iv) a battery configured to store power to provide usable power to components of one or more electronic devices.

As described herein, peripheral interfaces are electronic components (e.g., of electronic devices) that allow electronic devices to communicate with other devices or peripherals, and can provide a means for input and output of data and signals. Examples of peripheral interfaces can include: (i) universal serial bus (USB) and/or micro-USB interfaces configured for connecting devices to an electronic device; (ii) bluetooth interfaces configured to allow devices to communicate with each other, including bluetooth low energy (BLE); (iii) near field communication (NFC) interfaces configured to be short-range wireless interface for operations such as access control; (iv) POGO pins, which may be small, spring-loaded pins configured to provide a charging interface; (v) wireless charging interfaces; (vi) GPS interfaces; (vii) WiFi interfaces for providing a connection between a device and a wireless network; (viii) sensor interfaces.

As described herein, sensors are electronic components (e.g., in and/or otherwise in electronic communication with electronic devices, such as wearable devices) configured to detect physical and environmental changes and generate electrical signals. Examples of sensors can includer: (i) imaging sensors for collecting imaging data (e.g., including one or more cameras disposed on a respective electronic device); (ii) biopotential-signal sensors; (iii) inertial measurement unit (e.g., IMUs) for detecting, for example, angular rate, force, magnetic field, and/or changes in acceleration; (iv) heart rate sensors for measuring a user's heart rate; (v) SpO2 sensors for measuring blood oxygen saturation and/or other biometric data of a user; (vi) capacitive sensors for detecting changes in potential at a portion of a user's body (e.g., a sensor-skin interface) and/or the proximity of other devices or objects; (vii) light sensors (e.g., time-of-flight sensors, infrared light sensors, visible light sensors, etc.), and/or sensor for sensing data from the user or the user's environment. As described herein biopotential-signal-sensing components are devices used to measure electrical activity within the body (e.g., biopotential-signal sensors). Some types of biopotential-signal sensors include: (i) electroencephalography (EEG) sensors configured to measure electrical activity in the brain to diagnose neurological disorders; (ii) electrocardiography (ECG or EKG) sensors configured to measure electrical activity of the heart to diagnose heart problems; (iii) electromyography (EMG) sensors configured to measure the electrical activity of muscles and to diagnose neuromuscular disorders; (iv) electrooculography (EOG) sensors configure to measure the electrical activity of eye muscles to detect eye movement and diagnose eye disorders.

As described herein, an application stored in memory of an electronic device (e.g., software) includes instructions stored in the memory. Examples of such applications include: (i) games; (ii) word processors; (iii) messaging applications; (iv) media-streaming applications; (v) financial applications; (vi) calendars; (vii) clocks; (viii) web-browsers; (ix) social media applications, (x) camera applications, (xi) web-based applications; (xii) health applications; (xiii) artificial reality applications, and/or any other applications that can be stored in memory. The applications can operate in conjunction with data and/or one or more components of a device or communicatively coupled devices to perform one or more operations and/or functions.

As described herein, communication interface modules can include hardware and/or software capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document. A communication interface is a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, Bluetooth). In some embodiments, a communication interface can refer to a software layer that enables different software programs to communicate with each other (e.g., application programming interfaces (APIs), protocols like HTTP and TCP/IP, etc.).

As described herein, a graphics module is a component or software module that is designed to handle graphical operations and/or processes, and can include a hardware module and/or a software module.

As described herein, non-transitory computer-readable storage media are physical devices or storage medium that can be used to store electronic data in a non-transitory form (e.g., such that the data is stored permanently until it is intentionally deleted or modified.

### Example Artificial-Reality Systems 5A-5C-2

FIGS. 5A to 5C-2 illustrate example artificial-reality systems, in accordance with some embodiments. FIG. 5A shows a first artificial-reality system 500a and first example user interactions using a wrist-wearable device 600, a head-wearable device (e.g., artificial-reality device 700), and/or a handheld intermediary processing device (HIPD) 800. FIG. 5B shows a second artificial-reality system 500b and second example user interactions using a wrist-wearable device 600, artificial-reality device 700, and/or an HIPD 800. FIGS. 5C-1 and 5C-2 show a third artificial-reality system 500c and third example user interactions using a wrist-wearable device 600, a head-wearable device (e.g., the VR device 710), and/or an HIPD 800. As the skilled artisan will appreciate upon reading the descriptions provided herein, the above-example artificial-reality systems (described in detail below) can perform various functions and/or operations described above with reference to FIGS. 1A to 3H.

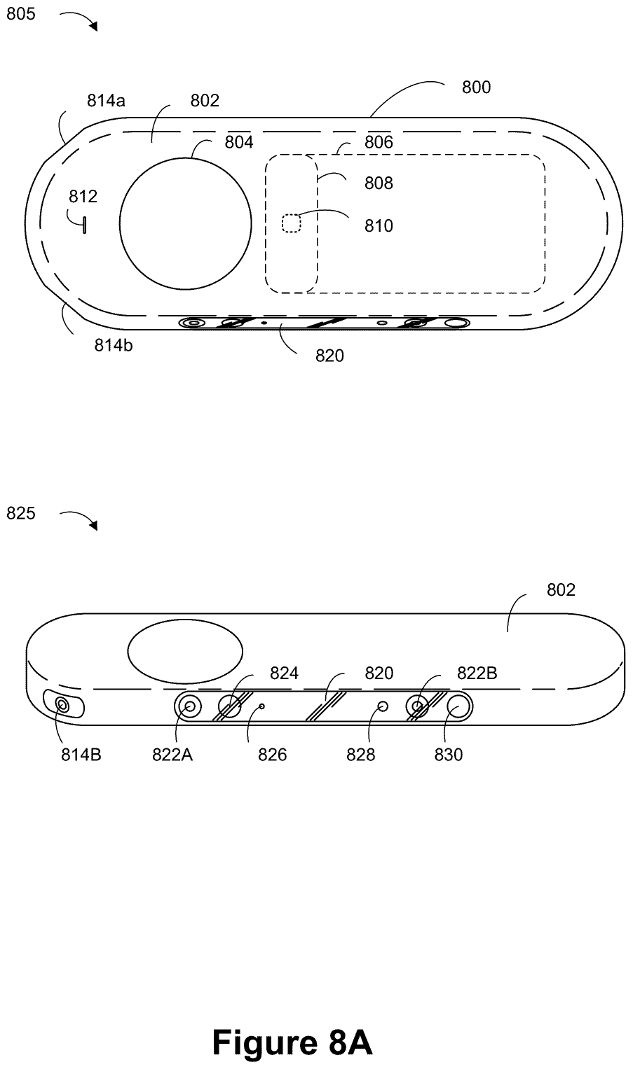

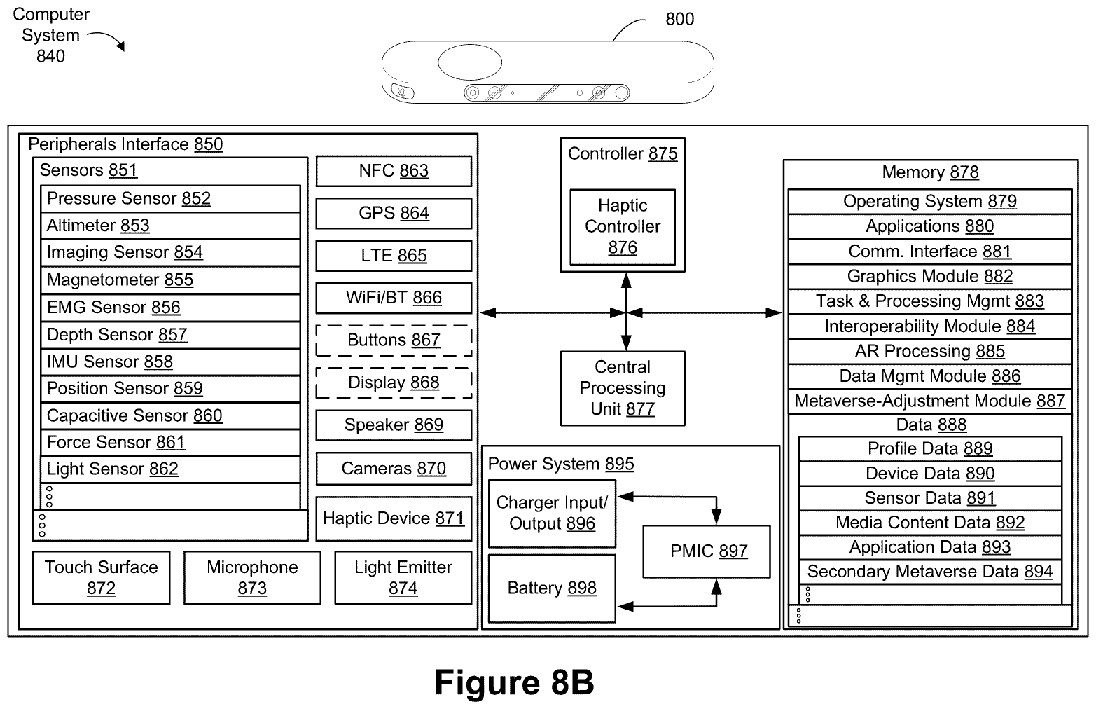

The wrist-wearable device 600 and one or more of its components are described below in reference to FIGS. 6A-6B; the head-wearable devices and their one or more components are described below in reference to FIGS. 7A-7D; and the HIPD 800 and its one or more components are described below in reference to FIGS. 8A-8B. The wrist-wearable device 600, the head-wearable devices, and/or the HIPD 800 can communicatively couple via a network 525 (e.g., cellular, near field, Wi-Fi, personal area network, wireless LAN, etc.). Additionally, the wrist-wearable device 600, the head-wearable devices, and/or the HIPD 800 can also communicatively couple with one or more servers 530, computers 540 (e.g., laptops, computers, etc.), mobile devices 550 (e.g., smartphones, tablets, etc.), and/or other electronic devices via the network 525 (e.g., cellular, near field, Wi-Fi, personal area network, wireless LAN, etc.).

Turning to FIG. 5A, a user 502 is shown wearing the wrist-wearable device 600 and the artificial-reality device 700, and having the HIPD 800 on their desk. The wrist-wearable device 600, the artificial-reality device 700, and the HIPD 800 facilitate user interaction with an artificial-reality environment. In particular, as shown by the first artificial-reality system 500a, the wrist-wearable device 600, the artificial-reality device 700, and/or the HIPD 800 cause presentation of one or more avatars 504, digital representations of contacts 506, and virtual objects 508. As discussed below, the user 502 can interact with the one or more avatars 504, digital representations of the contacts 506, and virtual objects 508 via the wrist-wearable device 600, the artificial-reality device 700, and/or the HIPD 800.

The user 502 can use any of the wrist-wearable device 600, the artificial-reality device 700, and/or the HIPD 800 to provide user inputs. For example, the user 502 can perform one or more hand gestures that are detected by the wrist-wearable device 600 (e.g., using one or more EMG sensors and/or IMUs, described below in reference to FIGS. 6A-6B) and/or artificial-reality device 700 (e.g. using one or more image sensor or camera, described below in reference to FIGS. 7A-7B) to provide a user input. Alternatively, or additionally, the user 502 can provide a user input via one or more touch surfaces of the wrist-wearable device 600, the artificial-reality device 700, and/or the HIPD 800, and/or voice commands captured by a microphone of the wrist-wearable device 600, the artificial-reality device 700, and/or the HIPD 800. In some embodiments, the wrist-wearable device 600, the artificial-reality device 700, and/or the HIPD 800 include a digital assistant to help the user in providing a user input (e.g., completing a sequence of operations, suggesting different operations or commands, providing reminders, confirming a command, etc.). In some embodiments, the user 502 can provide a user input via one or more facial gestures and/or facial expressions. For example, cameras of the wrist-wearable device 600, the artificial-reality device 700, and/or the HIPD 800 can track the eyes of the user 502 for navigating a user interface.

The wrist-wearable device 600, the artificial-reality device 700, and/or the HIPD 800 can operate alone or in conjunction to allow the user 502 to interact with the artificial-reality environment. In some embodiments, the HIPD 800 is configured to operate as a central hub or control center for the wrist-wearable device 600, the artificial-reality device 700, and/or another communicatively coupled device. For example, the user 502 can provide an input to interact with the artificial-reality environment at any of the wrist-wearable device 600, the artificial-reality device 700, and/or the HIPD 800, and the HIPD 800 can identify one or more back-end and front-end tasks to cause the performance of the requested interaction and distribute instructions to cause the performance of the one or more back-end and front-end tasks at the wrist-wearable device 600, the artificial-reality device 700, and/or the HIPD 800. In some embodiments, a back-end task is background processing task that is not perceptible by the user (e.g., rendering content, decompression, compression, etc.), and a front-end task is a user-facing task that is perceptible to the user (e.g., presenting information to the user, providing feedback to the user, etc.)). As described below in reference to FIGS. 8A-8B, the HIPD 800 can perform the back-end tasks and provide the wrist-wearable device 600 and/or the artificial-reality device 700 operational data corresponding to the performed back-end tasks such that the wrist-wearable device 600 and/or the artificial-reality device 700 can perform the front-end tasks. In this way, the HIPD 800, which has more computational resources and greater thermal headroom than the wrist-wearable device 600 and/or the artificial-reality device 700, performs computationally intensive tasks and reduces the computer resource utilization and/or power usage of the wrist-wearable device 600 and/or the artificial-reality device 700.

In the example shown by the first artificial-reality system 500a, the HIPD 800 identifies one or more back-end tasks and front-end tasks associated with a user request to initiate an artificial-reality video call with one or more other users (represented by the avatar 504 and the digital representation of the contact 506) and distributes instructions to cause the performance of the one or more back-end tasks and front-end tasks. In particular, the HIPD 800 performs back-end tasks for processing and/or rendering image data (and other data) associated with the artificial-reality video call and provides operational data associated with the performed back-end tasks to the artificial-reality device 700 such that the artificial-reality device 700 perform front-end tasks for presenting the artificial-reality video call (e.g., presenting the avatar 504 and the digital representation of the contact 506).

In some embodiments, the HIPD 800 can operate as a focal or anchor point for causing the presentation of information. This allows the user 502 to be generally aware of where information is presented. For example, as shown in the first artificial-reality system 500a, the avatar 504 and the digital representation of the contact 506 are presented above the HIPD 800. In particular, the HIPD 800 and the artificial-reality device 700 operate in conjunction to determine a location for presenting the avatar 504 and the digital representation of the contact 506. In some embodiments, information can be presented a predetermined distance from the HIPD 800 (e.g., within 5 meters). For example, as shown in the first artificial-reality system 500a, virtual object 508 is presented on the desk some distance from the HIPD 800. Similar to the above example, the HIPD 800 and the artificial-reality device 700 can operate in conjunction to determine a location for presenting the virtual object 508. Alternatively, in some embodiments, presentation of information is not bound by the HIPD 800. More specifically, the avatar 504, the digital representation of the contact 506, and the virtual object 508 do not have to be presented within a predetermined distance of the HIPD 800.

User inputs provided at the wrist-wearable device 600, the artificial-reality device 700, and/or the HIPD 800 are coordinated such that the user can use any device to initiate, continue, and/or complete an operation. For example, the user 502 can provide a user input to the artificial-reality device 700 to cause the artificial-reality device 700 to present the virtual object 508 and, while the virtual object 508 is presented by the artificial-reality device 700, the user 502 can provide one or more hand gestures via the wrist-wearable device 600 to interact and/or manipulate the virtual object 508.

FIG. 5B shows the user 502 wearing the wrist-wearable device 600 and the artificial-reality device 700, and holding the HIPD 800. In the second artificial-reality system 500b, the wrist-wearable device 600, the artificial-reality device 700, and/or the HIPD 800 are used to receive and/or provide one or more messages to a contact of the user 502. In particular, the wrist-wearable device 600, the artificial-reality device 700, and/or the HIPD 800 detect and coordinate one or more user inputs to initiate a messaging application and prepare a response to a received message via the messaging application.

In some embodiments, the user 502 initiates, via a user input, an application on the wrist-wearable device 600, the artificial-reality device 700, and/or the HIPD 800 that causes the application to initiate on at least one device. For example, in the second artificial-reality system 500b the user 502 performs a hand gesture associated with a command for initiating a messaging application (represented by messaging user interface 512); the wrist-wearable device 600 detects the hand gesture; and, based on a determination that the user 502 is wearing artificial-reality device 700, causes the artificial-reality device 700 to present a messaging user interface 512 of the messaging application. The artificial-reality device 700 can present the messaging user interface 512 to the user 502 via its display (e.g., as shown by the field of view 510 of the user 502). In some embodiments, the application is initiated and ran on the device (e.g., the wrist-wearable device 600, the artificial-reality device 700, and/or the HIPD 800) that detects the user input to initiate the application, and the device provides another device operational data to cause the presentation of the messaging application. For example, the wrist-wearable device 600 can detect the user input to initiate a messaging application; initiate and run the messaging application; and provide operational data to the artificial-reality device 700 and/or the HIPD 800 to cause presentation of the messaging application. Alternatively, the application can be initiated and ran at a device other than the device that detected the user input. For example, the wrist-wearable device 600 can detect the hand gesture associated with initiating the messaging application and cause the HIPD 800 to run the messaging application and coordinate the presentation of the messaging application.

Further, the user 502 can provide a user input provided at the wrist-wearable device 600, the artificial-reality device 700, and/or the HIPD 800 to continue and/or complete an operation initiated are at another device. For example, after initiating the messaging application via the wrist-wearable device 600 and while the artificial-reality device 700 present the messaging user interface 512, the user 502 can provide an input at the HIPD 800 to prepare a response (e.g., shown by the swipe gesture performed on the HIPD 800). The gestures performed by the user 502 directed to the HIPD 800 can be provided and/or displayed on another device. For example, the user 502 performing the swipe gesture directed to the HIPD 800 are displayed on a virtual keyboard of the messaging user interface 512 displayed by the artificial-reality device 700.

In some embodiments, the wrist-wearable device 600, the artificial-reality device 700, the HIPD 800, and/or other communicatively couple device can present one or more notifications to the user 502. The notification can be an indication of a new message, an incoming call, an application update, a status update, etc. The user 502 can select the notification via the wrist-wearable device 600, the artificial-reality device 700, the HIPD 800, and cause presentation of an application or operation associated with the notification on at least one device. For example, the user 502 can receive a notification that a message was received at the wrist-wearable device 600, the artificial-reality device 700, the HIPD 800, and/or other communicatively couple device and provide a user input at the wrist-wearable device 600, the artificial-reality device 700, and/or the HIPD 800 to review the notification, and the device detecting the user input can cause an application associated with the notification to be initiated and/or presented at the wrist-wearable device 600, the artificial-reality device 700, and/or the HIPD 800.

While the above example describes coordinated inputs used to interact with a messaging application, the skilled artisan will appreciate upon reading the descriptions that user inputs can be coordinated to interact with any number of applications including, but not limited to, gaming applications, social media applications, camera applications, web-based applications, financial applications, etc. For example, the artificial-reality device 700 can present to the user 502 game application data and the HIPD 800 can use a controller to provide inputs to the game. Similarly, the user 502 can use the wrist-wearable device 600 to initiate a camera of the artificial-reality device 700, and the user can use the wrist-wearable device 600, the artificial-reality device 700, and/or the HIPD 800 to manipulate the image capture (e.g., zoom in or out, apply filters, etc.) and capture image data.

Turning to FIGS. 5C-1 and 5C-2, the user 502 is shown wearing the wrist-wearable device 600 and a VR device 710, and holding the HIPD 800. In the third artificial-reality system 500c, the wrist-wearable device 600, the VR device 710, and/or the HIPD 800 are used to interact within an artificial-reality environment, such as a VR game or other artificial-reality application. While the VR device 710 present a representation of a VR game (e.g., first artificial-reality game environment 520) to the user 502, the wrist-wearable device 600, the VR device 710, and/or the HIPD 800 detect and coordinate one or more user inputs to allow the user 502 to interact with the VR game.

In some embodiments, the user 502 can provide a user input via the wrist-wearable device 600, the VR device 710, and/or the HIPD 800 that causes an action in a corresponding artificial-reality environment. For example, the user 502 in the third artificial-reality system 500c (shown in FIG. 5C-1) raises the HIPD 800 to prepare for a swing in the first artificial-reality game environment 520. The VR device 710, responsive to the user 502 raising the HIPD 800, causes the artificial-reality representation of the user 522 to perform a similar action (e.g., raise a virtual object, such as a virtual sword 524). In some embodiments, each device uses respective sensor data and/or image data to detect the user input and provide an accurate representation of the motion of the user 502. For example, imaging sensors 854 (e.g., SLAM cameras or other cameras discussed below in FIGS. 8A and 8B) of the HIPD 800 can be used to detect a position of the 800 relative to the body of the user 502 such that the virtual object can be positioned appropriately within the first artificial-reality game environment 520; sensor data from the wrist-wearable device 600 can be used to detect a velocity at which the user 502 raises the HIPD 800 such that the artificial-reality representation of the user 522 and the virtual sword 524 are synchronized with the movements of the user 502; and image sensors 726 (FIGS. 7A-7C) of the VR device 710 can be used to represent the body of the user 502, boundary conditions, or real-world objects within the first artificial-reality game environment 520.

In FIG. 5C-2, the user 502 performs a downward swing while holding the HIPD 800. The downward swing motion performed by the user 502 is detected by the wrist-wearable device 600, the VR device 710, and/or the HIPD 800 and a corresponding action is performed in the first artificial-reality game environment 520. In some embodiments, the data captured by each device is used to improve the user's experience within the artificial-reality environment. For example, sensor data of the wrist-wearable device 600 can be used to determine a speed and/or force at which the downward swing is performed and image sensors of the HIPD 800 and/or the VR device 710 can be used to determine a location of the swing and how it should be represented in the first artificial-reality game environment 520, which, in turn, can be used as inputs for the artificial-reality environment (e.g., game mechanics, which can use detected speed, force, locations, and/or aspects of actions of the user 502 to classify the inputs (e.g., user performs a light strike, hard strike, critical strike, glancing strike, miss, etc.) or calculate an output (e.g., amount of damage)).

While the wrist-wearable device 600, the VR device 710, and/or the HIPD 800 are described as detecting user inputs, in some embodiments, user inputs are detected at a single device (with the single device being responsible for distributing signals to the other devices for performing the user input). For example, the HIPD 800 can operate an application for generating the first artificial-reality game environment 520 and provide the VR device 710 with corresponding data for causing the presentation of the first artificial-reality game environment 520, as well as detect movements of the user 502 (while holding the HIPD 800) to cause the performance of corresponding actions within the first artificial-reality game environment 520. Additionally, or alternatively, in some embodiments, operational data (e.g., sensor data, image data, application data, device data, and/or other data) of one or more devices is provide to a single device (e.g., the HIPD 800) to process the operational data and cause respective devices to perform an action associated with processed operational data.

Having discussed example artificial-reality systems, devices for interacting with such artificial-reality systems, and other computing systems more generally, will now be discussed in greater detail below. Some definitions of devices and components that can be included in some or all of the example devices discussed below are defined here for ease of reference. A skilled artisan will appreciate that certain types of the components described below may be more suitable for a particular set of devices, and less suitable for a different set of devices. But subsequent reference to the components defined here should be considered to be encompassed by the definitions provided.

In some embodiments discussed below example devices and systems, including electronic devices and systems, will be discussed. Such example devices and systems are not intended to be limiting, and one of skill in the art will understand that alternative devices and systems to the example devices and systems described herein may be used to perform the operations and construct the systems and device that are described herein.

As described herein, an electronic device is a device that uses electrical energy to perform a specific function. It can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device is a device that sits between two other electronic devices, and/or a subset of components of one or more electronic devices and facilitates communication, and/or data processing and/or data transfer between the respective electronic devices and/or electronic components.

### Example Wrist-Wearable Devices

FIGS. 6A and 6B illustrate an example wrist-wearable device 600, in accordance with some embodiments. The wrist-wearable device 600 is an instance of the wearable device described in reference to FIGS. 1A to 3H herein, such that the wrist-wearable devices should be understood to have the features of the wrist-wearable device 600 and vice versa. FIG. 6A illustrates components of the wrist-wearable device 600, which can be used individually or in combination, including combinations that include other electronic devices and/or electronic components.

FIG. 6A shows a wearable band 610 and a watch body 620 (or capsule) being coupled, as discussed below, to form the wrist-wearable device 600. The wrist-wearable device 600 can perform various functions and/or operations associated with navigating through user interfaces and selectively opening applications, as well as the functions and/or operations described above with reference to FIGS. 1A to 4.

As will be described in more detail below, operations executed by the wrist-wearable device 600 can include: (i) presenting content to a user (e.g., displaying visual content via a display 605); (ii) detecting (e.g., sensing) user input (e.g., sensing a touch on peripheral button 623 and/or at a touch screen of the display 605, a hand gesture detected by sensors (e.g., biopotential sensors)); (iii) sensing biometric data via one or more sensors 613 (e.g., neuromuscular signals, heart rate, temperature, sleep, etc.); messaging (e.g., text, speech, video, etc.); image capture via one or more imaging devices or cameras 625; wireless communications (e.g., cellular, near field, Wi-Fi, personal area network, etc.); location determination; financial transactions; providing haptic feedback; alarms; notifications; biometric authentication; health monitoring; sleep monitoring; etc.

The above-example functions can be executed independently in the watch body 620, independently in the wearable band 610, and/or via an electronic communication between the watch body 620 and the wearable band 610. In some embodiments, functions can be executed on the wrist-wearable device 600 while an artificial-reality environment is being presented (e.g., via one of the artificial-reality systems 500a to 500d). As the skilled artisan will appreciate upon reading the descriptions provided herein, the novel wearable devices described herein can be used with other types of artificial-reality environments.

The wearable band 610 can be configured to be worn by a user such that an inner (or inside) surface of the wearable structure 611 of the wearable band 610 is in contact with the user's skin. When worn by a user, sensors 613 contact the user's skin. The sensors 613 can sense biometric data such as a user's heart rate, saturated oxygen level, temperature, sweat level, neuromuscular signal sensors, or a combination thereof. The sensors 613 can also sense data about a user's environment including a user's motion, altitude, location, orientation, gait, acceleration, position, or a combination thereof. In some embodiment, the sensors 613 are configured to track a position and/or motion of the wearable band 610. The one or more sensors 613 can include any of the sensors defined above and/or discussed below with respect to FIG. 6B.

The one or more sensors 613 can be distributed on an inside and/or an outside surface of the wearable band 610. In some embodiments, the one or more sensors 613 are uniformly spaced along the wearable band 610. Alternatively, in some embodiments, the one or more sensors 613 are positioned at distinct points along the wearable band 610. As shown in FIG. 6A, the one or more sensors 613 can be the same or distinct. For example, in some embodiments, the one or more sensors 613 can be shaped as a pill (e.g., sensor 613a), an oval, a circle a square, an oblong (e.g., sensor 613c) and/or any other shape that maintains contact with the user's skin (e.g., such that neuromuscular signal and/or other biometric data can be accurately measured at the user's skin). In some embodiments, the one or more sensors 613 are aligned to form pairs of sensors (e.g., for sensing neuromuscular signals based on differential sensing within each respective sensor). For example, sensor 613b is aligned with an adjacent sensor to form sensor pair 614a and sensor 613d aligned with an adjacent sensor to form sensor pair 614b. In some embodiments, the wearable band 610 does not have a sensor pair. Alternatively, in some embodiments, the wearable band 610 has a predetermined number of sensor pairs (one pair of sensors, three pairs of sensors, four pairs of sensors, six pairs of sensors, sixteen pairs of sensors, etc.).

The wearable band 610 can include any suitable number of sensors 613. In some embodiments, the number and arrangement of sensors 613 depends on the particular application for which the wearable band 610 is used. For instance, a wearable band 610 configured as an armband, wristband, or chest-band may include a plurality of sensors 613 with different number of sensors 613 and different arrangement for each use case, such as medical use cases as compared to gaming or general day-to-day use cases.

In accordance with some embodiments, the wearable band 610 further includes an electrical ground electrode and a shielding electrode. The electrical ground and shielding electrodes, like the sensors 613, can be distributed on the inside surface of the wearable band 610 such that they contact a portion of the user's skin. For example, the electrical ground and shielding electrodes can be at an inside surface of coupling mechanism 616 or an inside surface of a wearable structure 611. The electrical ground and shielding electrodes can be formed and/or use the same components as the sensors 613. In some embodiments, the wearable band 610 includes more than one electrical ground electrode and more than one shielding electrode.

The sensors 613 can be formed as part of the wearable structure 611 of the wearable band 610. In some embodiments, the sensors 613 are flush or substantially flush with the wearable structure 611 such that they do not extend beyond the surface of the wearable structure 611. While flush with the wearable structure 611, the sensors 613 are still configured to contact the user's skin (e.g., via a skin-contacting surface). Alternatively, in some embodiments, the sensors 613 extend beyond the wearable structure 611 a predetermined distance (e.g., 0.1-2 mm) to make contact and depress into the user's skin. In some embodiment, the sensors 613 are coupled to an actuator (not shown) configured to adjust an extension height (e.g., a distance from the surface of the wearable structure 611) of the sensors 613 such that the sensors 613 make contact and depress into the user's skin. In some embodiments, the actuators adjust the extension height between 0.01 mm-1.2 mm. This allows the user to customize the positioning of the sensors 613 to improve the overall comfort of the wearable band 610 when worn while still allowing the sensors 613 to contact the user's skin. In some embodiments, the sensors 613 are indistinguishable from the wearable structure 611 when worn by the user.

The wearable structure 611 can be formed of an elastic material, elastomers, etc. configured to be stretched and fitted to be worn by the user. In some embodiments, the wearable structure 611 is a textile or woven fabric. As described above, the sensors 613 can be formed as part of a wearable structure 611. For example, the sensors 613 can be molded into the wearable structure 611 or be integrated into a woven fabric (e.g., the sensors 613 can be sewn into the fabric and mimic the pliability of fabric (e.g., the sensors 613 can be constructed from a series woven strands of fabric)).

The wearable structure 611 can include flexible electronic connectors that interconnect the sensors 613, the electronic circuitry, and/or other electronic components (described below in reference to FIG. 6B) that are enclosed in the wearable band 610. In some embodiments, the flexible electronic connectors are configured to interconnect the sensors 613, the electronic circuitry, and/or other electronic components of the wearable band 610 with respective sensors and/or other electronic components of another electronic device (e.g., watch body 620). The flexible electronic connectors are configured to move with the wearable structure 611 such that the user adjustment to the wearable structure 611 (e.g., resizing, pulling, folding, etc.) does not stress or strain the electrical coupling of components of the wearable band 610.

As described above, the wearable band 610 is configured to be worn by a user. In particular, the wearable band 610 can be shaped or otherwise manipulated to be worn by a user. For example, the wearable band 610 can be shaped to have a substantially circular shape such that it can be configured to be worn on the user's lower arm or wrist. Alternatively, the wearable band 610 can be shaped to be worn on another body part of the user, such as the user's upper arm (e.g., around a bicep), forearm, chest, legs, etc. The wearable band 610 can include a retaining mechanism 612 (e.g., a buckle, a hook and loop fastener, etc.) for securing the wearable band 610 to the user's wrist or other body part. While the wearable band 610 is worn by the user, the sensors 613 sense data (referred to as sensor data) from the user's skin. In particular, the sensors 613 of the wearable band 610 obtain (e.g., sense and record) neuromuscular signals.

The sensed data (e.g., sensed neuromuscular signals) can be used to detect and/or determine the user's intention to perform certain motor actions. In particular, the sensors 613 sense and record neuromuscular signals from the user as the user performs muscular activations (e.g., movements, gestures, etc.). The detected and/or determined motor actions (e.g., phalange (or digits) movements, wrist movements, hand movements, and/or other muscle intentions) can be used to determine control commands or control information (instructions to perform certain commands after the data is sensed) for causing a computing device to perform one or more input commands. For example, the sensed neuromuscular signals can be used to control certain user interfaces displayed on the display 605 of the wrist-wearable device 600 and/or can be transmitted to a device responsible for rendering an artificial-reality environment (e.g., a head-mounted display) to perform an action in an associated artificial-reality environment, such as to control the motion of a virtual device displayed to the user. The muscular activations performed by the user can include static gestures, such as placing the user's hand palm down on a table; dynamic gestures, such as grasping a physical or virtual object; and covert gestures that are imperceptible to another person, such as slightly tensing a joint by co-contracting opposing muscles or using sub-muscular activations. The muscular activations performed by the user can include symbolic gestures (e.g., gestures mapped to other gestures, interactions, or commands, for example, based on a gesture vocabulary that specifies the mapping of gestures to commands).

The sensor data sensed by the sensors 613 can be used to provide a user with an enhanced interaction with a physical object (e.g., devices communicatively coupled with the wearable band 610) and/or a virtual object in an artificial-reality application generated by an artificial-reality system (e.g., user interface objects presented on the display 605, or another computing device (e.g., a smartphone)).

In some embodiments, the wearable band 610 includes one or more haptic devices 646 (FIG. 6B; e.g., a vibratory haptic actuator) that are configured to provide haptic feedback (e.g., a cutaneous and/or kinesthetic sensation, etc.) to the user's skin. The sensors 613, and/or the haptic devices 646 can be configured to operate in conjunction with multiple applications including, without limitation, health monitoring, social media, games, and artificial reality (e.g., the applications associated with artificial reality).

The wearable band 610 can also include coupling mechanism 616 (e.g., a cradle or a shape of the coupling mechanism can correspond to shape of the watch body 620 of the wrist-wearable device 600) for detachably coupling a capsule (e.g., a computing unit) or watch body 620 (via a coupling surface of the watch body 620) to the wearable band 610. In particular, the coupling mechanism 616 can be configured to receive a coupling surface proximate to the bottom side of the watch body 620 (e.g., a side opposite to a front side of the watch body 620 where the display 605 is located), such that a user can push the watch body 620 downward into the coupling mechanism 616 to attach the watch body 620 to the coupling mechanism 616. In some embodiments, the coupling mechanism 616 can be configured to receive a top side of the watch body 620 (e.g., a side proximate to the front side of the watch body 620 where the display 605 is located) that is pushed upward into the cradle, as opposed to being pushed downward into the coupling mechanism 616. In some embodiments, the coupling mechanism 616 is an integrated component of the wearable band 610 such that the wearable band 610 and the coupling mechanism 616 are a single unitary structure. In some embodiments, the coupling mechanism 616 is a type of frame or shell that allows the watch body 620 coupling surface to be retained within or on the wearable band 610 coupling mechanism 616 (e.g., a cradle, a tracker band, a support base, a clasp, etc.).

The coupling mechanism 616 can allow for the watch body 620 to be detachably coupled to the wearable band 610 through a friction fit, magnetic coupling, a rotation-based connector, a shear-pin coupler, a retention spring, one or more magnets, a clip, a pin shaft, a hook and loop fastener, or a combination thereof. A user can perform any type of motion to couple the watch body 620 to the wearable band 610 and to decouple the watch body 620 from the wearable band 610. For example, a user can twist, slide, turn, push, pull, or rotate the watch body 620 relative to the wearable band 610, or a combination thereof, to attach the watch body 620 to the wearable band 610 and to detach the watch body 620 from the wearable band 610. Alternatively, as discussed below, in some embodiments, the watch body 620 can be decoupled from the wearable band 610 by actuation of the release mechanism 629.

The wearable band 610 can be coupled with a watch body 620 to increase the functionality of the wearable band 610 (e.g., converting the wearable band 610 into a wrist-wearable device 600, adding an additional computing unit and/or battery to increase computational resources and/or a battery life of the wearable band 610, adding additional sensors to improve sensed data, etc.). As described above, the wearable band 610 (and the coupling mechanism 616) is configured to operate independently (e.g., execute functions independently) from watch body 620. For example, the coupling mechanism 616 can include one or more sensors 613 that contact a user's skin when the wearable band 610 is worn by the user and provide sensor data for determining control commands.

A user can detach the watch body 620 (or capsule) from the wearable band 610 in order to reduce the encumbrance of the wrist-wearable device 600 to the user. For embodiments in which the watch body 620 is removable, the watch body 620 can be referred to as a removable structure, such that in these embodiments the wrist-wearable device 600 includes a wearable portion (e.g., the wearable band 610) and a removable structure (the watch body 620).

Turning to the watch body 620, the watch body 620 can have a substantially rectangular or circular shape. The watch body 620 is configured to be worn by the user on their wrist or on another body part. More specifically, the watch body 620 is sized to be easily carried by the user, attached on a portion of the user's clothing, and/or coupled to the wearable band 610 (forming the wrist-wearable device 600). As described above, the watch body 620 can have a shape corresponding to the coupling mechanism 616 of the wearable band 610. In some embodiments, the watch body 620 includes a single release mechanism 629 or multiple release mechanisms (e.g., two release mechanisms 629 positioned on opposing sides of the watch body 620, such as spring-loaded buttons) for decoupling the watch body 620 and the wearable band 610. The release mechanism 629 can include, without limitation, a button, a knob, a plunger, a handle, a lever, a fastener, a clasp, a dial, a latch, or a combination thereof.

A user can actuate the release mechanism 629 by pushing, turning, lifting, depressing, shifting, or performing other actions on the release mechanism 629. Actuation of the release mechanism 629 can release (e.g., decouple) the watch body 620 from the coupling mechanism 616 of the wearable band 610, allowing the user to use the watch body 620 independently from wearable band 610, and vice versa. For example, decoupling the watch body 620 from the wearable band 610 can allow the user to capture images using rear-facing camera 625B. Although the is shown positioned at a corner of watch body 620, the release mechanism 629 can be positioned anywhere on watch body 620 that is convenient for the user to actuate. In addition, in some embodiments, the wearable band 610 can also include a respective release mechanism for decoupling the watch body 620 from the coupling mechanism 616. In some embodiments, the release mechanism 629 is optional and the watch body 620 can be decoupled from the coupling mechanism 616 as described above (e.g., via twisting, rotating, etc.).

The watch body 620 can include one or more peripheral buttons 623 and 627 for performing various operations at the watch body 620. For example, the peripheral buttons 623 and 627 can be used to turn on or wake (e.g., transition from a sleep state to an active state) the display 605, unlock the watch body 620, increase or decrease a volume, increase, or decrease a brightness, interact with one or more applications, interact with one or more user interfaces, etc. Additionally, or alternatively, in some embodiments, the display 605 operates as a touch screen and allows the user to provide one or more inputs for interacting with the watch body 620.

In some embodiments, the watch body 620 includes one or more sensors 621. The sensors 621 of the watch body 620 can be the same or distinct from the sensors 613 of the wearable band 610. The sensors 621 of the watch body 620 can be distributed on an inside and/or an outside surface of the watch body 620. In some embodiments, the sensors 621 are configured to contact a user's skin when the watch body 620 is worn by the user. For example, the sensors 621 can be placed on the bottom side of the watch body 620 and the coupling mechanism 616 can be a cradle with an opening that allows the bottom side of the watch body 620 to directly contact the user's skin. Alternatively, in some embodiments, the watch body 620 does not include sensors that are configured to contact the user's skin (e.g., including sensors internal and/or external to the watch body 620 that configured to sense data of the watch body 620 and the surrounding environment of the watch body 620). In some embodiment, the sensors 613 are configured to track a position and/or motion of the watch body 620.

The watch body 620 and the wearable band 610 can share data using a wired communication method (e.g., a Universal Asynchronous Receiver/Transmitter (UART), a USB transceiver, etc.) and/or a wireless communication method (e.g., near field communication, Bluetooth, etc.). For example, the watch body 620 and the wearable band 610 can share data sensed by the sensors 613 and 621, as well as application and device specific information (e.g., active and/or available applications, output devices (e.g., display, speakers, etc.), input devices (e.g., touch screen, microphone, imaging sensors, etc.).

In some embodiments, the watch body 620 can include, without limitation, a front-facing camera 625A and/or a rear-facing camera 625B, sensors 621 (e.g., a biometric sensor, an IMU, a heart rate sensor, a saturated oxygen sensor, a neuromuscular signal sensor, an altimeter sensor, a temperature sensor, a bioimpedance sensor, a pedometer sensor, an optical sensor (e.g., imaging sensor 663; FIG. 6B), a touch sensor, a sweat sensor, etc.). In some embodiments, the watch body 620 can include one or more haptic devices 676 (FIG. 6B; a vibratory haptic actuator) that is configured to provide haptic feedback (e.g., a cutaneous and/or kinesthetic sensation, etc.) to the user. The sensors 621 and/or the haptic device 676 can also be configured to operate in conjunction with multiple applications including, without limitation, health monitoring applications, social media applications, game applications, and artificial reality applications (e.g., the applications associated with artificial reality).

As described above, the watch body 620 and the wearable band 610, when coupled, can form the wrist-wearable device 600. When coupled, the watch body 620 and wearable band 610 operate as a single device to execute functions (operations, detections, communications, etc.) described herein. In some embodiments, each device is provided with particular instructions for performing the one or more operations of the wrist-wearable device 600. For example, in accordance with a determination that the watch body 620 does not include neuromuscular signal sensors, the wearable band 610 can include alternative instructions for performing associated instructions (e.g., providing sensed neuromuscular signal data to the watch body 620 via a different electronic device). Operations of the wrist-wearable device 600 can be performed by the watch body 620 alone or in conjunction with the wearable band 610 (e.g., via respective processors and/or hardware components) and vice versa. In some embodiments, operations of the wrist-wearable device 600, the watch body 620, and/or the wearable band 610 can be performed in conjunction with one or more processors and/or hardware components of another communicatively coupled device (e.g., the HIPD 800; FIGS. 8A-8B).

As described below with reference to the block diagram of FIG. 6B, the wearable band 610 and/or the watch body 620 can each include independent resources required to independently execute functions. For example, the wearable band 610 and/or the watch body 620 can each include a power source (e.g., a battery), a memory, data storage, a processor (e.g., a central processing unit (CPU)), communications, a light source, and/or input/output devices.

FIG. 6B shows block diagrams of a computing system 630 corresponding to the wearable band 610, and a computing system 660 corresponding to the watch body 620, according to some embodiments. A computing system of the wrist-wearable device 600 includes a combination of components of the wearable band computing system 630 and the watch body computing system 660, in accordance with some embodiments.

The watch body 620 and/or the wearable band 610 can include one or more components shown in watch body computing system 660. In some embodiments, a single integrated circuit includes all or a substantial portion of the components of the watch body computing system 660 are included in a single integrated circuit. Alternatively, in some embodiments, components of the watch body computing system 660 are included in a plurality of integrated circuits that are communicatively coupled. In some embodiments, the watch body computing system 660 is configured to couple (e.g., via a wired or wireless connection) with the wearable band computing system 630, which allows the computing systems to share components, distribute tasks, and/or perform other operations described herein (individually or as a single device).

The watch body computing system 660 can include one or more processors 679, a controller 677, a peripherals interface 661, a power system 695, and memory (e.g., a memory 680), each of which are defined above and described in more detail below.

The power system 695 can include a charger input 696, a power-management integrated circuit (PMIC) 697, and a battery 698, each are which are defined above. In some embodiments, a watch body 620 and a wearable band 610 can have respective charger inputs (e.g., charger input 696 and 657), respective batteries (e.g., battery 698 and 659), and can share power with each other (e.g., the watch body 620 can power and/or charge the wearable band 610, and vice versa). Although watch body 620 and/or the wearable band 610 can include respective charger inputs, a single charger input can charge both devices when coupled. The watch body 620 and the wearable band 610 can receive a charge using a variety of techniques. In some embodiments, the watch body 620 and the wearable band 610 can use a wired charging assembly (e.g., power cords) to receive the charge. Alternatively, or in addition, the watch body 620 and/or the wearable band 610 can be configured for wireless charging. For example, a portable charging device can be designed to mate with a portion of watch body 620 and/or wearable band 610 and wirelessly deliver usable power to a battery of watch body 620 and/or wearable band 610. The watch body 620 and the wearable band 610 can have independent power systems (e.g., power system 695 and 656) to enable each to operate independently. The watch body 620 and wearable band 610 can also share power (e.g., one can charge the other) via respective PMICs (e.g., PMICs 697 and 658) that can share power over power and ground conductors and/or over wireless charging antennas.

In some embodiments, the peripherals interface 661 can include one or more sensors 621, many of which listed below are defined above. The sensors 621 can include one or more coupling sensor 662 for detecting when the watch body 620 is coupled with another electronic device (e.g., a wearable band 610). The sensors 621 can include imaging sensors 663 (one or more of the cameras 625, and/or separate imaging sensors 663 (e.g., thermal-imaging sensors)). In some embodiments, the sensors 621 include one or more SpO2 sensors 664. In some embodiments, the sensors 621 include one or more biopotential-signal sensors (e.g., EMG sensors 665, which may be disposed on a user-facing portion of the watch body 620 and/or the wearable band 610). In some embodiments, the sensors 621 include one or more capacitive sensors 666. In some embodiments, the sensors 621 include one or more heart rate sensors 667. In some embodiments, the sensors 621 include one or more IMU sensors 668. In some embodiments, one or more IMU sensors 668 can be configured to detect movement of a user's hand or other location that the watch body 620 is placed or held).

In some embodiments, the peripherals interface 661 includes a near-field communication (NFC) component 669, a global-position system (GPS) component 670, a long-term evolution (LTE) component 671, and/or a Wi-Fi and/or Bluetooth communication component 672. In some embodiments, the peripherals interface 661 includes one or more buttons 673 (e.g., the peripheral buttons 623 and 627 in FIG. 6A), which, when selected by a user, cause operation to be performed at the watch body 620. In some embodiments, the peripherals interface 661 includes one or more indicators, such as a light emitting diode (LED), to provide a user with visual indicators (e.g., message received, low battery, active microphone and/or camera, etc.).

The watch body 620 can include at least one display 605, for displaying visual representations of information or data to the user, including user-interface elements and/or three-dimensional virtual objects. The display can also include a touch screen for inputting user inputs, such as touch gestures, swipe gestures, and the like. The watch body 620 can include at least one speaker 674 and at least one microphone 675 for providing audio signals to the user and receiving audio input from the user. The user can provide user inputs through the microphone 675 and can also receive audio output from the speaker 674 as part of a haptic event provided by the haptic controller 678. The watch body 620 can include at least one camera 625, including a front-facing camera 625A and a rear-facing camera 625B. The cameras 625 can include ultra-wide-angle cameras, wide angle cameras, fish-eye cameras, spherical cameras, telephoto cameras, a depth-sensing cameras, or other types of cameras.

The watch body computing system 660 can include one or more haptic controllers 678 and associated componentry (e.g., haptic devices 676) for providing haptic events at the watch body 620 (e.g., a vibrating sensation or audio output in response to an event at the watch body 620). The haptic controllers 678 can communicate with one or more haptic devices 676, such as electroacoustic devices, including a speaker of the one or more speakers 674 and/or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). The haptic controller 678 can provide haptic events to that are capable of being sensed by a user of the watch body 620. In some embodiments, the one or more haptic controllers 678 can receive input signals from an application of the applications 682.

In some embodiments, the computer system 630 and/or the computer system 660 can include memory 680, which can be controlled by a memory controller of the one or more controllers 677 and/or one or more processors 679. In some embodiments, software components stored in the memory 680 include one or more applications 682 configured to perform operations at the watch body 620. In some embodiments, the one or more applications 682 include games, word processors, messaging applications, calling applications, web browsers, social media applications, media streaming applications, financial applications, calendars, clocks, etc. In some embodiments, software components stored in the memory 680 include one or more communication interface modules 683 as defined above. In some embodiments, software components stored in the memory 680 include one or more graphics modules 684 for rendering, encoding, and/or decoding audio and/or visual data; and one or more data management modules 685 for collecting, organizing, and/or providing access to the data 687 stored in memory 680. In some embodiments, one or more of applications 682 and/or one or more modules can work in conjunction with one another to perform various tasks at the watch body 620.

In some embodiments, software components stored in the memory 680 can include one or more operating systems 681 (e.g., a Linux-based operating system, an Android operating system, etc.). The memory 680 can also include data 687. The data 687 can include profile data 688A, sensor data 689A, media content data 690, and application data 691.

It should be appreciated that the watch body computing system 660 is an example of a computing system within the watch body 620, and that the watch body 620 can have more or fewer components than shown in the watch body computing system 660, combine two or more components, and/or have a different configuration and/or arrangement of the components. The various components shown in watch body computing system 660 are implemented in hardware, software, firmware, or a combination thereof, including one or more signal processing and/or application-specific integrated circuits.

Turning to the wearable band computing system 630, one or more components that can be included in the wearable band 610 are shown. The wearable band computing system 630 can include more or fewer components than shown in the watch body computing system 660, combine two or more components, and/or have a different configuration and/or arrangement of some or all of the components. In some embodiments, all, or a substantial portion of the components of the wearable band computing system 630 are included in a single integrated circuit. Alternatively, in some embodiments, components of the wearable band computing system 630 are included in a plurality of integrated circuits that are communicatively coupled. As described above, in some embodiments, the wearable band computing system 630 is configured to couple (e.g., via a wired or wireless connection) with the watch body computing system 660, which allows the computing systems to share components, distribute tasks, and/or perform other operations described herein (individually or as a single device).

The wearable band computing system 630, similar to the watch body computing system 660, can include one or more processors 649, one or more controllers 647 (including one or more haptics controller 648), a peripherals interface 631 that can includes one or more sensors 613 and other peripheral devices, power source (e.g., a power system 656), and memory (e.g., a memory 650) that includes an operating system (e.g., an operating system 651), data (e.g., data 654 including profile data 688B, sensor data 689B, etc.), and one or more modules (e.g., a communications interface module 652, a data management module 653, etc.).

The one or more sensors 613 can be analogous to sensors 621 of the computer system 660 and in light of the definitions above. For example, sensors 613 can include one or more coupling sensors 632, one or more SpO2 sensor 634, one or more EMG sensors 635, one or more capacitive sensor 636, one or more heart rate sensor 637, and one or more IMU sensor 638.

The peripherals interface 631 can also include other components analogous to those included in the peripheral interface 661 of the computer system 660, including an NFC component 639, a GPS component 640, an LTE component 641, a Wi-Fi and/or Bluetooth communication component 642, and/or one or more haptic devices 676 as described above in reference to peripherals interface 661. In some embodiments, the peripherals interface 631 includes one or more buttons 643, a display 633, a speaker 644, a microphone 645, and a camera 655. In some embodiments, the peripherals interface 631 includes one or more indicators, such as an LED.

It should be appreciated that the wearable band computing system 630 is an example of a computing system within the wearable band 610, and that the wearable band 610 can have more or fewer components than shown in the wearable band computing system 630, combine two or more components, and/or have a different configuration and/or arrangement of the components. The various components shown in wearable band computing system 630 can be implemented in one or a combination of hardware, software, firmware, including one or more signal processing and/or application-specific integrated circuits.

The wrist-wearable device 600 with respect to FIG. 6A is an example of the wearable band 610 and the watch body 620 coupled, so the wrist-wearable device 600 will be understood to include the components shown and described for the wearable band computing system 630 and the watch body computing system 660. In some embodiments, wrist-wearable device 600 has a split architecture (e.g., a split mechanical architecture, a split electrical architecture) between the watch body 620 and the wearable band 610. In other words, all of the components shown in the wearable band computing system 630 and the watch body computing system 660 can be housed or otherwise disposed in a combined watch device 600, or within individual components of the watch body 620, wearable band 610, and/or portions thereof (e.g., a coupling mechanism 616 of the wearable band 610).

The techniques described above can be used with any device for sensing neuromuscular signals, including the arm-wearable devices of FIG. 6A-6B, but could also be used with other types of wearable devices for sensing neuromuscular signals (such as body-wearable or head-wearable devices that might have neuromuscular sensors closer to the brain or spinal column).

In some embodiments, a wrist-wearable device 600 can be used in conjunction with a head-wearable device described below (e.g., artificial-reality device 700 and VR device 710) and/or an HIPD 800; and the wrist-wearable device 600 can also be configured to be used to allow a user to control aspect of the artificial reality (e.g., by using EMG-based gestures to control user interface objects in the artificial reality and/or by allowing a user to interact with the touchscreen on the wrist-wearable device to also control aspects of the artificial reality). Having thus described example wrist-wearable device, attention will now be turned to example head-wearable devices, such artificial-reality device 700 and VR device 710.

### Example Head-Wearable Devices

FIGS. 7A-7C show example head-wearable devices, in accordance with some embodiments. Head-wearable devices can include, but are not limited to, artificial-reality devices 710 (e.g., artificial-reality or smart eyewear devices, such as smart glasses, smart monocles, smart contacts, etc.), VR devices 710 (e.g., VR headsets, head-mounted displays (HMD)s, etc.), or other ocularly coupled devices. The artificial-reality devices 700 and the VR devices 710 can perform various functions and/or operations associated with navigating through user interfaces and selectively opening applications, as well as the functions and/or operations described above with reference to FIGS. 1A to 3H.

In some embodiments, an artificial-reality system (e.g., artificial-reality systems 500a-500d; FIGS. 5A-5C-2) includes an artificial-reality device 700 (as shown in FIG. 7A) and/or VR device 710 (as shown in FIGS. 7B-1-B-2). In some embodiments, the artificial-reality device 700 and the VR device 710 can include one or more analogous components (e.g., components for presenting interactive artificial-reality environments, such as processors, memory, and/or presentation devices, including one or more displays and/or one or more waveguides), some of which are described in more detail with respect to FIG. 7C. The head-wearable devices can use display projectors (e.g., display projector assemblies 707A and 707B) and/or waveguides for projecting representations of data to a user. Some embodiments of head-wearable devices do not include displays.

FIG. 7A shows an example visual depiction of the artificial-reality device 700 (e.g., which may also be described herein as augmented-reality glasses, and/or smart glasses). The artificial-reality device 700 can work in conjunction with additional electronic components that are not shown in FIGS. 7A, such as a wearable accessory device and/or an intermediary processing device, in electronic communication or otherwise configured to be used in conjunction with the artificial-reality device 700. In some embodiments, the wearable accessory device and/or the intermediary processing device may be configured to couple with the artificial-reality device 700 via a coupling mechanism in electronic communication with a coupling sensor 724, where the coupling sensor 724 can detect when an electronic device becomes physically or electronically coupled with the artificial-reality device 700. In some embodiments, the artificial-reality device 700 can be configured to couple to a housing (e.g., a portion of frame 704 or temple arms 705), which may include one or more additional coupling mechanisms configured to couple with additional accessory devices. The components shown in FIG. 7A can be implemented in hardware, software, firmware, or a combination thereof, including one or more signal-processing components and/or application-specific integrated circuits (ASICs).

The artificial-reality device 700 includes mechanical glasses components, including a frame 704 configured to hold one or more lenses (e.g., one or both lenses 706-1 and 706-2). One of ordinary skill in the art will appreciate that the artificial-reality device 700 can include additional mechanical components, such as hinges configured to allow portions of the frame 704 of the artificial-reality device 700 to be folded and unfolded, a bridge configured to span the gap between the lenses 706-1 and 706-2 and rest on the user's nose, nose pads configured to rest on the bridge of the nose and provide support for the artificial-reality device 700, earpieces configured to rest on the user's ears and provide additional support for the artificial-reality device 700, temple arms 705 configured to extend from the hinges to the earpieces of the artificial-reality device 700, and the like. One of ordinary skill in the art will further appreciate that some examples of the artificial-reality device 700 can include none of the mechanical components described herein. For example, smart contact lenses configured to present artificial-reality to users may not include any components of the artificial-reality device 700.

The lenses 706-1 and 706-2 can be individual displays or display devices (e.g., a waveguide for projected representations). The lenses 706-1 and 706-2 may act together or independently to present an image or series of images to a user. In some embodiments, the lenses 706-1 and 706-2 can operate in conjunction with one or more display projector assemblies 707A and 707B to present image data to a user. While the artificial-reality device 700 includes two displays, embodiments of this disclosure may be implemented in artificial-reality devices with a single near-eye display (NED) or more than two NEDs.

The artificial-reality device 700 includes electronic components, many of which will be described in more detail below with respect to FIG. 7C. Some example electronic components are illustrated in FIG. 7A, including sensors 723-1, 723-2, 723-3, 723-4, 723-5, and 723-6, which can be distributed along a substantial portion of the frame 704 of the artificial-reality device 700. The different types of sensors are described below in reference to FIG. 7C. The artificial-reality device 700 also includes a left camera 739A and a right camera 739B, which are located on different sides of the frame 704. And the eyewear device includes one or more processors 748A and 748B (e.g., an integral microprocessor, such as an ASIC) that is embedded into a portion of the frame 704.

FIGS. 7B-1 and 7B-2 show an example visual depiction of the VR device 710 (e.g., a head-mounted display (HMD) 712, also referred to herein as an artificial-reality headset, a head-wearable device, a VR headset, etc.). The HMD 712 includes a front body 714 and a frame 716 (e.g., a strap or band) shaped to fit around a user's head. In some embodiments, the front body 714 and/or the frame 716 includes one or more electronic elements for facilitating presentation of and/or interactions with an artificial-reality and/or VR system (e.g., displays, processors (e.g., processor 748A-1), IMUs, tracking emitter or detectors, sensors, etc.). In some embodiments, the HMD 712 includes output audio transducers (e.g., an audio transducer 718-1), as shown in FIG. 7B-2. In some embodiments, one or more components, such as the output audio transducer(s) 718 and the frame 716, can be configured to attach and detach (e.g., are detachably attachable) to the HMD 712 (e.g., a portion or all of the frame 716, and/or the output audio transducer 718), as shown in FIG. 7B-2. In some embodiments, coupling a detachable component to the HMD 712 causes the detachable component to come into electronic communication with the HMD 712. The VR device 710 includes electronic components, many of which will be described in more detail below with respect to FIG. 7C.

FIG. 7B-1 to 7B-2 also show that the VR device 710 can include one or more cameras, such as the left camera 739A and the right camera 739B, which can be analogous to the left and right cameras on the frame 704 of the artificial-reality device 700. In some embodiments, the VR device 710 includes one or more additional cameras (e.g., cameras 739C and 739D), which can be configured to augment image data obtained by the cameras 739A and 739B by providing more information. For example, the camera 739C can be used to supply color information that is not discerned by cameras 739A and 739B. In some embodiments, one or more of the cameras 739A to 739D can include an optional IR cut filter configured to remove IR light from being received at the respective camera sensors.

The VR device 710 can include a housing 790 storing one or more components of the VR device 710 and/or additional components of the VR device 710. The housing 790 can be a modular electronic device configured to couple with the VR device 710 (or an artificial-reality device 700) and supplement and/or extend the capabilities of the VR device 710 (or an artificial-reality device 700). For example, the housing 790 can include additional sensors, cameras, power sources, processors (e.g., processor 748A-2), etc. to improve and/or increase the functionality of the VR device 710. Examples of the different components included in the housing 790 are described below in reference to FIG. 7C.

Alternatively, or additionally, in some embodiments, the head-wearable device, such as the VR device 710 and/or the artificial-reality device 700), includes, or is communicatively coupled to, another external device (e.g., a paired device), such as the HIPD 800 (discussed below in reference to FIGS. 8A-8B) and/or an optional neckband. The optional neckband can couple to the head-wearable device via one or more connectors (e.g., wired, or wireless connectors). The head-wearable device and the neckband can operate independently without any wired or wireless connection between them. In some embodiments, the components of the head-wearable device and the neckband are located on one or more additional peripheral devices paired with the head-wearable device, the neckband, or some combination thereof. Furthermore, the neckband is intended to represent any suitable type or form of paired device. Thus, the following discussion of neckband may also apply to various other paired devices, such as smart watches, smart phones, wrist bands, other wearable devices, hand-held controllers, tablet computers, or laptop computers.

In some situations, pairing external devices, such as an intermediary processing device (e.g., an HIPD 800, an optional neckband, and/or wearable accessory device) with the head-wearable devices (e.g., an artificial-reality device 700 and/or VR device 710) enables the head-wearable devices to achieve a similar form factor of a pair of glasses while still providing sufficient battery and computation power for expanded capabilities. Some, or all, of the battery power, computational resources, and/or additional features of the head-wearable devices can be provided by a paired device or shared between a paired device and the head-wearable devices, thus reducing the weight, heat profile, and form factor of the head-wearable devices overall while allowing the head-wearable devices to retain its desired functionality. For example, the intermediary processing device (e.g., the HIPD 800) can allow components that would otherwise be included in a head-wearable device to be included in the intermediary processing device (and/or a wearable device or accessory device), thereby shifting a weight load from the user's head and neck to one or more other portions of the user's body. In some embodiments, the intermediary processing device has a larger surface area over which to diffuse and disperse heat to the ambient environment. Thus, the intermediary processing device can allow for greater battery and computation capacity than might otherwise have been possible on the head-wearable devices, standing alone. Because weight carried in the intermediary processing device can be less invasive to a user than weight carried in the head-wearable devices, a user may tolerate wearing a lighter eyewear device and carrying or wearing the paired device for greater lengths of time than the user would tolerate wearing a heavier eyewear device standing alone, thereby enabling an artificial-reality environment to be incorporated more fully into a user's day-to-day activities.

In some embodiments, the intermediary processing device is communicatively coupled with the head-wearable device and/or to other devices. The other devices may provide certain functions (e.g., tracking, localizing, depth mapping, processing, storage, etc.) to the head-wearable device. In some embodiments, the intermediary processing device includes a controller and a power source. In some embodiments, sensors of the intermediary processing device are configured to sense additional data that can be shared with the head-wearable devices in an electronic format (analog or digital).

The controller of the intermediary processing device processes information generated by the sensors on the intermediary processing device and/or the head-wearable devices. The intermediary processing device, like an HIPD 800, can process information generated by one or more sensors of its sensors and/or information provided by other communicatively coupled devices. For example, a head-wearable device can include an IMU, and the intermediary processing device (neckband and/or an HIPD 800) can compute all inertial and spatial calculations from the IMUs located on the head-wearable device. Additional examples of processing performed by a communicatively coupled device, such as the HIPD 800, are provided below in reference to FIGS. 8A and 8B.

AR systems may include a variety of types of visual feedback mechanisms. For example, display devices in the artificial-reality devices 700 and/or the VR devices 710 may include one or more liquid-crystal displays (LCDs), light emitting diode (LED) displays, organic LED (OLED) displays, and/or any other suitable type of display screen. artificial-reality systems may include a single display screen for both eyes or may provide a display screen for each eye, which may allow for additional flexibility for varifocal adjustments or for correcting a refractive error associated with the user's vision. Some artificial-reality systems also include optical subsystems having one or more lenses (e.g., conventional concave or convex lenses, Fresnel lenses, or adjustable liquid lenses) through which a user may view a display screen. In addition to or instead of using display screens, some artificial-reality systems include one or more projection systems. For example, display devices in the artificial-reality device 700 and/or the VR device 710 may include micro-LED projectors that project light (e.g., using a waveguide) into display devices, such as clear combiner lenses that allow ambient light to pass through. The display devices may refract the projected light toward a user's pupil and may enable a user to simultaneously view both artificial-reality content and the real world. artificial-reality systems may also be configured with any other suitable type or form of image projection system. As noted, some artificial-reality systems may, instead of blending an artificial reality with actual reality, substantially replace one or more of a user's sensory perceptions of the real world with a virtual experience.

While the example head-wearable devices are respectively described herein as the artificial-reality device 700 and the VR device 710, either or both of the example head-wearable devices described herein can be configured to present fully-immersive VR scenes presented in substantially all of a user's field of view, additionally or alternatively to, subtler augmented-reality scenes that are presented within a portion, less than all, of the user's field of view.

In some embodiments, the artificial-reality device 700 and/or the VR device 710 can include haptic feedback systems. The haptic feedback systems may provide various types of cutaneous feedback, including vibration, force, traction, shear, texture, and/or temperature. The haptic feedback systems may also provide various types of kinesthetic feedback, such as motion and compliance. The haptic feedback can be implemented using motors, piezoelectric actuators, fluidic systems, and/or a variety of other types of feedback mechanisms. The haptic feedback systems may be implemented independently of other artificial-reality devices, within other artificial-reality devices, and/or in conjunction with other artificial-reality devices (e.g., wrist-wearable devices which may be incorporated into headwear, gloves, body suits, handheld controllers, environmental devices (e.g., chairs or floormats), and/or any other type of device or system, such as a wrist-wearable device 600, an HIPD 800, etc.), and/or other devices described herein.

FIG. 7C illustrates a computing system 720 and an optional housing 790, each of which show components that can be included in a head-wearable device (e.g., the artificial-reality device 700 and/or the VR device 710). In some embodiments, more or less components can be included in the optional housing 790 depending on practical restraints of the respective head-wearable device being described. Additionally, or alternatively, the optional housing 790 can include additional components to expand and/or augment the functionality of a head-wearable device.

In some embodiments, the computing system 720 and/or the optional housing 790 can include one or more peripheral interfaces 722A and 722B, one or more power systems 742A and 742B (including charger input 743, PMIC 744, and battery 745), one or more controllers 746A and/or 746B (including one or more haptic controllers 747), one or more processors 748A and 748B (as defined above, including any of the examples provided), and memory 750A and 750B, which can all be in electronic communication with each other. For example, the one or more processors 748A and/or 748B can be configured to execute instructions stored in the memory 750A and/or 750B, which can cause a controller of the one or more controllers 746A and/or 746B to cause operations to be performed at one or more peripheral devices of the peripheral interfaces 722A and/or 722B. In some embodiments, each operation described can occur based on electrical power provided by the power system 742A and/or 742B.

In some embodiments, the peripherals interface 722A can include one or more devices configured to be part of the computing system 720, many of which have been defined above and/or described with respect to wrist-wearable devices shown in FIGS. 6A and 6B. For example, the peripherals interface can include one or more sensors 723A. Some example sensors include: one or more coupling sensors 724, one or more acoustic sensors 725, one or more imaging sensors 726, one or more EMG sensors 727, one or more capacitive sensors 728, and/or one or more IMU sensors 729. In some embodiments, the sensors 723A further include depth sensors 767, light sensors 768 and/or any other types of sensors defined above or described with respect to any other embodiments discussed herein.

In some embodiments, the peripherals interface can include one or more additional peripheral devices, including one or more NFC devices 730, one or more GPS devices 731, one or more LTE devices 732, one or more WiFi and/or Bluetooth devices 733, one or more buttons 734 (e.g., including buttons that are slidable or otherwise adjustable), one or more displays 735A, one or more speakers 736A, one or more microphones 737A, one or more cameras 738A (e.g., including the a first camera 739-1 through nth camera 739-n, which are analogous to the left camera 739A and/or the right camera 739B), one or more haptic devices 740; and/or any other types of peripheral devices defined above or described with respect to any other embodiments discussed herein.

The head-wearable devices can include a variety of types of visual feedback mechanisms (e.g., presentation devices). For example, display devices in the artificial-reality device 700 and/or the VR device 710 can include one or more liquid-crystal displays (LCDs), light emitting diode (LED) displays, organic LED (OLED) displays, micro-LEDs, and/or any other suitable types of display screens. The head-wearable devices can include a single display screen (e.g., configured to be seen by both eyes), and/or can provide separate display screens for each eye, which can allow for additional flexibility for varifocal adjustments and/or for correcting a refractive error associated with the user's vision. Some embodiments of the head-wearable devices also include optical subsystems having one or more lenses (e.g., conventional concave or convex lenses, Fresnel lenses, or adjustable liquid lenses) through which a user can view a display screen. For example, respective displays 735A can couple to each of the lenses 706-1 and 706-2 of the artificial-reality device 700. The displays 735A coupled to each of the lenses 706-1 and 706-2 can act together or independently to present an image or series of images to a user. In some embodiments, the artificial-reality device 700 and/or the VR device 710 includes a single display 735A (e.g., a near-eye display) or more than two displays 735A.

In some embodiments, a first set of one or more displays 735A can be used to present an augmented-reality environment, and a second set of one or more display devices 735A can be used to present a VR environment. In some embodiments, one or more waveguides are used in conjunction with presenting artificial-reality content to the user of the artificial-reality device 700 and/or the VR device 710 (e.g., as a means of delivering light from a display projector assembly and/or one or more displays 735A to the user's eyes). In some embodiments, one or more waveguides are fully or partially integrated into the artificial-reality device 700 and/or the VR device 710. Additionally, or alternatively to display screens, some artificial-reality systems include one or more projection systems. For example, display devices in the artificial-reality device 700 and/or the VR device 710 can include micro-LED projectors that project light (e.g., using a waveguide) into display devices, such as clear combiner lenses that allow ambient light to pass through. The display devices can refract the projected light toward a user's pupil and can enable a user to simultaneously view both artificial-reality content and the real world. The head-wearable devices can also be configured with any other suitable type or form of image projection system. In some embodiments, one or more waveguides are provided additionally or alternatively to the one or more display(s) 735A.

In some embodiments of the head-wearable devices, ambient light and/or a real-world live view (e.g., a live feed of the surrounding environment that a user would normally see) can be passed through a display element of a respective head-wearable device presenting aspects of the artificial-reality system. In some embodiments, ambient light and/or the real-world live view can be passed through a portion less than all, of an artificial-reality environment presented within a user's field of view (e.g., a portion of the artificial-reality environment co-located with a physical object in the user's real-world environment that is within a designated boundary (e.g., a guardian boundary) configured to be used by the user while they are interacting with the artificial-reality environment). For example, a visual user interface element (e.g., a notification user interface element) can be presented at the head-wearable devices, and an amount of ambient light and/or the real-world live view (e.g., 15-50% of the ambient light and/or the real-world live view) can be passed through the user interface element, such that the user can distinguish at least a portion of the physical environment over which the user interface element is being displayed.

The head-wearable devices can include one or more external displays 735A for presenting information to users. For example, an external display 735A can be used to show a current battery level, network activity (e.g., connected, disconnected, etc.), current activity (e.g., playing a game, in a call, in a meeting, watching a movie, etc.), and/or other relevant information. In some embodiments, the external displays 735A can be used to communicate with others. For example, a user of the head-wearable device can cause the external displays 735A to present a do not disturb notification. The external displays 735A can also be used by the user to share any information captured by the one or more components of the peripherals interface 722A and/or generated by head-wearable device (e.g., during operation and/or performance of one or more applications).

The memory 750A can include instructions and/or data executable by one or more processors 748A (and/or processors 748B of the housing 790) and/or a memory controller of the one or more controllers 746A (and/or controller 746B of the housing 790). The memory 750A can include one or more operating systems 751; one or more applications 752; one or more communication interface modules 753A; one or more graphics modules 754A; one or more artificial-reality processing modules 755A; metaverse-adjustment user interface module 756 for performing adjustments to secondary metaverse environments that are being presented by the VR device 710; and/or any other types of modules or components defined above or described with respect to any other embodiments discussed herein.

The data 760 stored in memory 750A can be used in conjunction with one or more of the applications and/or programs discussed above. The data 760 can include profile data 761; sensor data 762; media content data 763; artificial-reality application data 764; secondary metaverse data 765, which may be related to secondary metaverse environment content usage by the user 502 (e.g., data about how much time the user 502 has spent interacting with artificial-reality content of different secondary metaverse environments; and/or any other types of data defined above or described with respect to any other embodiments discussed herein.

In some embodiments, the controller 746A of the head-wearable devices processes information generated by the sensors 723A on the head-wearable devices and/or another component of the head-wearable devices and/or communicatively coupled with the head-wearable devices (e.g., components of the housing 790, such as components of peripherals interface 722B). For example, the controller 746A can process information from the acoustic sensors 725 and/or image sensors 726. For each detected sound, the controller 746A can perform a direction of arrival (DOA) estimation to estimate a direction from which the detected sound arrived at a head-wearable device. As one or more of the acoustic sensors 725 detects sounds, the controller 746A can populate an audio data set with the information (e.g., represented by sensor data 762).

In some embodiments, a physical electronic connector can convey information between the head-wearable devices and another electronic device, and/or between one or more processors 748A of the head-wearable devices and the controller 746A. The information can be in the form of optical data, electrical data, wireless data, or any other transmittable data form. Moving the processing of information generated by the head-wearable devices to an intermediary processing device can reduce weight and heat in the eyewear device, making it more comfortable and safer for a user. In some embodiments, an optional accessory device (e.g., an electronic neckband or an HIPD 800) is coupled to the head-wearable devices via one or more connectors. The connectors can be wired or wireless connectors and can include electrical and/or non-electrical (e.g., structural) components. In some embodiments, the head-wearable devices and the accessory device can operate independently without any wired or wireless connection between them.

The head-wearable devices can include various types of computer vision components and subsystems. For example, the artificial-reality device 700 and/or the VR device 710 can include one or more optical sensors such as two-dimensional (2D) or three-dimensional (3D) cameras, time-of-flight depth sensors, single-beam or sweeping laser rangefinders, 3D LiDAR sensors, and/or any other suitable type or form of optical sensor. A head-wearable device can process data from one or more of these sensors to identify a location of a user and/or aspects of the use's real-world physical surroundings, including the locations of real-world objects within the real-world physical surroundings. In some embodiments, the methods described herein are used to map the real world, to provide a user with context about real-world surroundings, and/or to generate interactable virtual objects (which can be replicas or digital twins of real-world objects that can be interacted with in artificial-reality environment), among a variety of other functions. For example, FIGS. 7B-1 and 7B-2 show the VR device 710 having cameras 739A-739D, which can be used to provide depth information for creating a voxel field and a two-dimensional mesh to provide object information to the user to avoid collisions.

The optional housing 790 can include analogous components to those describe above with respect to the computing system 720. For example, the optional housing 790 can include a respective peripherals interface 722B including more or less components to those described above with respect to the peripherals interface 722A. As described above, the components of the optional housing 790 can be used augment and/or expand on the functionality of the head-wearable devices. For example, the optional housing 790 can include respective sensors 723B, speakers 736B, displays 735B, microphones 737B, cameras 738B, and/or other components to capture and/or present data. Similarly, the optional housing 790 can include one or more processors 748B, controllers 746B, and/or memory 750B (including respective communication interface modules 753B; one or more graphics modules 754B; one or more artificial-reality processing modules 755B, etc.) that can be used individually and/or in conjunction with the components of the computing system 720.

The techniques described above in FIGS. 7A-7C can be used with different head-wearable devices. In some embodiments, the head-wearable devices (e.g., the artificial-reality device 700 and/or the VR device 710) can be used in conjunction with one or more wearable device such as a wrist-wearable device 600 (or components thereof), as well as the HIPD 800. Having thus described example the head-wearable devices, attention will now be turned to example handheld intermediary processing devices, such as HIPD 800.

### Example Handheld Intermediary Processing Devices

FIGS. 8A and 8B illustrate an example handheld intermediary processing device (HIPD) 800, in accordance with some embodiments.

FIG. 8A shows a top view 805 and a side view 825 of the HIPD 800. The HIPD 800 is configured to communicatively couple with one or more wearable devices (or other electronic devices) associated with a user. For example, the HIPD 800 is configured to communicatively couple with a user's wrist-wearable device 600 (or components thereof, such as the watch body 620 and the wearable band 610), artificial-reality device 700, and/or VR device 710. The HIPD 800 can be configured to be held by a user (e.g., as a handheld controller), carried on the user's person (e.g., in their pocket, in their bag, etc.), placed in proximity of the user (e.g., placed on their desk while seated at their desk, on a charging dock, etc.), and/or placed at or within a predetermined distance from a wearable device or other electronic device (e.g., where, in some embodiments, the predetermined distance is the maximum distance (e.g., 10 meters) at which the HIPD 800 can successfully be communicatively coupled with an electronic device, such as a wearable device).

The HIPD 800 can perform various functions independently and/or in conjunction with one or more wearable devices (e.g., wrist-wearable device 600, artificial-reality device 700, VR device 710, etc.). The HIPD 800 is configured to increase and/or improve the functionality of communicatively coupled devices, such as the wearable devices. The HIPD 800 is configured to perform one or more functions or operations associated with interacting with user interfaces and applications of communicatively coupled devices, interacting with an artificial-reality environment, interacting with VR environment. Additionally, as will be described in more detail below, functionality and/or operations of the HIPD 800 can include, without limitation, task offloading and/or handoffs; thermals offloading and/or handoffs; 6 degrees of freedom (6DoF) raycasting and/or gaming (e.g., using imaging devices or cameras 814A and 814B, which can be used for simultaneous localization and mapping (SLAM) and/or with other image processing techniques); portable charging; messaging; image capturing via one or more imaging devices or cameras (e.g., cameras 822A and 822B); sensing user input (e.g., sensing a touch on a multi-touch input surface 802); wireless communications and/or interlining (e.g., cellular, near field, Wi-Fi, personal area network, etc.); location determination; financial transactions; providing haptic feedback; alarms; notifications; biometric authentication; health monitoring; sleep monitoring; etc. The above-example functions can be executed independently in the HIPD 800 and/or in communication between the HIPD 800 and another wearable device described herein. In some embodiments, functions can be executed on the HIPD 800 in conjunction with an artificial-reality environment. As the skilled artisan will appreciate upon reading the descriptions provided herein, the novel the HIPD 800 described herein can be used with any type of suitable artificial-reality environment.

While the HIPD 800 is communicatively coupled with a wearable device and/or other electronic device, the HIPD 800 is configured to perform one or more operations initiated at the wearable device and/or the other electronic device. In particular, one or more operations of the wearable device and/or the other electronic device can be offloaded to the HIPD 800 to be performed. The HIPD 800 performs the one or more operations of the wearable device and/or the other electronic device and provides to data corresponded to the completed operations to the wearable device and/or the other electronic device. For example, a user can initiate a video stream using artificial-reality device 700 and back-end tasks associated with performing the video stream (e.g., video rendering) can be offloaded to the HIPD 800, which the HIPD 800 performs and provides corresponding data to the artificial-reality device 700 to perform remaining front-end tasks associated with the video stream (e.g., presenting the rendered video data via a display of the artificial-reality device 700). In this way, the HIPD 800, which has more computational resources and greater thermal headroom than a wearable device, can perform computationally intensive tasks for the wearable device improving performance of an operation performed by the wearable device.

The HIPD 800 includes a multi-touch input surface 802 on a first side (e.g., a front surface) that is configured to detect one or more user inputs. In particular, the multi-touch input surface 802 can detect single tap inputs, multi-tap inputs, swipe gestures and/or inputs, force-based and/or pressure-based touch inputs, held taps, and the like. The multi-touch input surface 802 is configured to detect capacitive touch inputs and/or force (and/or pressure) touch inputs. The multi-touch input surface 802 includes a first touch-input surface 804 defined by a surface depression, and a second touch-input surface 806 defined by a substantially planar portion. The first touch-input surface 804 can be disposed adjacent to the second touch-input surface 806. In some embodiments, the first touch-input surface 804 and the second touch-input surface 806 can be different dimensions, shapes, and/or cover different portions of the multi-touch input surface 802. For example, the first touch-input surface 804 can be substantially circular and the second touch-input surface 806 is substantially rectangular. In some embodiments, the surface depression of the multi-touch input surface 802 is configured to guide user handling of the HIPD 800. In particular, the surface depression is configured such that the user holds the HIPD 800 upright when held in a single hand (e.g., such that the using imaging devices or cameras 814A and 814B are pointed toward a ceiling or the sky). Additionally, the surface depression is configured such that the user's thumb rests within the first touch-input surface 804.

In some embodiments, the different touch-input surfaces include a plurality of touch-input zones. For example, the second touch-input surface 806 includes at least a first touch-input zone 808 within a second touch-input surface 806 and a third touch-input zone 810 within the first touch-input zone 808. In some embodiments, one or more of the touch-input zones are optional and/or user defined (e.g., a user can specific a touch-input zone based on their preferences). In some embodiments, each touch-input surface and/or touch-input zone is associated with a predetermined set of commands. For example, a user input detected within the first touch-input zone 808 causes the HIPD 800 to perform a first command and a user input detected within the second touch-input surface 806 causes the HIPD 800 to perform a second command, distinct from the first. In some embodiments, different touch-input surfaces and/or touch-input zones are configured to detect one or more types of user inputs. The different touch-input surfaces and/or touch-input zones can be configured to detect the same or distinct types of user inputs. For example, the first touch-input zone 808 can be configured to detect force touch inputs (e.g., a magnitude at which the user presses down) and capacitive touch inputs, and the second touch-input surface 806 can be configured to detect capacitive touch inputs.

The HIPD 800 includes one or more sensors 851 for sensing data used in the performance of one or more operations and/or functions. For example, the HIPD 800 can include an IMU sensor that is used in conjunction with cameras 814 for 3-dimensional object manipulation (e.g., enlarging, moving, destroying, etc. an object) in an artificial-reality or VR environment. Non-limiting examples of the sensors 851 included in the HIPD 800 include a light sensor, a magnetometer, a depth sensor, a pressure sensor, and a force sensor. Additional examples of the sensors 851 are provided below in reference to FIG. 8B.

The HIPD 800 can include one or more light indicators 812 to provide one or more notifications to the user. In some embodiments, the light indicators are LEDs or other types of illumination devices. The light indicators 812 can operate as a privacy light to notify the user and/or others near the user that an imaging device and/or microphone are active. In some embodiments, a light indicator is positioned adjacent to one or more touch-input surfaces. For example, a light indicator can be positioned around the first touch-input surface 804. The light indicators can be illuminated in different colors and/or patterns to provide the user with one or more notifications and/or information about the device. For example, a light indicator positioned around the first touch-input surface 804 can flash when the user receives a notification (e.g., a message), change red when the HIPD 800 is out of power, operate as a progress bar (e.g., a light ring that is closed when a task is completed (e.g., 0% to 100%)), operates as a volume indicator, etc.).

In some embodiments, the HIPD 800 includes one or more additional sensors on another surface. For example, as shown FIG. 8A, HIPD 800 includes a set of one or more sensors (e.g., sensor set 820) on an edge of the HIPD 800. The sensor set 820, when positioned on an edge of the of the HIPD 800, can be positioned at a predetermined tilt angle (e.g., 26 degrees), which allows the sensor set 820 to be angled toward the user when placed on a desk or other flat surface. Alternatively, in some embodiments, the sensor set 820 is positioned on a surface opposite the multi-touch input surface 802 (e.g., a back surface). The one or more sensors of the sensor set 820 are discussed in detail below.

The side view 825 of the of the HIPD 800 shows the sensor set 820 and camera 814B. The sensor set 820 includes one or more cameras 822A and 822B, a depth projector 824, an ambient light sensor 828, and a depth receiver 830. In some embodiments, the sensor set 820 includes a light indicator 826. The light indicator 826 can operate as a privacy indicator to let the user and/or those around them know that a camera and/or microphone is active. The sensor set 820 is configured to capture a user's facial expression such that the user can puppet a custom avatar (e.g., showing emotions, such as smiles, laughter, etc., on the avatar or a digital representation of the user). The sensor set 820 can be configured as a side stereo RGB system, a rear indirect Time-of-Flight (iToF) system, or a rear stereo RGB system. As the skilled artisan will appreciate upon reading the descriptions provided herein, the novel HIPD 800 described herein can use different sensor set 820 configurations and/or sensor set 820 placement.

In some embodiments, the HIPD 800 includes one or more haptic devices 871 (FIG. 8B; e.g., a vibratory haptic actuator) that are configured to provide haptic feedback (e.g., kinesthetic sensation). The sensors 851, and/or the haptic devices 871 can be configured to operate in conjunction with multiple applications and/or communicatively coupled devices including, without limitation, a wearable devices, health monitoring applications, social media applications, game applications, and artificial reality applications (e.g., the applications associated with artificial reality).

The HIPD 800 is configured to operate without a display. However, in optional embodiments, the HIPD 800 can include a display 868 (FIG. 8B). The HIPD 800 can also include one or more optional peripheral buttons 867 (FIG. 8B). For example, the peripheral buttons 867 can be used to turn on or turn off the HIPD 800. Further, the HIPD 800 housing can be formed of polymers and/or elastomer elastomers. The HIPD 800 can be configured to have a non-slip surface to allow the HIPD 800 to be placed on a surface without requiring a user to watch over the HIPD 800. In other words, the HIPD 800 is designed such that it would not easily slide off a surfaces. In some embodiments, the HIPD 800 include one or magnets to couple the HIPD 800 to another surface. This allows the user to mount the HIPD 800 to different surfaces and provide the user with greater flexibility in use of the HIPD 800.

As described above, the HIPD 800 can distribute and/or provide instructions for performing the one or more tasks at the HIPD 800 and/or a communicatively coupled device. For example, the HIPD 800 can identify one or more back-end tasks to be performed by the HIPD 800 and one or more front-end tasks to be performed by a communicatively coupled device. While the HIPD 800 is configured to offload and/or handoff tasks of a communicatively coupled device, the HIPD 800 can perform both back-end and front-end tasks (e.g., via one or more processors, such as CPU 877; FIG. 8B). The HIPD 800 can, without limitation, can be used to perform augmenting calling (e.g., receiving and/or sending 3D or 2.5D live volumetric calls, live digital human representation calls, and/or avatar calls), discreet messaging, 6DoF portrait/landscape gaming, AR/VR object manipulation, AR/VR content display (e.g., presenting content via a virtual display), and/or other AR/VR interactions. The HIPD 800 can perform the above operations alone or in conjunction with a wearable device (or other communicatively coupled electronic device).

FIG. 8B shows block diagrams of a computing system 840 of the HIPD 800, in accordance with some embodiments. The HIPD 800, described in detail above, can include one or more components shown in HIPD computing system 840. The HIPD 800 will be understood to include the components shown and described below for the HIPD computing system 840. In some embodiments, all, or a substantial portion of the components of the HIPD computing system 840 are included in a single integrated circuit. Alternatively, in some embodiments, components of the HIPD computing system 840 are included in a plurality of integrated circuits that are communicatively coupled.

The HIPD computing system 840 can include a processor (e.g., a CPU 877, a GPU, and/or a CPU with integrated graphics), a controller 875, a peripherals interface 850 that includes one or more sensors 851 and other peripheral devices, a power source (e.g., a power system 895), and memory (e.g., a memory 878) that includes an operating system (e.g., an operating system 879), data (e.g., data 888), one or more applications (e.g., applications 880), and one or more modules (e.g., a communications interface module 881, a graphics module 882, a task and processing management module 883, an interoperability module 884, an artificial-reality processing module 885, a data management module 886, a metaverse-adjustment module 887, etc.). The metaverse-adjustment module 887 can be used to control artificial-reality content of secondary metaverse environments as shown in FIGS. 1A to 3H (e.g., by using a metaverse-adjustment user interface element). In some embodiments, different portions of the touch surface 872 can correspond to different selections of the metaverse-adjustment user interface element 302 shown in FIGS. 3A to 3H. For example, the first, second, and third touch-input surfaces 806, 808, and 810, respectively, can each cause artificial-reality content of a currently-selected secondary metaverse environment 104-1 to be adjusted to be presented in a corresponding different presentation state (e.g., the first touch-input surface 804 can correspond to the first presentation state 202 that includes the virtual object 204 having the miniaturized representation). The HIPD computing system 840 further includes a power system 895 that includes a charger input and output 896, a PMIC 897, and a battery 898, all of which are defined above.

In some embodiments, the peripherals interface 850 can include one or more sensors 851. The sensors 851 can include analogous sensors to those described above in reference to FIG. 6B. For example, the sensors 851 can include imaging sensors 854, (optional) EMG sensors 856, IMU sensors 858, and capacitive sensors 860. In some embodiments, the sensors 851 can include one or more pressure sensor 852 for sensing pressure data, an altimeter 853 for sensing an altitude of the HIPD 800, a magnetometer 855 for sensing a magnetic field, a depth sensor 857 (or a time-of flight sensor) for determining a difference between the camera and the subject of an image, a position sensor 859 (e.g., a flexible position sensor) for sensing a relative displacement or position change of a portion of the HIPD 800, a force sensor 861 for sensing a force applied to a portion of the HIPD 800, and a light sensor 862 (e.g., an ambient light sensor) for detecting an amount of lighting. The sensors 851 can include one or more sensors not shown in FIG. 8B.

Analogous to the peripherals described above in reference to FIGS. 6B, the peripherals interface 850 can also include an NFC component 863, a GPS component 864, an LTE component 865, a Wi-Fi and/or Bluetooth communication component 866, a speaker 869, a haptic device 871, and a microphone 873. As described above in reference to FIG. 8A, the HIPD 800 can optionally include a display 868 and/or one or more buttons 867. The peripherals interface 850 can further include one or more cameras 870, touch surfaces 872, and/or one or more light emitters 874. The multi-touch input surface 802 described above in reference to FIG. 8A is an example of touch surface 872. The light emitters 874 can be one or more LEDs, lasers, etc. and can be used to project or present information to a user. For example, the light emitters 874 can include light indicators 812 and 826 described above in reference to FIG. 8A. The cameras 870 (e.g., cameras 814A, 814B, and 822 described above in FIG. 8A) can include one or more wide angle cameras, fish-eye cameras, spherical cameras, compound eye cameras (e.g., stereo and multi cameras), depth cameras, RGB cameras, ToF cameras, RGB-D cameras (depth and ToF cameras), and/or other available cameras. Cameras 870 can be used for SLAM; 6 DoF ray casting, gaming, object manipulation, and/or other rendering; facial recognition and facial expression recognition, etc.

Similar to the watch body computing system 660 and the watch band computing system 630 described above in reference to FIG. 6B, the HIPD computing system 840 can include one or more haptic controllers 876 and associated componentry (e.g., haptic devices 871) for providing haptic events at the HIPD 800.

Memory 878 can include high-speed random-access memory and/or non-volatile memory, such as one or more magnetic disk storage devices, flash memory devices, or other non-volatile solid-state memory devices. Access to the memory 878 by other components of the HIPD 800, such as the one or more processors and the peripherals interface 850, can be controlled by a memory controller of the controllers 875.

In some embodiments, software components stored in the memory 878 include one or more operating systems 879, one or more applications 880, one or more communication interface modules 881, one or more graphics modules 882, one or more data management modules 886, which are analogous to the software components described above in reference to FIG. 6B.

In some embodiments, software components stored in the memory 878 include a task and processing management module 883 for identifying one or more front-end and back-end tasks associated with an operation performed by the user, performing one or more front-end and/or back-end tasks, and/or providing instructions to one or more communicatively coupled devices that cause performance of the one or more front-end and/or back-end tasks. In some embodiments, the task and processing management module 883 uses data 888 (e.g., device data 890) to distribute the one or more front-end and/or back-end tasks based on communicatively coupled devices' computing resources, available power, thermal headroom, ongoing operations, and/or other factors. For example, the task and processing management module 883 can cause the performance of one or more back-end tasks (of an operation performed at communicatively coupled artificial-reality device 700) at the HIPD 800 in accordance with a determination that the operation is utilizing a predetermined amount (e.g., at least 70%) of computing resources available at the artificial-reality device 700.

In some embodiments, software components stored in the memory 878 include an interoperability module 884 for exchanging and utilizing information received and/or provided to distinct communicatively coupled devices. The interoperability module 884 allows for different systems, devices, and/or applications to connect and communicate in a coordinated way without user input. In some embodiments, software components stored in the memory 878 include an artificial-reality processing module 885 that is configured to process signals based at least on sensor data for use in an artificial-reality and/or VR environment. For example, the artificial-reality processing module 885 can be used for 3D object manipulation, gesture recognition, facial and facial expression, recognition, etc.

The memory 878 can also include data 888, including structured data. In some embodiments, the data 888 can include profile data 889, device data 890 (including device data of one or more devices communicatively coupled with the HIPD 800, such as device type, hardware, software, configurations, etc.), sensor data 891, media content data 892, application data 893, and secondary metaverse data, which may include data about usage (e.g., by user 502 and/or aggregate usage data for a plurality of users of different HIPD devices) related to presenting secondary metaverse environments. Such data may be used to, for example, determine which secondary metaverse environments a user is most likely to use, and/or how to disambiguate different user inputs directed to different portions of the touch surface 872 of the HIPD 800.

It should be appreciated that the HIPD computing system 840 is an example of a computing system within the HIPD 800, and that the HIPD 800 can have more or fewer components than shown in the HIPD computing system 840, combine two or more components, and/or have a different configuration and/or arrangement of the components. The various components shown in HIPD computing system 840 are implemented in hardware, software, firmware, or a combination thereof, including one or more signal processing and/or application-specific integrated circuits.

The techniques described above in FIG. 8A-8B can be used with any device used as a human-machine interface controller. In some embodiments, an HIPD 800 can be used in conjunction with one or more wearable device such as a head-wearable device (e.g., artificial-reality device 700 and VR device 710) and/or a wrist-wearable device 600 (or components thereof).

Any data collection performed by the devices described herein and/or any devices configured to perform or cause the performance of the different embodiments described above in reference to any of the Figures, hereinafter the “devices,” is done with user consent and in a manner that is consistent with all applicable privacy laws. Users are given options to allow the devices to collect data, as well as the option to limit or deny collection of data by the devices. A user is able to opt-in or opt-out of any data collection at any time. Further, users are given the option to request the removal of any collected data.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A non-transitory computer-readable storage medium including instructions that, when executed by one or more processors, cause the one or more processors to:
present to a user, via an artificial-reality system, a primary metaverse environment and a secondary metaverse environment corresponding to different artificial-reality content than the primary metaverse environment, wherein the different artificial-reality content of the secondary metaverse environment is presented using a first presentation state within the primary metaverse environment;
while the different artificial-reality content of the secondary metaverse environment is presented, using the first presentation state, within the primary metaverse environment:
detect an input requesting a modification to the different artificial-reality content of the secondary metaverse environment;
in response to detecting the input, adjust the different artificial-reality content of the secondary metaverse environment to reflect the requested modification; and
after adjusting the different artificial-reality content of the secondary metaverse environment to reflect the requested modification:
in accordance with detecting a request to present the different artificial-reality content of the secondary metaverse environment using a second presentation state instead of the first presentation state:
cease to present the different artificial-reality content of the secondary metaverse environment using the first presentation state; and
cause presentation of the different artificial-reality content of the secondary metaverse environment within the primary metaverse environment such that the different artificial-reality content is presented using the second presentation state and continues to reflect the modification caused by the input.

2. The non-transitory computer-readable storage medium of claim 1, further including instructions to:
at a first time, while another user of a different artificial-reality system, distinct from the artificial-reality system, is interacting with the primary metaverse environment in conjunction with the user, present a first representation of the other user to the user within the primary metaverse environment; and
at a second time different than the first time, in response to receiving an indication that the other user of the different artificial-reality system has moved from the primary metaverse environment to the secondary metaverse environment:
present a second representation, distinct from the first representation, of the other user, the second representation including a trailing indicator associated with the other user in the primary metaverse environment, the trailing indicator indicating to other users in the primary metaverse environment that the other user is interacting with the secondary metaverse environment.

3. The non-transitory computer-readable storage medium of claim 2, further including instructions to:
after the other user has moved from the primary metaverse environment to the secondary metaverse environment:
based on an interaction that the other user is engaged in within the secondary metaverse environment, present a perceptible indicator as part of the second representation of the other user within the primary metaverse environment.

4. The non-transitory computer-readable storage medium of claim 2, further including instructions to:
after the other user has moved from the primary metaverse environment to the secondary metaverse environment:
in response to an additional input from a user of the artificial-reality system to cause another modification to the different artificial-reality content of the secondary metaverse environment, cause a change within the different artificial-reality content such that the other modification is viewable by the other user.

5. The non-transitory computer-readable storage medium of claim 1, further including instructions to:
while the different artificial-reality content of the secondary metaverse environment is presented using the second presentation state, detect a second input requesting another modification to the secondary metaverse environment;
in response to detecting the second input, adjust the different artificial-reality content of the secondary metaverse environment to reflect the modification and the other modification to the other artificial-reality content; and
in accordance with detecting a request to present the artificial-reality content of the secondary metaverse environment using a third presentation state instead of the second presentation state:
cease to present the different artificial-reality content of the secondary metaverse environment using the second presentation state; and
cause presentation of the different artificial-reality content of the secondary metaverse environment within the primary metaverse environment such that the different artificial-reality content is presented using the third presentation state and continues to reflect the modification and the other modification caused by the respective inputs requesting the modification and the other modification.

6. The non-transitory computer-readable storage medium of claim 5, wherein:
presenting the other artificial-reality content of the secondary metaverse environment using the first presentation state includes presenting a miniaturized representation of a portion of the secondary metaverse environment;
presenting the other artificial-reality content of the secondary metaverse environment using the second presentation state includes presenting a volumetric presentation object, wherein the volumetric presentation object is different than the miniaturized representation of the portion of secondary metaverse environment; and
presenting the other artificial-reality content of the secondary metaverse environment using the third presentation state includes presenting a two-dimensional virtual display that is configured to display a field of view within the secondary metaverse environment.

7. The non-transitory computer-readable storage medium of claim 6, wherein:
the volumetric presentation object includes a three-dimensional interaction zone configured to receive inputs from a user, and
gestures performed within the three-dimensional interaction zone are configured to cause operations to modify the artificial-reality content of the secondary metaverse environment.

8. The non-transitory computer-readable storage medium of claim 7, further including instructions to:
while the user is interacting with the volumetric presentation object:
in accordance with detecting that the user is interacting with a surface of the volumetric presentation object, present a first representation of a hand of the user; and
in accordance with detecting that the user is interacting with an internal portion of the volumetric presentation object, present a second representation of the hand of the user.

9. The non-transitory computer-readable storage medium of claim 1, further including instructions to:
present a metaverse-adjustment user interface element, wherein the metaverse-adjustment user interface element is responsive to selection of:
a first set of user inputs for toggling between respective presentation states of a respective secondary metaverse environment that is currently being presented being presented, and
a second set of user inputs replacing the respective secondary metaverse environment being presented with artificial-reality content of a different respective secondary metaverse environment.

10. The non-transitory computer-readable storage medium of claim 9, further including instructions to:
in response to detecting an adjustment input directed to a respective second user input of the second set of user inputs of the metaverse-adjustment user interface element:
present a different secondary metaverse environment, distinct from the secondary metaverse environment, the different secondary metaverse environment presented in a same presentation state being used to display the secondary metaverse environment.

11. The non-transitory computer-readable storage medium of claim 1, wherein:
the artificial-reality content of the primary metaverse environment is a first portion of a first metaverse world associated with a first set of users such that the first set of users, including the user, can interact within the primary metaverse environment; and
the other artificial-reality content of the secondary metaverse environment is a second portion of a second metaverse world associated with a second set of users, distinct from a first set of users and including the user, such that the second set of user can interact within the secondary metaverse environment.

12. A method, comprising:
presenting, via an artificial-reality system, a primary metaverse environment and a secondary metaverse environment corresponding to different artificial-reality content than the primary metaverse environment, wherein the different artificial-reality content of the secondary metaverse environment is presented using a first presentation state within the primary metaverse environment;
while the different artificial-reality content of the secondary metaverse environment is presented, using the first presentation state, within the primary metaverse environment:
detecting an input requesting a modification to the different artificial-reality content of the secondary metaverse environment;
in response to detecting the input, adjusting the different artificial-reality content of the secondary metaverse environment to reflect the requested modification; and
after adjusting the different artificial-reality content of the secondary metaverse environment to reflect the requested modification:
in accordance with detecting a request to present the different artificial-reality content of the secondary metaverse environment using a second presentation state instead of the first presentation state:
ceasing to present the different artificial-reality content of the secondary metaverse environment using the first presentation state; and
causing presentation of the different artificial-reality content of the secondary metaverse environment within the primary metaverse environment such that the different artificial-reality content is presented using the second presentation state and continues to reflect the modification caused by the input.

13. The method of claim 12, further comprising:
at a first time, while another user of a different artificial-reality system, distinct from the artificial-reality system, is interacting with the primary metaverse environment in conjunction with the user, presenting a first representation of the other user to the user within the primary metaverse environment; and
at a second time different than the first time, in response to receiving an indication that the other user of the different artificial-reality system has moved from the primary metaverse environment to the secondary metaverse environment:
presenting a second representation, distinct from the first representation, of the other user, the second representation including a trailing indicator associated with the other user in the primary metaverse environment, the trailing indicator indicating to other users in the primary metaverse environment that the other user is interacting with the secondary metaverse environment.

14. The method of claim 13, further comprising:
after the other user has moved from the primary metaverse environment to the secondary metaverse environment:
based on an interaction that the other user is engaged in within the secondary metaverse environment, presenting a perceptible indicator as part of the second representation of the other user within the primary metaverse environment.

15. The method of claim 13, further comprising:
after the other user has moved from the primary metaverse environment to the secondary metaverse environment:
in response to an additional input from a user of the artificial-reality system to cause another modification to the different artificial-reality content of the secondary metaverse environment, causing a change within the different artificial-reality content such that the other modification is viewable by the other user.

16. The method of claim 12, further comprising:
while the different artificial-reality content of the secondary metaverse environment is presented using the second presentation state, detecting a second input requesting another modification to the secondary metaverse environment;
in response to detecting the second input, adjusting the different artificial-reality content of the secondary metaverse environment to reflect the modification and the other modification to the other artificial-reality content; and
in accordance with detecting a request to present the artificial-reality content of the secondary metaverse environment using a third presentation state instead of the second presentation state:
ceasing to present the different artificial-reality content of the secondary metaverse environment using the second presentation state; and
causing presentation of the different artificial-reality content of the secondary metaverse environment within the primary metaverse environment such that the different artificial-reality content is presented using the third presentation state and continues to reflect the modification and the other modification caused by the respective inputs requesting the modification and the other modification.

17. The method of claim 16, wherein:
presenting the other artificial-reality content of the secondary metaverse environment using the first presentation state includes presenting a miniaturized representation of a portion of the secondary metaverse environment;
presenting the other artificial-reality content of the secondary metaverse environment using the second presentation state includes presenting a volumetric presentation object, wherein the volumetric presentation object is different than the miniaturized representation of the portion of secondary metaverse environment; and
presenting the other artificial-reality content of the secondary metaverse environment using the third presentation state includes presenting a two-dimensional virtual display that is configured to display a field of view within the secondary metaverse environment.

18. An artificial-reality system, comprising:
a presentation device;
one or more processors; and
memory, comprising instructions that, when executed by the one or more processors, cause the one or more processors to:
present, via an artificial-reality system, a primary metaverse environment and a secondary metaverse environment corresponding to different artificial-reality content than the primary metaverse environment, wherein the different artificial-reality content of the secondary metaverse environment is presented using a first presentation state within the primary metaverse environment;
while the different artificial-reality content of the secondary metaverse environment is presented, using the first presentation state, within the primary metaverse environment:
detect an input requesting a modification to the different artificial-reality content of the secondary metaverse environment;
in response to detecting the input, adjust the different artificial-reality content of the secondary metaverse environment to reflect the requested modification; and
after adjusting the different artificial-reality content of the secondary metaverse environment to reflect the requested modification:
in accordance with detecting a request to present the different artificial-reality content of the secondary metaverse environment using a second presentation state instead of the first presentation state:
cease to present the different artificial-reality content of the secondary metaverse environment using the first presentation state; and
cause presentation of the different artificial-reality content of the secondary metaverse environment within the primary metaverse environment such that the different artificial-reality content is presented using the second presentation state and continues to reflect the modification caused by the input.

19. The system of claim 18, wherein the memory further comprises instructions that, when executed by the one or more processors, cause the one or more processors to:
at a first time, while another user of a different artificial-reality system, distinct from the artificial-reality system, is interacting with the primary metaverse environment in conjunction with the user, present a first representation of the other user to the user within the primary metaverse environment; and
at a second time different than the first time, in response to receiving an indication that the other user of the different artificial-reality system has moved from the primary metaverse environment to the secondary metaverse environment:
present a second representation, distinct from the first representation, of the other user, the second representation including a trailing indicator associated with the other user in the primary metaverse environment, the trailing indicator indicating to other users in the primary metaverse environment that the other user is interacting with the secondary metaverse environment.

20. The system of claim 19, wherein the memory further comprises instructions that, when executed by the one or more processors, cause the one or more processors to:
after the other user has moved from the primary metaverse environment to the secondary metaverse environment:
based on an interaction that the other user is engaged in within the secondary metaverse environment, present a perceptible indicator as part of the second representation of the other user within the primary metaverse environment.
